(19) United States
(12) Patent Application Publication
(10) Pub. No.: US 2009/0059035 A1
(43) Pub. Date: Mar. 5, 2009

(54) PICTURE PRODUCTION SYSTEM, AND PICTURE PRODUCTION APPARATUS AND METHOD

(75) Inventors: Masataka Shinoda, Kanagawa (JP); Masayoshi Kanno, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/260,208

(22) Filed: Oct. 29, 2008

Related U.S. Application Data
(62) Division of application No. 10/718,479, filed on Nov. 20, 2003.

(30) Foreign Application Priority Data
Nov. 20, 2002 (JP) JP2002-335965
Mar. 11, 2003 (JP) JP2003-065151
Mar. 19, 2003 (JP) JP2003-076427

(51) Int. Cl. H04N 5/76

(52) U.S. Cl. 348/231.5; 348/E05.031

(57) ABSTRACT

A user carries a user medium in a facility, for example, in a theme park. Position data and time data are written into the user medium according to user's actions. Photographic devices installed at predetermined places constantly take pictures, and the pictures are stored in a picture production apparatus. When the user wishes to receive the pictures of himself/herself, he/she allows the picture production apparatus to read the data of the user medium when he/she leaves the facility. The picture production apparatus then extracts pictures for the user from the stored pictures based on the data read from the user medium, and produces a picture package. Then, the picture production apparatus records the produced picture package into a portable recording medium, for example, a disk, a memory card, or magnetic tape, and provides it to the user, or distributes the picture package to the user via a communication line.

### RELATED APPLICATIONS

This application is a divisional of U.S. application Ser. No. 10/718,479, filed on Nov. 20, 2003, which, in turn, claims priority under 35 U.S.C. §119 to Japanese Patent Application No. JP 2002-335965, filed in the Japanese Patent Office on Nov. 20, 2002, Japanese Patent Application No. JP 2003-065151, filed in the Japanese Patent Office on Mar. 11, 2003, and Japanese Patent Application No. JP 2003-076427, filed in the Japanese Patent Office on Mar. 19, 2003, the entire contents of which being incorporated herein by reference.

### BACKGROUND OF THE INVENTION

1. Field of the Invention

The present invention relates to a picture production system, and a picture production apparatus and method for providing pictures to users.

2. Description of the Related Art

In theme parks or attraction parks, services that allow users to purchase pictures (including photographs or videos) of themselves while partaking in an attraction are provided. Such services are very convenient for the users if they are unable to take pictures of themselves while partaking in an attraction, and such photographs can make attractive as souvenir photographs or souvenir videos.

A known system for providing photographic services in, for example, theme parks, is disclosed in, for example, Japanese Unexamined Patent Application Publication No. 11-136607.

However, such services do not seem to be efficient for both users and commercial entities providing the services because the time load and work load required to offer and use the services are burdensome.

It is now considered that a user purchases a photograph or a video for each attraction in a theme park or an attraction park, and an example of the user's action is indicated in (a) of FIG. 67.

It is now assumed, for example, that the user enters a theme park at time T_{ST}, and uses attraction 1 from time T₁. When attraction 1 is finished, the user orders a photograph or a video of himself/herself in attraction 1, and is then able to receive it after the lapse of waiting time T_{w} required for developing the photograph or editing the video. The user then moves to the next attraction.

If the user has to follow such a procedure for each attraction, the waiting time T_{w} for purchasing photographs or videos accumulates. In particular, the waiting time T_{w} required for developing photographs or editing videos is very long, and as a result, the user is able to use only three attractions, i.e., attractions 1 to 3, while the user stays in the theme park, and the number of attractions that can be attended by the user is decreased.

The user also has to pay for a photograph or a video for each attraction, and the time load and work load for purchasing photographs or videos increases.

As described above, the services for selling pictures (photographs and videos) are effective for the users, but on the other hand, the time load and the work load are burdensome for the users.

For commercial entities providing such services, the load for providing services is also burdensome because facilities and manpower for selling pictures are required.

The above-described problems arise, not only in theme parks and attraction parks, but also in any facility in which services such as souvenir photographs or souvenir videos are provided, for example, at golf courses, golf driving ranges, driving schools, sport gyms, and wedding reception halls.

### SUMMARY OF THE INVENTION

Accordingly, it is an object of the present invention to implement a picture providing service that is efficient for both users and commercial entities.

In order to achieve the above-described object, according to an aspect of the present invention, there is provided a picture production system including: a medium including a storage unit from or into which data is read or written; at least one photographic device for taking pictures fixed at a predetermined place; and a picture production apparatus for producing a picture by extracting a picture in accordance with an action of a user owning the medium from the pictures taken by at least one photographic device based on the data recorded in the medium and by editing the extracted picture.

The picture production system may further include at least one data writer fixed at a predetermined place, for writing data into the medium. At least one data writer may write time data and position data into the medium. The picture production apparatus may extract a picture in accordance with the action of the user by using the time data and the position data read from the medium.

The picture production system may further include at least one data reader fixed at a predetermined place, for reading data from the medium. The data reader may read client identification information from the medium, and sends, together with the client identification information, time data and position data to the picture production apparatus. The picture production apparatus may manage the client identification information, the time data, and the position data sent from the data reader, and also obtains the time data and position data based on the client identification information read from the medium, thereby extracting a picture in accordance with the action of the user by using the time data and the position data.

The above-described medium may be a card medium or a medium loaded or integrated into an information processing apparatus.

The information processing apparatus as the medium may include a position detector, and writes position data detected by the position detector into the medium. Alternatively, the information processing apparatus may include a timer, and writes time data obtained by the timer into the medium.

The picture production system may further include at least one medium access device fixed at a predetermined place. The medium may be a medium loaded or integrated into an information processing apparatus provided with a communication function. The medium access device may instruct the information processing apparatus to obtain time data and position data. The information processing apparatus may send, together with client identification information stored in the medium, the time data and the position data transferred from the medium access device or obtained in response to an instruction from the medium access device to the picture production apparatus. The picture production apparatus may manage the client identification information, the time data, and the position data sent from the information processing apparatus, and obtains the time data and the position data based on the client identification information read from the medium, thereby extracting a picture in accordance with the action of the user based on the time data and the position data.

The information processing apparatus may store the time data and the position data transferred from the medium access device into the medium, and sends the client identification information, the time data, and the position data read from the medium to the picture production apparatus.

The information processing apparatus may include a position detector, and sends position data detected by the position detector to the picture production apparatus. Alternatively, the information processing apparatus may include a timer, and sends time data obtained by the timer to the picture production apparatus.

The medium access device may access the medium according to a contact or wired-connection method.

In the picture production system, the medium may be a medium loaded or integrated into an information processing apparatus provided with a recording function. The picture production apparatus may produce a picture with sound based on the picture extracted from the pictures taken by at least one photographic device and sound recorded by the information processing apparatus.

The information processing apparatus may store audio data corresponding to time information in the medium or another storage means provided in the information processing apparatus by using the recording function.

The information processing apparatus may be provided with a communication function, and outputs the audio data recorded by the recording function in association with the time information by using the communication function.

The medium may be a medium loaded or integrated into an information processing apparatus provided with a photographic function. The picture production apparatus may produce an edited picture for the user by using the picture extracted from the pictures taken by at least one photographic device and a picture taken by the information processing apparatus.

The information processing apparatus may store picture data corresponding to time information in the medium or another storage means provided in the information processing apparatus by using the photographic function.

The information processing apparatus may be provided with a communication function, and outputs picture data taken by the photographic function in association with time information by using the communication function.

The picture production apparatus may associate the time data with a time code added to a picture taken by at least one photographic device so as to extract a picture in accordance with the action of the user by using the time data and the position data.

The medium may be a medium loaded or integrated into an information processing apparatus provided with a position detecting function for detecting a position of the user when taking a picture by at least one photographic device. The picture production apparatus may edit the picture extracted from the pictures taken by at least one photographic device by using user position information detected by the position detecting function and position information of at least one photographic device.

The picture production apparatus may enlarge, shrink, or rotate an image for editing a picture by using position information indicating a position of the information processing apparatus detected by the position detecting function and the position information of at least one photographic device.

The information processing apparatus may store the user position information detected by the position detecting function in the medium or another storage means provided in the information processing apparatus.

The information processing apparatus may be provided with a communication function, and outputs the user position information detected by the position detecting function by using the communication function.

The picture production apparatus may produce an edited picture for the user by using a picture extracted from the pictures taken by at least one photographic device and additional picture or additional sound.

The picture production apparatus may select the additional picture or the additional sound used for producing an edited picture based on user information.

The medium may be a medium loaded or integrated into an information processing apparatus provided with a data selection function. The picture production apparatus may extract a picture in accordance with the action of the user from the pictures taken by at least one photographic device at least based on data selected by the data selection function among the data stored in the medium.

At least one photographic device may be disposed at a predetermined place within a photographic-service receiving area. The picture production apparatus may produce an edited picture when the medium leaves the photographic-service receiving area.

According to another aspect of the present invention, there is provided a picture production apparatus including: a picture storage device for storing pictures from at least one photographic device which is disposed at a predetermined place to take pictures; a reader for reading data from a medium which is capable of reading or writing data; and a picture production device for producing a picture by extracting a picture in accordance with an action of a user owning the medium from the pictures stored in the picture storage device based on the data read from the medium by the reader and by editing the picture related to the user.

In the picture production apparatus, the medium may store time data and position data written into the medium by at least one medium access device fixed at a predetermined place, and the picture production means may extract a picture in accordance with the action of the user by using the time data and the position data read from the medium by the reader.

User identification information may be stored in the medium. The picture production apparatus may further include a client-data manager for managing the user identification information, time data, and position data sent from at least one medium access device fixed at a predetermined place. The client-data manager may obtain the time data and the position data based on the user identification information read from the medium by the reader. The picture production device may extract a picture in accordance with the action of the user by using the time data and the position data.

User identification information may be stored in the medium. The picture production apparatus may further include a client-data manager for managing the user identification information, time data, and position data sent from a communication device owned by the user. The client-data manager may obtain the time data and the position data based on the client identification information read from the medium by the reader. The picture production device may extract a picture in accordance with the action of the user based on the time data and the position data.

The picture production device may produce an edited picture by adding an additional picture or additional sound to the extracted picture.

The picture production apparatus may further include: a user-information manager for storing and managing user information, and an additional-information storage device for storing additional pictures or additional sound. The picture production device may produce an edited picture by using the additional picture or additional sound selected from the additional-information storage device by the user-information manager based on the user information.

The picture production apparatus may further include a recorder for recording the edited picture produced by the picture production device into a portable recording medium.

The picture production apparatus may further include a distributor for distributing the edited picture produced by the picture production device.

The picture production apparatus may further include an accounting device for performing accounting processing for the edited picture produced by the picture production device for the user.

The picture production apparatus may further include a sound storage device for storing audio data recorded by a recorder owned by the user. The picture production device may produce an edited picture with sound for the user by using a picture extracted from the picture storage device and sound extracted from the sound storage device.

The picture production device may perform calibration processing for associating the time data with a time code added to a picture taken by at least one photographic device so as to extract a picture in accordance with the action of the user by using the time data and the position data.

The picture production apparatus may further include: a user-position-information storage device for storing user position information detected by an information processing apparatus owned by the user, and a photographic-device-position storage device for storing position information of at least one photographic device. The picture production device may edit a picture extracted from the picture storage device by using the user position information searched from the user-position-information storage device and the photographic-device position information searched from the photographic-device-position information storage device.

The picture production device may enlarge, shrink, or rotate an image for editing a picture extracted from the picture storage device by using the user position information and the photographic-device position information.

The picture production apparatus may further include a user-picture storage device for storing picture data taken by a photographic machine owned by the user. The picture production device may produce an edited picture for the user by using a picture extracted from the picture storage device and a picture extracted from the user-picture storage device.

The picture production apparatus may be disposed at a predetermined place within a photographic-service receiving area, and produces the edited picture when the medium leaves the photographic-service receiving area.

According to still another aspect of the present invention, there is provided a picture production method including: a picture storage step of storing pictures from at least one photographic device which is disposed at a predetermined place to take pictures; a reading step of reading data from a medium which is capable of reading or writing data; and a picture production step of producing a picture by extracting a picture in accordance with an action of a user owning the medium from the pictures stored in the picture storage step based on the data read from the medium in the reading step and by editing the picture related to the user.

In the picture production method, the medium may store time data and position data written into the medium by at least one medium access device fixed at a predetermined place. The picture production step may extract a picture in accordance with the action of the user by using the time data and the position data read from the medium in the reading step.

User identification information may be stored in the medium. The picture production method may further include: a client-data management step of managing the user identification information, time data, and position data sent from at least one medium access device fixed at a predetermined place; and an obtaining step of obtaining the time data and the position data based on the user identification information read from the medium in the reading step. In the picture production step, a picture in accordance with the action of the user may be extracted by using the time data and the position data obtained in the obtaining step.

User identification information may be stored in the medium. The picture production method may further include: a client-data management step of managing the user identification information, time data, and position data sent from a communication device owned by the user; and an obtaining step of obtaining the time data and the position data based on the client identification information read from the medium in the reading step. In the picture production step, a picture in accordance with the action of the user may be extracted based on the time data and the position data.

The picture production method may further include a sound storage step of storing audio data recorded by a recorder owned by the user. In the picture production step, an edited picture with sound for the user may be produced by using a picture extracted from the pictures stored in the picture storage step and sound extracted from the sound stored in the sound storage step.

The picture production method may further include a user-picture storage step of storing picture data taken by a photographic machine owned by the user. In the picture production step, an edited picture for the user may be produced by using a picture extracted from the pictures stored in the picture storage step and a picture extracted from the pictures stored in the user-picture storage step.

In the picture production step, the time data may be associated with a time code added to a picture stored in the picture storage step so as to extract a picture in accordance with the action of the user by using the time data and the position data.

In the picture production step, an edited picture may be produced by adding an additional picture or additional sound to the extracted picture.

The additional picture or the additional sound may be selected based on user information.

In the picture production step, an extracted picture may be edited by using user position information detected by an information processing apparatus owned by the user and position information of at least one photographic device.

In the picture production step, an image may be enlarged, shrunk, or rotated for editing a picture by using the user position information and the position information of at least one photographic device.

The picture production step may be performed when the medium leaves the photographic-service receiving area.

According to the picture production system, and the picture production apparatus and method, picture providing services that are efficient for both the users and commercial entities can be implemented.

The user carries the user medium, and makes a request to write data into the user medium or send data to the picture production apparatus when necessary. When the user wishes to receive picture services, he/she allows the picture production apparatus to read the data of the user medium when he/she leaves the facility. Accordingly, the user does not have to wait for receiving services at each spot of the facility, and the work load for receiving services is very small. Thus, the time loss/load and the work loss/load for the user can be significantly reduced. This enables the user to make the best use of the facility, for example, by enjoying more attractions in a theme park. By using the picture services, the user does not have to take pictures of himself/herself.

The commercial entity does not have to provide production/sales facilities or manpower for picture services at each spot in the facility, thereby making it possible to reduce the cost and the work load. In response to a request from the user to provide services, pictures of the user at each position can be simultaneously processed, and the resulting picture package can be provided. Accordingly, the work for each user can be made more efficient, thereby enhancing the efficiency of the entire work for providing services.

As for the commercial entity, instead of taking pictures for all the individual users, it is sufficient that pictures simply taken by photographic devices during the day are stored in a picture database, and that picture data is extracted from time data and position data of each user. It is thus possible for the commercial entity to provide picture sales services for individual users with high efficiency and low cost.

If a picture package is produced by adding additional pictures to the extracted pictures, the resulting picture package has a high value, and improved services can be provided.

It is sufficient that data to be stored in the user medium is restricted to client ID information, time data, and position data. Accordingly, the user medium can be implemented by a small-capacity storage medium, and thus, it can be provided to the user with low cost when the user medium is sold in the form of, for example, a memory card.

As the information processing apparatus, a cellular telephone, a personal digital assistant (PDA), or a personal computer owned by the user can be used. Accordingly, the user does not have to buy a new device for the information processing apparatus.

If the information processing apparatus has a timer or a position detector, the medium access device does not have to generate time data or position data. Thus, the provision of the medium access device may be eliminated, thereby further reducing the facility cost.

In the system in which time data and position data are written into the user medium, data is not sent from the user medium to another source, thereby preventing the leakage or unauthorized use of the data concerning the user.

In the system in which client ID information is read from the user medium and sent to the picture production apparatus together with time data and position data, the writing of the data into the user medium is not necessary, and it is sufficient that at least client ID information is recorded in the user medium. Thus, the user medium can be an inexpensive, small-capacity medium, and the medium access device may be a simple reader without a writing function, thereby further reducing the facility cost for the commercial entity.

In the system in which client ID information, time data, and position data are sent from an information processing apparatus loading/integrating the user medium to the picture production apparatus, the medium access device may be a simple writer for writing time data and position data. Alternatively, if the information processing apparatus is capable of obtaining time data and position data by itself, the medium access device may be a device simply for giving a writing or sending instruction without a communication function. Accordingly, the cost of the medium access device is significantly reduced, and the facility load for the commercial entity is further reduced. The user medium may store only client ID information, in which case, an inexpensive, small-capacity medium can be used.

In picture production, pictures are extracted based on time data and position data. Accordingly, even an anonymous user is able to use picture services, thereby enhancing the protection of the user' privacy.

Wireless (non-contact) communication may be performed between the user medium and the medium access device, and thus, the work load is further reduced for both the user and commercial entity, and the time required is also reduced.

A picture package can be distributed via a communication line. Accordingly, the user does not have to receive the picture package on the spot, thereby eliminating a waiting time for producing a picture package.

In contrast, the user may receive a picture package in the form of a portable medium, in which case, the user does not have to give a destination address to the commercial entity, and he/she is able to receive picture services while protecting his/her privacy.

If a picture package with sound is produced by using audio data recorded by the information processing apparatus owned by the user, sound around the user can be contained, thereby making the pictures more interesting.

If a picture package is produced by using picture data taken by the information processing apparatus owned by the user, pictures taken by the user can be contained, thereby making the pictures more personal and interesting. Additionally, pictures at a place where a photographic device prepared by the commercial entity is not available can be contained.

If audio data or picture data recorded or taken by the information processing apparatus owned by the user is stored in the user medium or another storage medium, it can be easily provided to the commercial entity. Audio data or picture data may be sent to the commercial entity by using a communication function of the information processing apparatus, in which case, the data can be provided to the commercial entity regardless of the storage capacity of the information processing apparatus.

In extracting pictures from a database, calibration processing can be performed for associating the time data in accordance with the user's actions with a time code added to a picture taken by a photographic device, thereby making it possible to correctly extract pictures. This is effective particularly when the photographic device is a type which adds a time code from the photograph start time to a picture rather than adding actual time.

The picture production apparatus can perform secondary editing processing, for example, enlarging, shrinking, or rotating pictures extracted from the pictures taken by the photographic device by using position information of the photographic device and user position information detected by a position detecting function of the information processing apparatus owned by the user. Thus, the resulting picture package becomes more suitable and interesting for each user.

The picture production apparatus can produce a picture package by using pictures extracted from the pictures taken by the photographic device and additional pictures or additional sound selected based on user information (user attribute data). Accordingly, the commercial entity can improve the services for the users by providing effective information, and also perform promotion and advertisement. The resulting picture package is more valuable for the users.

If the information processing apparatus has a data selection function and extracts pictures in accordance with the user's actions at least based on the data selected by the data selection function among the data stored in the user medium, a picture package desired by the user can be provided.

### BRIEF DESCRIPTION OF THE DRAWINGS

FIG. 1 illustrates a first example of a system according to an embodiment of the present invention;

FIG. 2 is a block diagram illustrating a picture production apparatus in the first example of the system;

FIG. 3 is a flowchart illustrating picture production processing in the first example of the system;

FIG. 4 illustrates client data stored in a user medium;

FIG. 5 is a flowchart illustrating processing for generating a picture-extracting database;

FIG. 6 illustrates a picture-extracting database;

FIG. 7 illustrates a process for producing a picture package;

FIG. 8 illustrates a second example of the system according to an embodiment of the present invention;

FIG. 9 is a block diagram illustrating a picture production apparatus in the second example of the system;

FIG. 10 is a flowchart illustrating client-data storage processing in the second example of the system;

FIG. 11 is a flowchart illustrating picture production processing in the second example of the system;

FIG. 12 illustrates a third example of the system according to an embodiment of the present invention;

FIG. 13 is a block diagram illustrating a picture production apparatus in the third example of the system;

FIG. 14 is a flowchart illustrating client-data storage processing in the third example of the system;

FIGS. 15A through 15D illustrate examples of the configuration of a reader/writer in the first example of the system;

FIGS. 16A through 16D illustrate examples of the configuration of a reader in the second example of the system;

FIGS. 17A and 17B illustrate examples of the configuration of a writer in the third example of the system;

FIGS. 18A and 18B illustrate examples of the configuration of a trigger device in the third example of the system;

FIGS. 19A through 23B illustrate examples of the configuration of a user medium;

FIG. 24 illustrates the configuration of a system using an information processing apparatus provided with a recording function according to an embodiment of the present invention;

FIG. 25 is a block diagram illustrating a picture production apparatus corresponding to the information processing apparatus shown in FIG. 24;

FIGS. 26A and 26B illustrate client data and audio data stored in the user medium;

FIG. 27 is a flowchart illustrating processing for generating a picture/audio-extracting database;

FIG. 28 illustrates processing for generating a picture/audio-extracting database;

FIG. 29 illustrates a process for producing a picture/audio package;

FIGS. 30A and 30B illustrate examples of the configuration of a user medium as an information processing apparatus with a recording function;

FIG. 31 illustrates an example of the configuration of the system using an information processing apparatus provided with a photographic function according to an embodiment of the present invention;

FIG. 32 is a block diagram illustrating a picture production apparatus corresponding to the information processing apparatus shown in FIG. 31;

FIGS. 33A and 33B illustrate client data and picture data stored in the user medium;

FIG. 34 is a flowchart illustrating processing for generating a picture-extracting database;

FIG. 35 illustrates processing for generating a picture-extracting database;

FIG. 36 illustrates a process for producing a picture package;

FIGS. 37A and 37B illustrate examples of the configuration of a user medium as an information processing apparatus with a photographic function;

FIG. 38 illustrates a user medium attached to the user's hip;

FIG. 39 illustrates a user medium attached to the user's back;

FIG. 40 illustrates a user medium attached to the user's sole;

FIG. 41 illustrates a system in which photographic devices are disposed in the vicinity of medium access devices according to an embodiment of the present invention;

FIG. 42 illustrates client data stored in the user medium;

FIG. 43 is a flowchart illustrating processing for generating a picture-extracting database;

FIG. 44 illustrates processing for generating a picture-extracting database;

FIG. 45 illustrates a process for producing a picture package;

FIG. 46 illustrates a system using a user medium attached to the user's sole;

FIG. 47 illustrates time calibration performed in the system of the present invention;

FIG. 48 is a block diagram illustrating a picture production apparatus performing time calibration;

FIG. 49 is a flowchart illustrating processing for producing a picture-extracting database by performing time calibration;

FIG. 50 illustrates processing for generating a picture-extracting database by performing time calibration;

FIG. 51 illustrates a process for producing a picture package;

FIG. 52 illustrates time calibration performed in the system of the present invention;

FIG. 53 illustrates the configuration of a system using user GPS data according to an embodiment of the present invention;

FIG. 54 is a block diagram illustrating a picture production apparatus using user GPS data;

FIG. 55 illustrates client data stored in the user medium;

FIG. 56 is a flowchart illustrating picture editing processing including secondary editing;

FIG. 57 illustrates a process for producing a picture package by performing picture editing processing including secondary editing;

FIGS. 58A, 58B, and 58C illustrate an example of secondary editing;

FIG. 59 is a block diagram illustrating a picture production apparatus using user attribute data according to an embodiment of the present invention;

FIG. 60 is a flowchart illustrating picture editing processing by using additional information based on user attribute data;

FIGS. 61A, 61B, and 61C illustrate a process for producing a picture package by using additional information based on user attribute data;

FIGS. 62A, 62B, and 62C illustrate a process for producing a picture package by using additional information based on user attribute data;

FIG. 63A illustrates examples of information stored in a user attribute database;

FIG. 63B illustrates an approach to selecting additional data;

FIG. 64 is a block diagram illustrating an information processing apparatus provided with a selection function;

FIGS. 65 and 66 illustrate display examples of action history information; and

FIG. 67 illustrates the system of the present invention in comparison with a known system.

### DESCRIPTION OF THE PREFERRED EMBODIMENTS

The present invention is described in detail below with reference to the accompanying drawings through illustration of preferred embodiments. It should be noted that a “database” described in this specification is not a physical medium, but a file system in which data is managed. An embodiment of the present invention is described in the following order.

1. Overall system
2. First example of system
3. Second example of system
4. Third example of system
5. Various configurations of user medium and medium access device
6. Use of recorded user's voice
7. Use of pictures taken by user
8. Wireless-connection access to user medium and corresponding system
9. Time calibration
10. Editing using user position information and photographic-device position information
11. Additional pictures/sound according to user
12. Selection of data by user
13. Various modifications

### 1. Overall System

An overall system of an embodiment of the present invention is described below.

In this system, a user purchasing or using a service or a product (hereinafter also referred to as “goods”) in a theme park or another type of facility, possesses a user medium. The user medium is, for example, a card-type storage medium or a storage medium loaded or integrated into a user's information processing apparatus (personal digital assistant (PDA), a mobile personal computer, a cellular telephone, etc.).

The user medium does not have to be an electrical data storage medium, and may be a magnetic or optical data storage medium or a punch-recording storage medium.

The user may purchase such a user medium from a commercial entity or prepare it on his/her own.

In the facility, photographic devices are installed at certain places and constantly take pictures. Also in the facility, medium access devices (reader/writers, readers, writers, or trigger devices) are installed at certain places, and the user is able to read or write data from or into the user medium by using such medium access devices.

The user medium may reserve an area into which data can be recorded by using the medium access devices (reader/writers or writers) disposed in the facility. The user medium may reserve an area from which data can be played back by using the medium access devices (reader/writers or readers). Alternatively, data may be read or written, or sent by the triggering by the medium access devices (trigger devices). These modes are specifically described below as first, second, and third examples of the system.

The data to be stored in the user medium includes client identification information (client ID) unique to the user, and time data and position data in accordance with the user's activity in the facility.

The medium access devices access the user medium by a contact or wired connection or a non-contact or wireless connection.

The user presents this user medium when or after using, for example, an attraction in the facility, and then, time data indicating the corresponding time and position data indicating the position of the user are recorded in the user medium.

If the time data and the position data in the user medium can be safely identified and managed by the commercial entity, the medium access device transfers the client data (client ID, time data, and position data) unique to the user to a database of a picture production apparatus via a network.

Alternatively, instead of the medium access device, the information processing apparatus integrating the user medium therein may transfer the client data to the database of the picture production apparatus via a network, for example, a public line.

When leaving the facility, the user presents this user medium to a service/product provider (hereinafter also referred to as a “commercial entity”). Then, the commercial entity reads data from the user medium so as to produce a picture package for the user by using the time data and the position data recorded (or managed together with the client ID) in the user medium. That is, from the time data and the position data concerning the user, pictures of the user taken at various times and places are extracted and edited so as to produce a picture package.

The picture package unique to the user produced as described above is recorded as photographs or in a recording medium, for example, a compact disc (CD) or a digital versatile disk (DVD), and is then directly sold to the user or is distributed to the user's transmitter/receiver, for example, a cellular telephone, a personal computer, a television, or a home server.

According to this system, the user is able to easily and simultaneously receive video pictures or photographs unique to himself/herself in the form of a recording medium or by using a picture distribution service.

Also according to this system, the user is able to purchase videos or photographs of himself/herself at one time when leaving the facility, thereby significantly reducing the waiting time for developing photographs or editing video pictures for each attraction or the time required for paying for the purchased photographs or video pictures and the work load therefor. As a result, the user does not have to waste time while staying in the facility.

As for the commercial entity, the need to prepare facilities, devices, and manpower for developing photographs or editing video pictures and selling them for each attraction can be eliminated, thereby making it possible to reduce the facility cost and manpower cost.

### 2. First Example of System

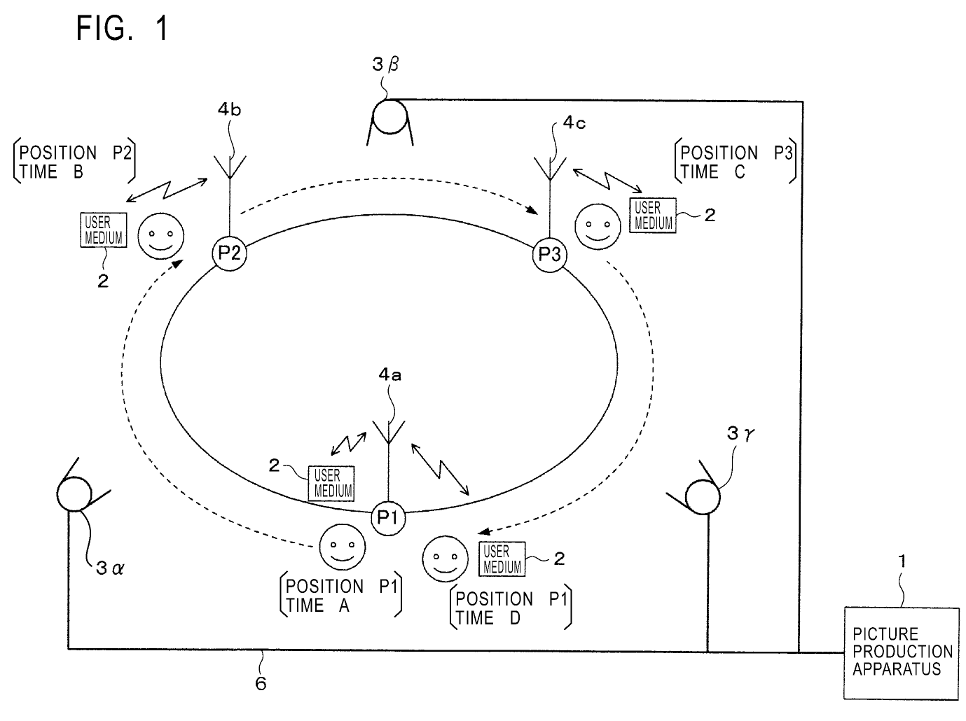

A first example of the system is as follows. FIG. 1 schematically illustrates the system of this embodiment indicating a service receiving area, for example, a theme park or a golf course.

In this service receiving area, a user performs actions, for example, enjoying many attractions, with a user medium 2.

In the service receiving area, readers/writers 4a, 4b, and 4c, and so on, which serve as the medium access devices, are installed at corresponding positions P1, P2, P3, and so on. The readers/writers 4a, 4b, 4c, and so on, record and play back data into and from the user medium 2 when the user presents the recording medium 2. In this case, the readers/writers 4a, 4b, 4c, and so on, write time data and position data into the user medium 2.

In the service receiving area, a plurality of photographic devices 3α, 3β, 3γ, and so on, are installed. For example, the photographic device 3α is fixed at a predetermined position between the positions P1 and P2. The photographic device 3β is fixed at a predetermined position between the positions P2 and P3. The photographic device 3γ is fixed at a predetermined position between the positions P3 and P1.

The photographic devices 3α, 3β, 3γ, and so on, constantly take pictures at the corresponding positions, and store the pictures. The pictures are recorded in synchronization with the time data. The photographic devices 3α, 3β, 3γ, and so on, transfer the photographed (photographed and stored) picture data in real time or at regular intervals to a picture production apparatus 1 via a network 6.

In this first example of the system, each reader/writer 4 (4a, 4b, 4c, and so on) is an independent device which is not connected to the network 6. However, it may be connected to the network 6 to perform communication with the picture production apparatus 1. For example, for maintenance or checking of the operation of the reader/writer 4, or supplying the current time for synchronization, the reader/writer 4 may be suitably connected to the network 6 so that the picture production apparatus 1 can manage the reader/writer 4.

In such a facility having the service receiving area shown in FIG. 1, the user carries the user medium 2, and performs an action while writing data into the user medium 2 by using the reader/writer 4 when necessary.

The user purchases or rents the user medium 2 when entering this facility, or prepares it on his/her own in advance. The client ID for identifying the user is already recorded in the user medium 2. The client ID is sufficient if the user of the service provided by this system can be identified, and does not have to contain user personal information (address, name, etc.). A desired ID number can be set by the commercial entity.

It is now assumed that the user is located at position P1 at time A after entering the facility. In this case, when the user presents the user medium 2, the reader/writer 4a writes time data A and position data P1 into the user medium 2.

Then, the user performs an action, as indicated by the broken lines in FIG. 1, for example, entering the attraction from position P1 and proceeding to position P2. The photographic device 3α, which takes pictures between positions P1 and P2, takes pictures of the user at certain points therebetween.

The user also presents the user medium 2 at position

P2. Then, the reader/writer 4b writes time data B and position data P2 into the user medium 2. The user then proceeds to position P3, and the photographic device 3β takes pictures of the user at certain points between positions P2 and P3.

Similarly, at position P3, the reader/writer 4c writes time data C and position data P3 into the user medium 2. After the user reaches position P1, as indicated by the broken line in FIG. 1, the reader/writer 4a writes time data D and position data P1 into the user medium 2.

Pictures of the user who has acted as described above are taken by the photographic devices 3α, 3β, and 3γ at certain points. If the user wishes to purchase the pictures that have been taken, he/she presents the user medium 2 to the picture production apparatus 1. The picture production apparatus 1 extracts the pictures of the user from those taken by the photographic devices 3α, 3β, 3γ, and so on, based on the time data and the position data recorded in the user medium 2 so as to produce a picture package for the user, and then provides it to the user.

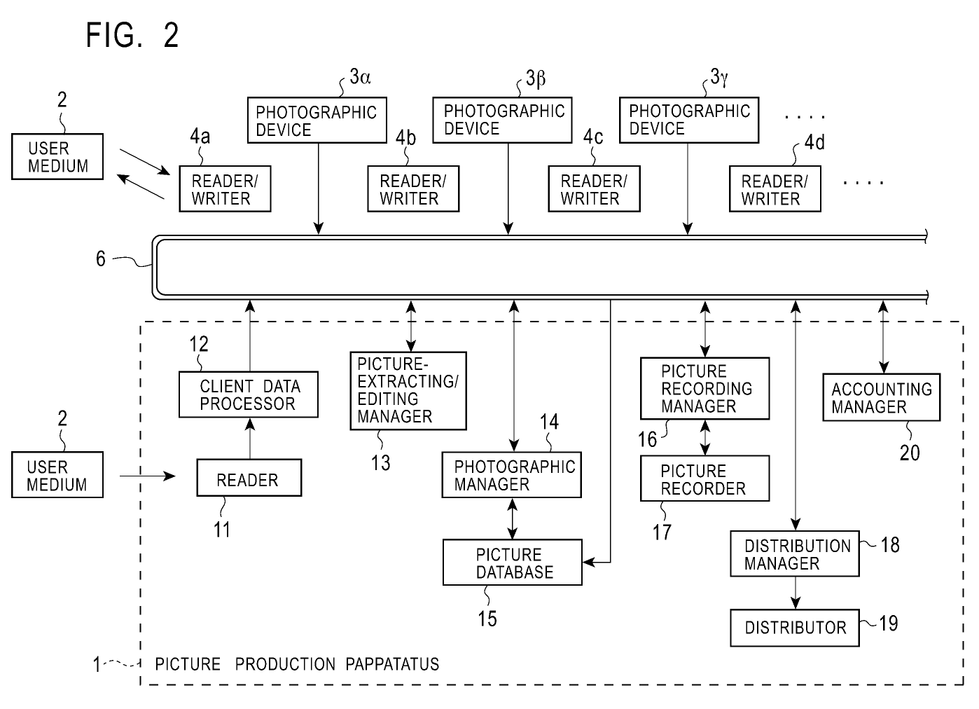

FIG. 2 illustrates details of the picture production apparatus 1 in the system shown in FIG. 1.

In the picture production apparatus 1, a reader 11 reads recorded data (client ID, time data, and position data) from the user medium 2 presented by the user. As the reader 11, one of the readers/writers 4 installed, as shown in FIG. 1, may be used. For example, the reader/writer 4a near the entrance/exit of the facility may be used as the reader 11.

A client data processor 12 processes the client data, i.e., client ID, time data, and position data, read from the user medium 2 by the reader 11. The client data processor 12 performs, for example, data correction, data format verification, and data rearrangement, so as to form the client data into a data group required for creating a picture-extracting database, which is described below. The client data processor 12 then transfers the data group to a picture-extracting/editing manager 13.

The picture-extracting/editing manager 13 creates the picture-extracting database, gives an instruction to extract pictures, and edits picture data so as to produce a picture package.

The picture-extracting database, which is a database used for extracting pictures unique to each user, is created by using the time data and the position data concerning the user as the data group transferred from the client data processor 12. The picture-extracting database may be created by the client data processor 12, and is received by the picture-extracting/editing manager 13.

The picture-extracting/editing manager 13 instructs a photographic manager 14 to extract and transfer required picture data based on the created (or transferred) picture-extracting database. The picture-extracting/editing manager 13 also edits picture data extracted and transferred from the client data processor 12 so as to produce a picture package for the user.

The photographic manager 14 manages the picture-extracting database. Picture data taken by each photographic device 3 (3α, 3β, 3γ, and so on) is constantly transferred via the network 6, and is stored in a picture database 15, for example, in synchronization with the time data of each photographic device 3.

The photographic manager 14 extracts picture data from the picture database 15 in response to an instruction from the picture-extracting/editing manager 13, and transfers the extracted picture data to the picture-extracting/editing manager 13.

A picture recording manager 16 allows a picture recorder 17 to record pictures in accordance with the edited result of the picture package by the picture-extracting/editing manager 13.

The picture recorder 17 is in the form of a photo-taking machine or a picture data recorder for still images or moving pictures, for example, a disk recorder, a magnetic tape recorder, or a memory card drive.

The picture recording manager 16 allows the picture recorder 17 to record the picture package transferred from the picture-extracting/editing manager 13 into a recording medium as photographs or video picture data. For example, still image data is printed on paper, or moving-picture video data or still-image video data is recorded on a compact disc recordable (CD-R), a digital versatile disk recordable (DVD-R), or a memory card (semiconductor recording medium).

A distribution manager 18 distributes the picture package produced by the picture-extracting/editing manager 13.

A distributor 19 is connected to a predetermined network, for example, a public telephone line, an optical fiber network, or a satellite communication line, so as to distribute picture data to an external terminal.

The distribution manager 18 allows the distributor 19 to distribute the produced picture package to, for example, a user's terminal as a user's transceiver/receiver such as a cellular telephone, a personal computer, a television provided with a terminal function, or a home server.

An account manager 20 performs accounting processing, for example, data storage/management and data communication for bank settlement, credit-card settlement, or billing, when providing picture services to the user by way of a recording medium or picture distribution.

The client data processor 12, the picture-extracting/editing manager 13, the photographic manager 14, the picture database 15, the picture recording manager 16, the distribution manager 18, and the accounting manager 20 may be in the form of independent computers so as to be connected in parallel with each other via the network 6. Alternatively, these elements may be connected in series with each other, for example, the computers serving as these elements may be connected by using a local area network (LAN), and this LAN is connected to a LAN implemented by the network 6 starting from a certain computer.

Alternatively, the client data processor 12, the picture-extracting/editing manager 13, the photographic manager 14, the picture recording manager 16, the distribution manager 18, and the accounting manager 20 are not formed independently, and may be wholly or partially implemented by the same computer.

The operation of the above-described system is as follows.

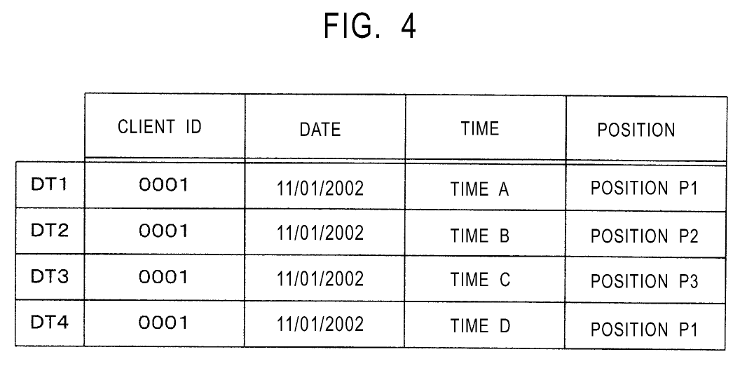

It is now assumed that the user performs an action, as indicated by the broken lines in FIG. 1 with the user medium 2, and that each reader/writer 4a, 4b, 4c, and 4a records time data and position data into the user medium 2. In this case, data, such as that shown in FIG. 4, is recorded in the user medium 2. For the sake of convenience, the client ID, the time data, and the position data recorded in the user medium 2 are collectively referred to as “client data”.

As shown in FIG. 4, as a result of writing data four times by the readers/writers 4a, 4b, 4c, and 4a, client data DT1 through DT4 are recorded in the user medium 2. In this case, each client data contains client ID, time data (time and date), and position data.

The picture data constantly taken by the photographic devices 3α, 3β, and 3γ are transferred to the picture production apparatus 1 via the network 6, and are stored in the picture database 15.

If the user wishes to purchase a picture package containing user's pictures after performing an action, as described with reference to FIG. 1, in the state in which the client data shown in FIG. 4 is recorded in the user medium 2, the user presents the user medium 2 at a service reception.

At the service reception, the picture production apparatus 1 reads the client data from the user medium 2 by using the reader 11 so as to produce a picture package for the user.

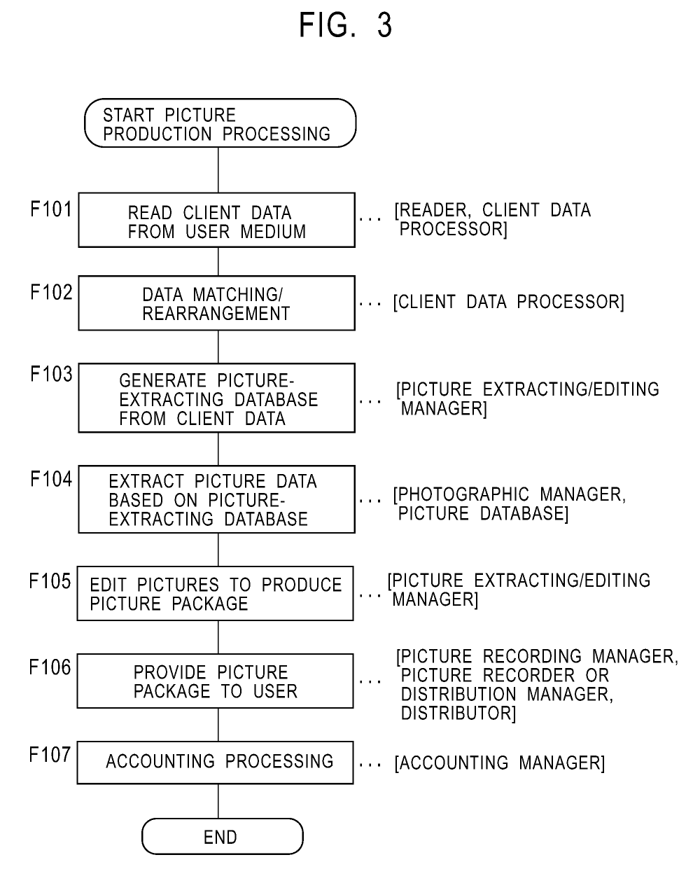

The picture production process performed by the picture production apparatus 1 is described below with reference to FIG. 3.

In step F101, the picture production apparatus 1 reads the client data recorded in the user medium 2 by using the reader 11.

In step F102, the client data processor 12 performs data matching or data rearrangement of the client data.

In step F103, the picture-extracting/editing manager 13 (or the client data processor 12) creates a picture-extracting database based on the data-matching/rearrangement results.

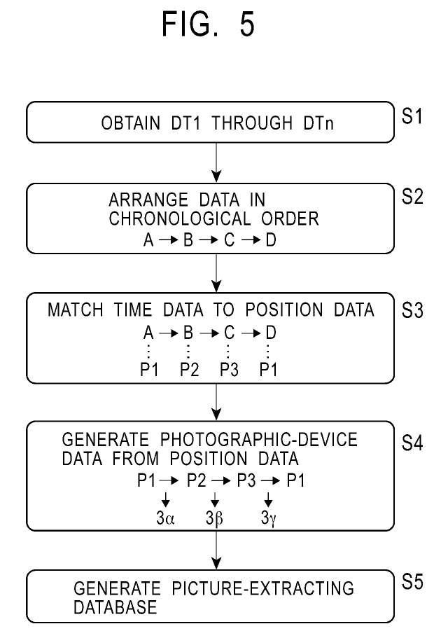

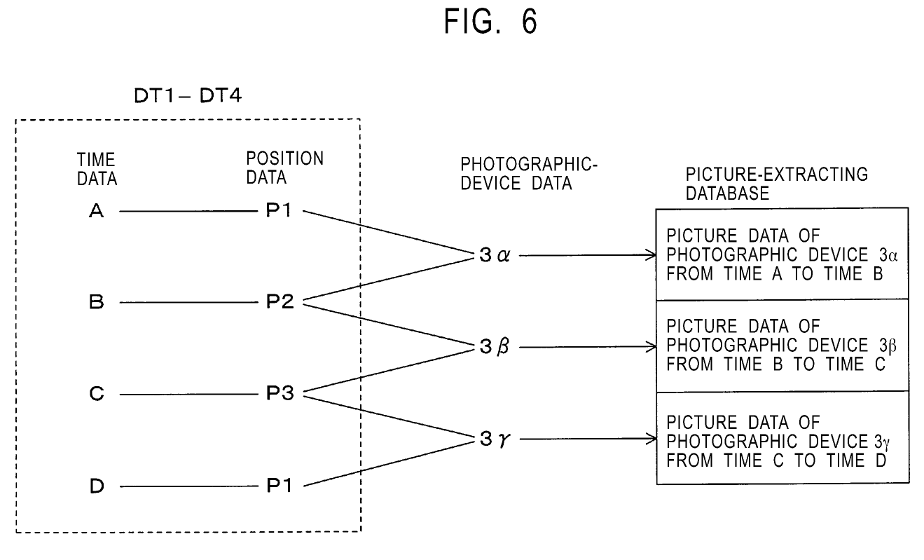

The processing in steps F102 and F103, i.e., data matching/rearrangement processing for creating a picture, is now discussed with reference to FIGS. 5 and 6.

In step S1 of FIG. 5, client data containing time data and position data, i.e., DT1 through DTn (DT1 through DT4 in FIG. 4) are obtained. Then, in step S2, the client data DT1 through DTn are rearranged in chronological order. In the example shown in FIG. 4, the client data is rearranged in chronological order, i.e., time A→B→C→D.

Then, in step S3, the time data rearranged in chronological order is matched to the position data. In the example shown in FIG. 4, the position data associated with the chronological order is P1→P2→P3→P1.

In step S4, the corresponding photographic-device data is generated from the rearranged position data. In the example of the system shown in FIG. 1, the photographic device 3α corresponds to the zone from position P1 to position P2, the photographic device 3β corresponds to the zone from position P2 to position P3, and the photographic device 3γ is associated with the zone from position P3 to position P1.

Finally, in step S5, a picture-extracting database in which the photographic device data is correlated to the time data is generated.

That is, the picture-extracting database is a list indicating picture data from the photographic device 3α from time A to time B, picture data from the photographic device 3β from time B to time C, and picture data from the photographic device 3γ from time C to time D.

The processing of step S2 through S5 is schematically shown in FIG. 6.

As shown in FIG. 6, the photographic device data “3α”, “3β”, and “3γ” that specify the photographic devices for the corresponding zones are obtained from position data P1, P2, P3, and P1 rearranged in chronological order, thereby generating a picture-extracting database indicating the picture data to be extracted for each zone. In this manner, by performing matching between the time data, the position data, and the photographic device data, a database for extracting picture data for each user is generated.

After completing the creation of the picture-extracting database in steps F102 and F103 of FIG. 3, the process proceeds to step F104 in which picture data is extracted based on the picture-extracting database.

That is, the picture-extracting/editing manager 13 instructs the photographic manager 14 to extract the required pictures based on the picture-extracting database.

More specifically, the picture-extracting/editing manager 13 instructs the photographic manager 14 to read the picture data from the photographic device 3α from time A to time B, the picture data from the photographic device 3β from time B to time C, and the picture data from the photographic device 3γ from time C to time D from the picture database 15.

In response to this instruction, the photographic manager 14 selects and extracts the specified pictures from the picture data of the photographic devices 3α, 3β, and 3γ recorded in the picture database 15, and transfers the extracted picture data to the picture-extracting/editing manager 13.

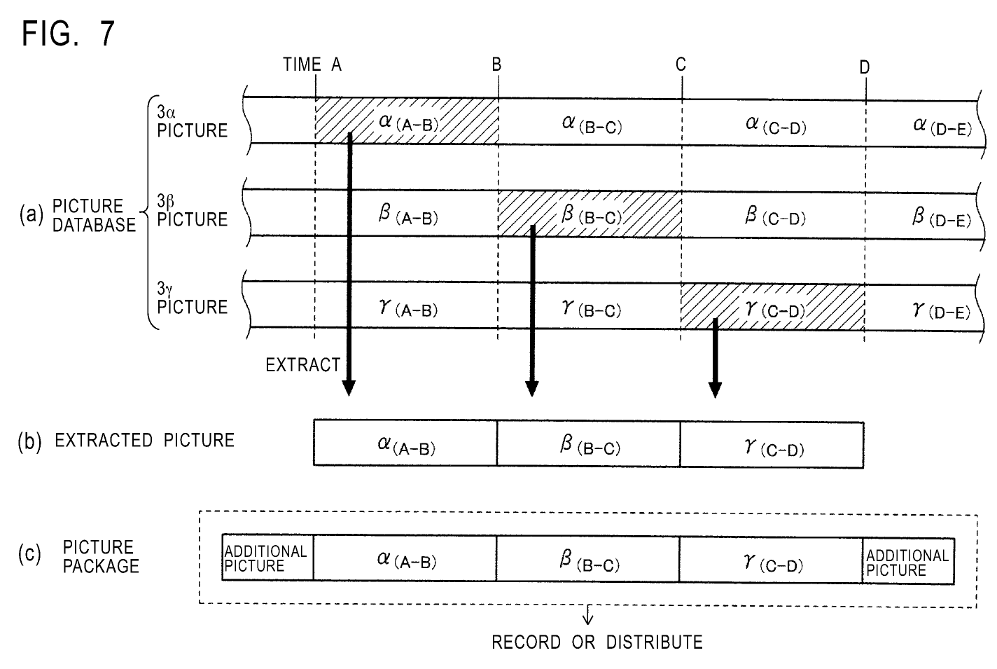

FIG. 7 schematically illustrates the extraction of pictures.

As indicated by (a) of FIG. 7, the picture data taken by the photographic devices 3α, 3β, and 3γ are stored in the picture database 15.

Based on the picture-extracting database, the photographic manager 14 extracts picture data α_{(A-B)} taken by the photographic device 3α from time A to time B, picture data β_{(B-C)} taken by the photographic device 3β from time B to time C, and picture data γ_{(C-D)} taken by the photographic device 3γ from time C to time D, and transfers the extracted picture data as indicated by (b) of FIG. 7 to the picture-extracting/editing manager 13.

In step F105 of FIG. 3, the picture-extracting/editing manager 13 performs predetermined processing, for example, editing of the picture data α_{(A-B)}, β_{(B-C)}, and γ_{(C-D)} transferred from the photographic manager 14 in chronological order, or cutting of the time length.

In some cases, the entire picture of an attraction or a promotional picture of an attraction or a facility may be inserted before or after, or in the middle of the picture data α_{(A-B)}, β_{(B-C)}, and γ_{(C-D)} as an additional picture.

By performing such editing processing, a picture package can be generated. An example of the picture package by using the picture data α_{(A-B)}, β_{(B-C)}, and γ_{(C-D)} and by inserting additional pictures before and after the picture data is shown in (c) of FIG. 7.

In the above-described example, pictures taken by the photographic device 3 and additional pictures are used as the picture package. However, the picture package may contain audio data accompanying these pictures. For example, sound simultaneously recorded with the pictures by the photographic device 3 or sound accompanying the additional pictures may be added. Alternatively, audio data prepared by the commercial entity, for example, background music (BGM) or sound effects may be added.

The same applies to the subsequent description of the specification, and it is assumed that pictures or picture data include audio data accompanying the pictures or picture data.

In step F106, the completed picture package is provided to the user. That is, the data as the picture package is transferred to the picture recording manager 16 or the distribution manager 18.

The picture recording manager 16 allows the picture recorder 17, for example, a CD-R or DVD-R recorder or a semiconductor memory recorder, which is connected to the picture recording manager 16, to record the picture package, i.e., picture data unique to the user, into a recording medium, for example, a CD-R, a DVD-R, or a semiconductor memory, respectively. The recording medium having the recorded picture package is transferred (sold) to the user, thereby making the picture package available to the user.

The distribution manager 18 allows the distributor 19, for example, a communication device including a coder and an encryption device, which is connected to the distribution manager 18, to distribute the picture package to a cellular telephone, a personal computer, or a home server owned by the user via an external network, for example, a public line, thereby also making the picture package available to the user.

In step F107, the accounting manager 20 performs accounting processing after providing the picture package to the user. If the user selects, for example, credit-card settlement, the sales information is transferred to the accounting manager 20 in accordance with the sales type (distribution of the picture package or the delivery of the recording medium), and the payment for this service is managed according to the accounting method selected by the user. For example, the sales time and date, the sales type (distribution of picture package/delivery of recording medium), the credit card number or the bank account number of the user, and the billing issuance data are managed.

According to the above-described system of this embodiment, picture providing services that are efficient for both the users and commercial entities can be implemented.

The user using the facility carries the user medium 2 and writes data into the user medium 2 when necessary, and if the user wishes to purchase a picture package service, he/she merely requests the picture production apparatus 1 to read the data from the user medium 2 when leaving the facility.

Accordingly, the waiting time for receiving picture services at certain places (for example, positions P2 and P3) in the facility, which is necessary in known systems, can be saved, and the work load for the user is minimal. Thus, the time load and the work load for the user can be significantly reduced. This enables the user to make the best use of the facility, for example, enjoying more attractions, for example, in a theme park.

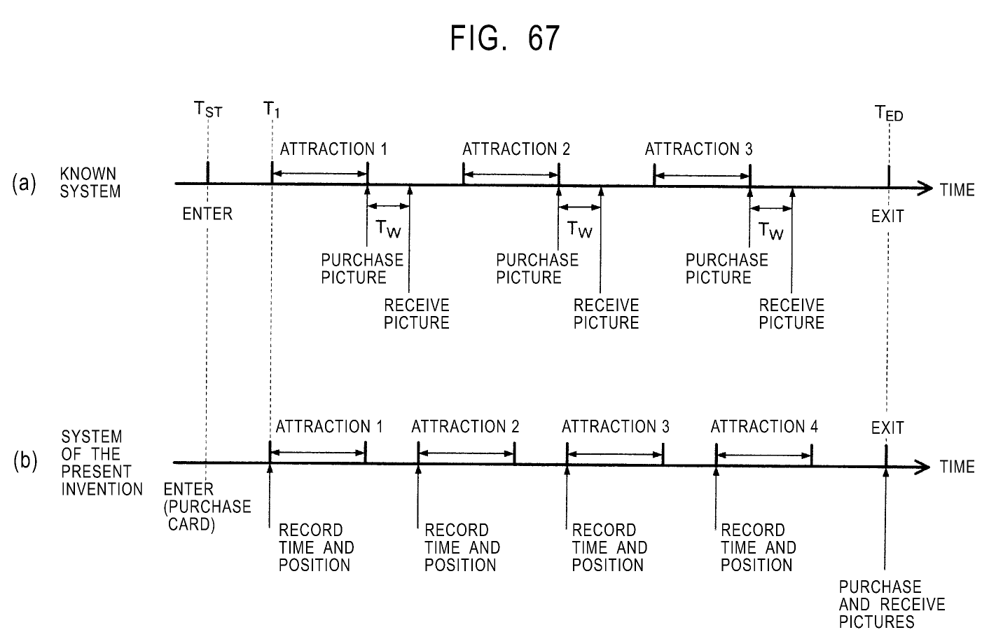

An example of the user's actions using this system is indicated in (b) of FIG. 67. As discussed above, in the known system indicated in (a) of FIG. 67, the user requires the waiting time T_{w} for receiving pictures after using each attraction. In contrast, the user does not require the waiting time T_{w} in this system of the present invention, thereby enabling the user to make the best use of time. For example, the user is able to enjoy four attractions, i.e., attraction 1 through attraction 4, as indicated in (b) of FIG. 67.

By utilizing this picture service system, the user does not have to take pictures of himself/herself.

The commercial entity does not have to provide production/sales facilities or manpower for picture services at certain places (positions P2 and P3), thereby making it possible to reduce the cost and the work load. In response to a request from the user to provide services, pictures of the user at each position can be simultaneously processed, and the resulting picture package can be provided. Accordingly, the work for each user can be made more efficient, thereby enhancing the efficiency of the entire work for providing services.

Additionally, pictures are taken constantly and unconditionally during the day rather than being taken intentionally for each user, and are stored in the picture database 15. Among such pictures, picture data can be extracted according to time data and position data of the corresponding user, thereby making it possible to provide picture sales services for the individual users with high efficiency and low cost.

If additional pictures are added to pictures reflecting the user's actions, a higher-quality picture package can be produced, thereby improving the value of the services.

Particularly, by inserting, for example, a promotional picture of an attraction, as indicated by (c) of FIG. 7, the resulting picture package becomes very impressive to the user. Thus, the user can enjoy the benefit of a reduction in the fee for using this system because part of the cost of this system can be borne by the promotional picture.

Since the data stored in the user medium 2 is small, such as the client ID unique to the user, and the time data and position data, the user medium 2 can be implemented by a small-capacity storage medium.

In the above-described example of the system, data is only written into the user medium 2 without being transmitted to another source, thereby eliminating the possibility of leakage or unauthorized use of the data.

Since the reader/writer 4a does not have to be connected to the network 6, the flexibility in the installment of the reader/writer 4a can be increased, and a network communication function is not required for the reader/writer 4a.

According to the picture production by the picture production apparatus 1, since pictures are extracted based on time data and position data, even an anonymous user is able to use the picture services, and the protection of the user's privacy can be enhanced.

A picture package can be provided to the user by distribution, and thus, the user does not have to receive a picture package on the spot, thereby saving the entire waiting time for picture production.

When the user receives a picture package by way of a portable medium, for example, a disk, the user does not have to give his/her address or email address, and he/she is able to receive picture services while protecting his/her privacy.

### 3. Second Example of System

The second example of the system of the present invention is discussed below. The same elements as those of the first example of the system are indicated by like reference numerals, and a detailed explanation thereof is thus omitted.

In the second example of the system, instead of directly writing time data and position data into the user medium 2, the writing of time data and position data into the user medium 2 is managed by the picture production apparatus 1 via the network 6.

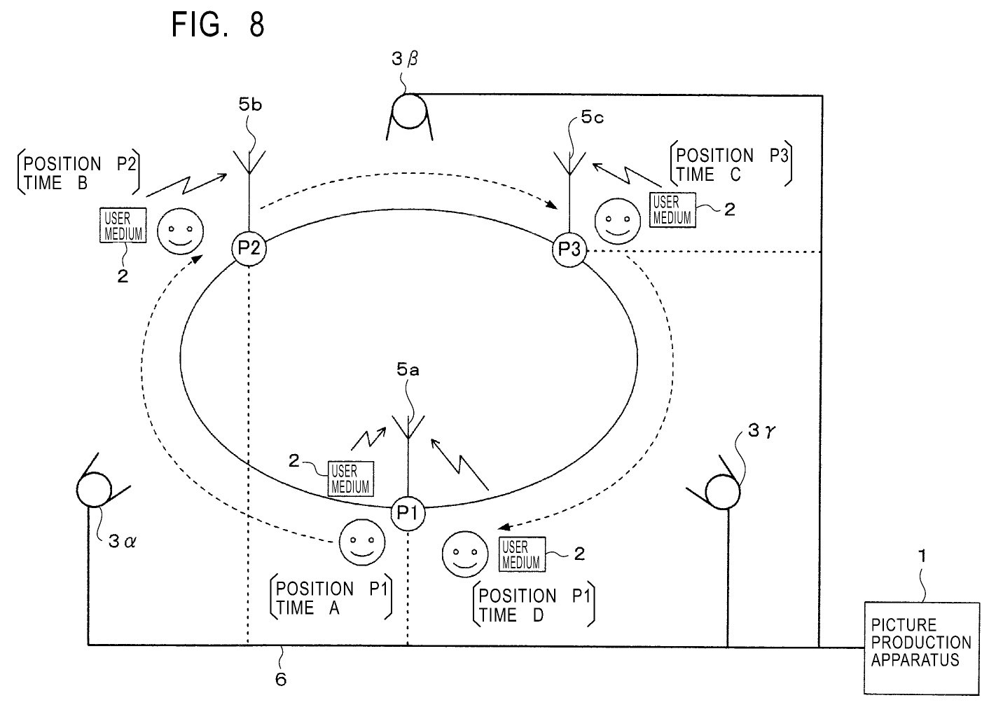

The configuration of the second example of the system is shown in FIG. 8. In the service receiving area, readers 5a, 5b, 5c, and so on, which serve as the medium access devices, are installed at positions P1, P2, P3, and so on. When the user presents the user medium 2, the readers 5a, 5b, 5c, and so on, read data from the user medium 2.

In the second example of the system, the medium access devices are formed of the readers 5a, 5b, 5c, and so on, because data is not directly written into the user medium 2.

However, the readers 5a, 5b, 5c, and so on, have a function of sending data to the picture production apparatus 1 via the network 6 by being connected to the network 6.

More specifically, at least client ID is recorded in the user medium 2, and each reader 5 (5a, 5b, 5c, and so on) reads the client ID when the user presents the user medium 2, and then transfers, together with the client ID, the corresponding time data and position data indicating the place at which the reader 5 is installed to the picture production apparatus 1.

In the service receiving area, a plurality of photographic devices 3α, 3β, 3γ, and so on, which take pictures at certain positions, are installed. The photographic devices 3α, 3β, 3γ, and so on, constantly take pictures at fixed positions, and transfer the photographed picture data to the picture production apparatus 1 via the network 6 in real time or at regular intervals, as in the first example of the system.

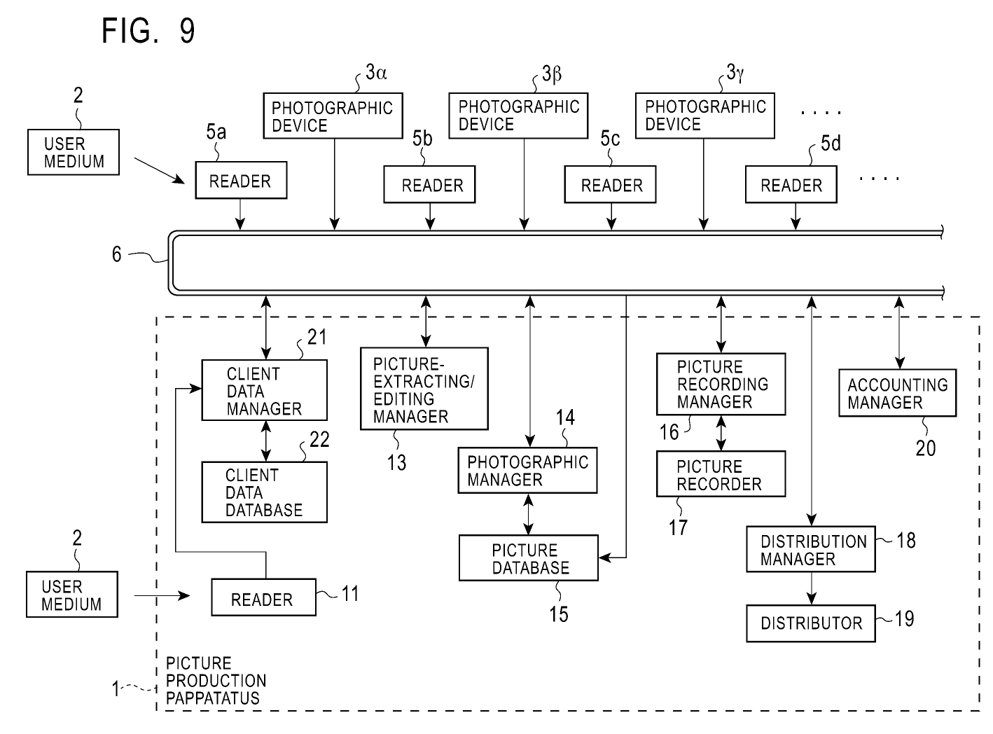

The configuration of the picture production apparatus 1 is shown in FIG. 9. The picture production apparatus 1 of the second example is different from that of the first example shown in FIG. 2 in that a client-data database 22 is provided, and a client data manager 21 for performing processing in a manner similar to the client data processor 12 shown in FIG. 2 and also for managing the client-data database 22 is also provided. The other elements are similar to those of the first example. The client-data database 22 stores client data sent from each reader 5 via the network 6.

The client data manager 21, the client-data database 22, the picture-extracting/editing manager 13, the photographic manager 14, the picture database 15, the picture recording manager 16, the distribution manager 18, and the accounting manager 20 may be formed as independent computers so as to be connected in parallel with each other via the network 6. Alternatively, these elements may be connected in series with each other, for example, the computers serving as these elements may be connected by using a local area network (LAN), and this LAN is connected to a LAN implemented by the network 6 starting from a certain computer.

Alternatively, the client data manager 21, the client-data database 22, the picture-extracting/editing manager 13, the photographic manager 14, the picture recording manager 16, the distribution manager 18, and the accounting manager 20 are not formed independently, and may be wholly or partially implemented by the same computer.

The operation of the second example of the system is as follows.

It is now assumed that the user acts, as indicated by the broken lines in FIG. 8, by carrying the user medium 2. More specifically, the user presents the user medium 2 at time A at position P1. Then, the reader 5a reads the data recorded in the user medium 2. In this case, it is sufficient that the client ID is recorded in the user medium 2. The reader 5a reads the client ID, and simultaneously, generates position data P1 and time data A and sends them, together with the client ID, to the picture production apparatus 1 via the network 6.

The user then presents the user medium 2 to the reader 5b at time B at position P2, and then, the reader 5b reads the client ID and sends the client ID, time data B, and position data P2 to the picture production apparatus 1.

Similarly, at time C and at position P3 and at time D and position P1, processing similar to the above is performed.

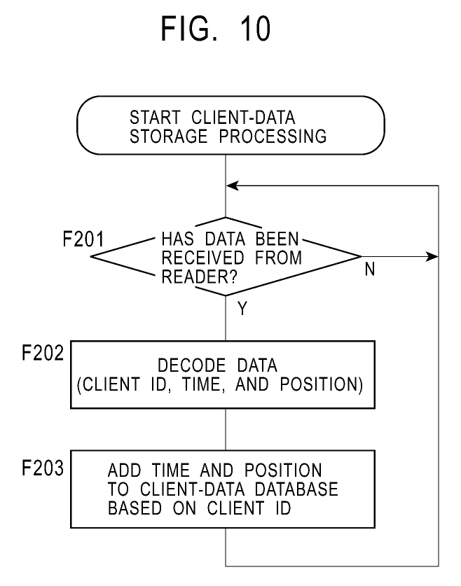

The processing performed by the picture production apparatus 1 upon receiving the data from each reader 5 is described below with reference to FIG. 10.

It is determined in step F201 whether data has been received from the reader 5. If the outcome of step F201 is yes, the process proceeds to step F202 in which the client data manager 21 decodes the received data to obtain the client ID, the time data, and the position data.

Then, in step F203, the client data manager 21 adds the time data and position data to the client-data database 22 based on the client ID.

Accordingly, the client data manager 21 performs the above-described processing on the data sent from each reader 5 so as to store the data in the client-data database 22. Thus, the client data including the client ID, the time data, and the position data is accumulated in the client-data database 22. In this case, the client data for many users having different client IDs are accumulated in the client-data database 22.

As described above, when the user presents the user medium 2, at least the client ID, the time data, and the position data are added to the client-data database 22.

Meanwhile, picture data constantly taken by the photographic devices 3α, 3β, and 3γ are sent to the picture production apparatus 1 via the network 6, and are stored in the picture database 15.

If the user wishes to purchase a picture package containing user's pictures after performing action, as described with reference to FIG. 8, the user presents the user medium 2 at the service reception.

At the service reception, the picture production apparatus 1 reads the client ID from the user medium 2 by using the reader 11 of the picture production apparatus 1 so as to start producing a picture package for the user.

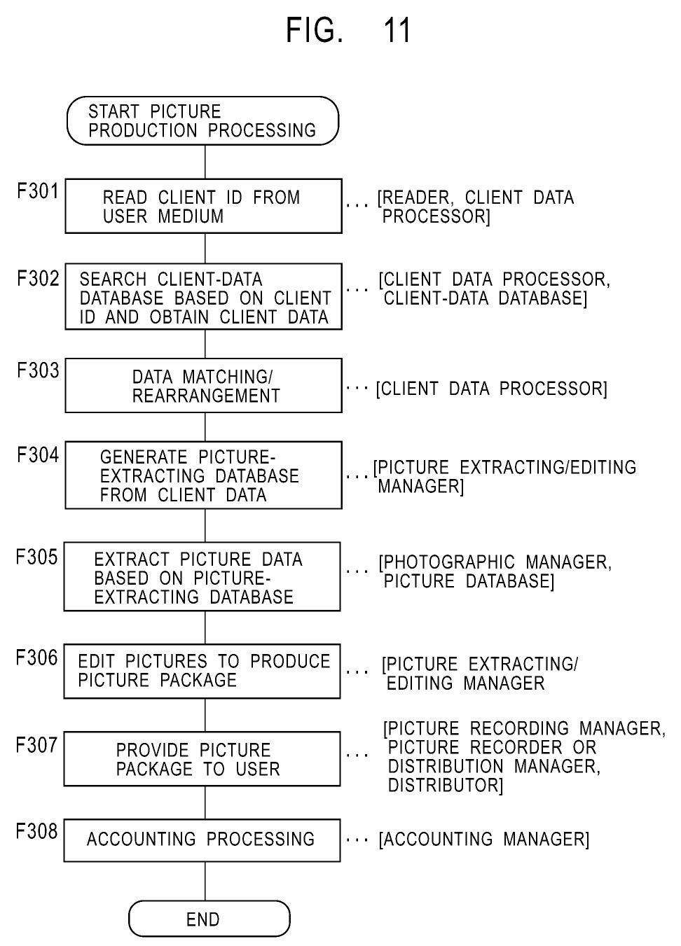

The picture production processing performed by the picture production apparatus 1 is shown in FIG. 11.

In step F301, the picture production apparatus 1 reads the client ID recorded in the user medium 2 by using the reader 11.

Then, in step F302, the picture production apparatus 1 obtains the client data of the user based on the client ID. More specifically, the client data manager 21 searches the client-data database 22 by using the client ID as the key, and reads all the items of client data associated with the client ID. The read client data is client data stored in the client-data database 22 as a result of presenting the user medium 2 at certain places by the user. That is, all the items of client data for the user, such as that shown in FIG. 4 in the first example of the system, can be obtained.

In step F303, the client data manager 21 performs data matching and rearrangement for the obtained client data.

Then, in step F304, the picture extracting/editing manager 13 (or the client data manager 21) may create a picture-extracting database based on the matching/rearrangement results.

The formation of the picture-extracting database in steps F303 and F304 and processings in steps F305 through F308 are similar to those in steps F102 through F107 of FIG. 3, and a detailed explanation thereof is omitted here. In short, as in the first example of the system, a picture package is produced by extracting pictures based on the picture-extracting database and by editing the extracted picture data and additional data, the picture package is provided to the user by being recorded on a recording medium or by being distributed, and the accounting processing is performed.

In the second example of the system, advantages similar to those obtained by the first example of the system can be achieved. Advantages unique to the second example are as follows.

It is sufficient that at least the client ID is stored in the user medium 2, and data writing into the user medium 2 is not performed. Accordingly, an inexpensive small-capacity medium can be used as the user medium 2, and since data writing is not performed, a read only medium can be used, in which case, the client ID is already written into the read only medium. The medium access devices installed at the predetermined positions can be formed as readers, and thus, it is less expensive than when the medium access devices are formed as readers/writers, thereby achieving a cost reduction.

### 4. Third Example of System

The third example of the system is described below. The same elements as those of the first or second example of the system are designated with like reference numerals, and a detailed explanation thereof is thus omitted.

In the third example, time data and position data are written into the user medium 2, though it is not essential. More specifically, user information, i.e., the client ID, the corresponding time data and position data, is sent to the picture production apparatus 1 by a communicator 8 owned by the user via a public line or a communication line (for example, the network 6) in the service receiving area, and is managed by the picture production apparatus 1.

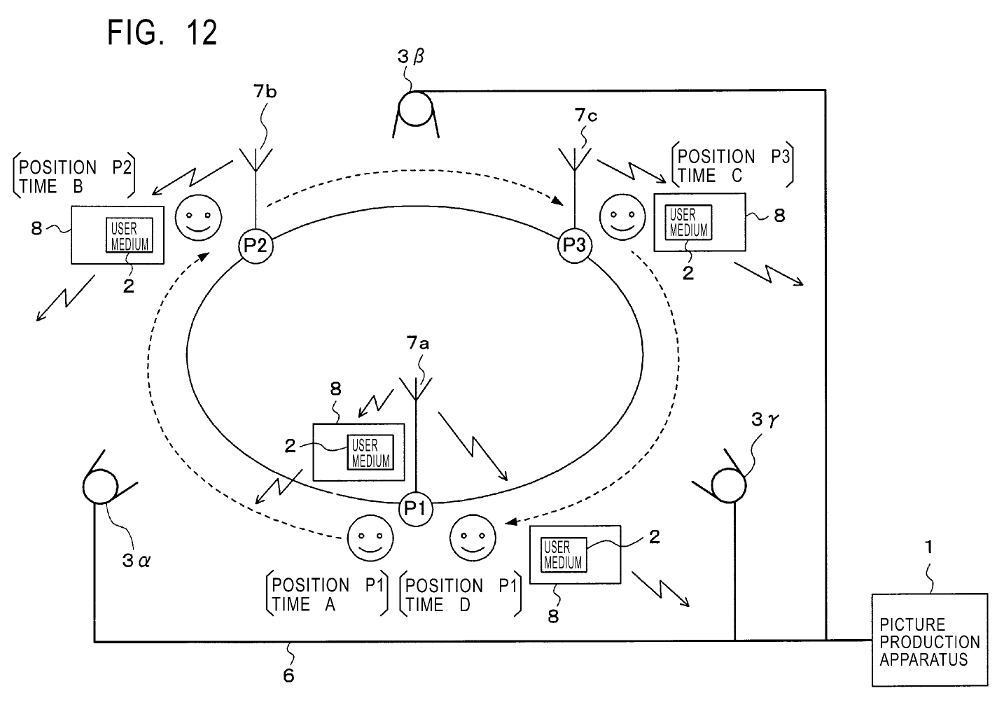

FIG. 12 illustrates the configuration of the third example of the system. In the service receiving area, writers 7a, 7b, 7c, and so on, are installed at positions P1, P2, P3, and so on, as the medium access devices. The writers 7a, 7b, 7c, and so on, write position data and time data to the user medium 2 when the user presents the user medium 2.

The medium access devices may be trigger devices 7a, 7b, 7c, and so on. A trigger device generates a signal giving an instruction to write time data and position data into the user medium 2 or an instruction to send time data and position data.

In the third example of the system, the medium access devices are formed as the writers (or trigger devices) 7a, 7b, 7c, and so on, because they do not read data from the user medium 2.

In this case, the user medium 2 is integrated into the communicator 8 owned by the user. The communicator 8 can be implemented by an information processing apparatus provided with a communication function, for example, a mobile personal computer, a PDA, or a cellular telephone. The communicator 8 is connected to a public line or the network 6 in the facility, and has the function of sending data to the picture production apparatus 1.

In the user medium 2, at least the client ID is recorded.

When the medium access devices are formed as the writers 7a, 7b, 7c, and so on, each writer 7 writes time data and position data when the user presents the user medium 2.

The communicator (information processing apparatus) 8 owned by the user sends, together with the client ID, the time data and the position data written into the user medium 2 to the picture production apparatus 1.

When the medium access devices are formed as the trigger devices 7a, 7b, 7c, and so on, each trigger device 7 outputs a trigger signal indicating an instruction to write or send the time data and position data into the user medium 2 when the user presents the user medium 2.

The medium access devices can be formed as trigger devices only when the communicator 8 owned by the user has a function of obtaining time data and position data by itself. If the communicator 8 has a timer for counting the current time, the time data can be obtained in accordance with a trigger signal from the trigger device. If the communicator 8 has a global positioning system (GPS) antenna or a decoder to obtain current position information, position data can be obtained in response to a trigger signal from the trigger device.

That is, upon receiving a trigger signal from the trigger device 7, the communicator 8 is able to obtain the time, the corresponding time data and position data.

Upon receiving a trigger signal from the trigger device 7, the communicator 8 obtains the time data and position data so as to write them into the user medium 2. Immediately after the writing operation or after a certain lapse of the writing operation, the communicator 8 sends the time data and position data to the picture production apparatus 1 together with the client ID stored in the user medium 2.

Alternatively, upon receiving a trigger signal from the trigger device 7, the communicator 8 obtains the time data and position data. Simultaneously, the communicator 8 reads the client ID stored in the user medium 2, and sends the obtained time data and position data to the picture production apparatus 1 together with the client ID.

In this manner, the communicator 8 may send the client ID, the time data and position data to the picture production apparatus 1 at various times. That is, the communicator 8 may send the time data and position data to the picture production apparatus 1 together with the client ID every time the writer (or trigger device) 7 makes access to the communicator 8, or after the lapse of a predetermined period of time. Alternatively, instead of automatically performing sending data, the communicator 8 sends the corresponding data to the picture production apparatus 1 when the user performs a certain operation. Alternatively, time data and position data may be sent to the picture production apparatus 1 at regular intervals, in which case, the data from a plurality of medium access devices may be sent to the picture production apparatus 1.

In the service receiving area, the plurality of photographic devices 3α, 3β, 3γ, and so on, are installed to constantly photograph pictures at certain points. The photographic devices 3α, 3β, 3γ, and so on, transfer the photographed picture data to the picture production apparatus 1 via the network 6 in real time or at regular intervals, as in the first and second examples of the system.

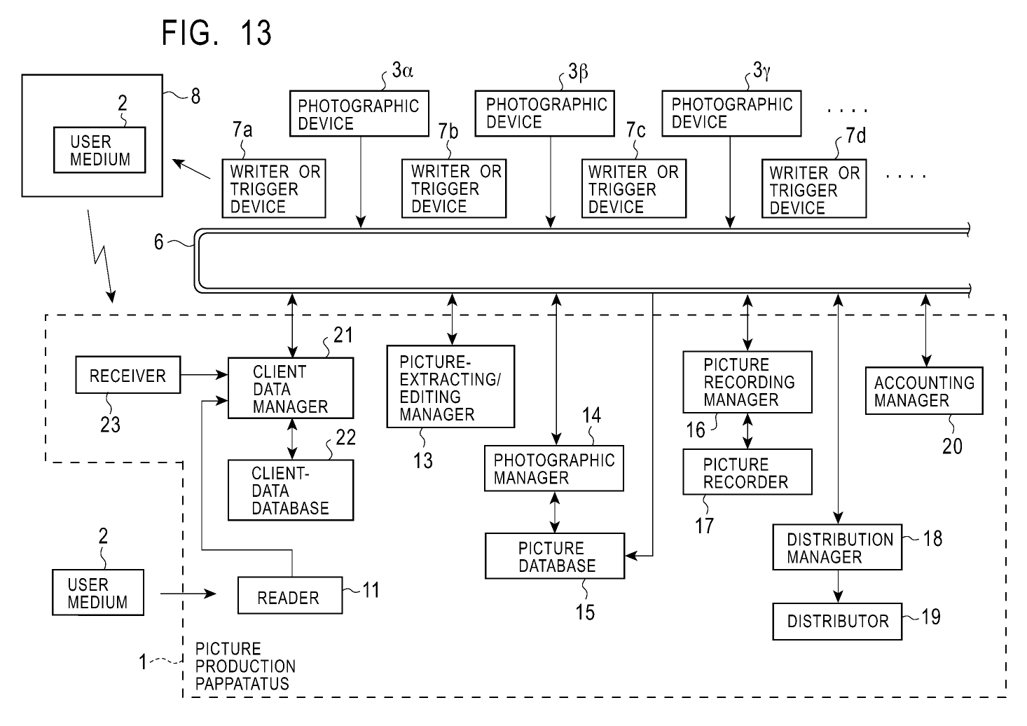

The configuration of the picture production apparatus 1 is shown in FIG. 13. As in the picture production apparatus 1 of the second example shown in FIG. 9, the client-data database 22 and the client data manager 21 are disposed.

The picture production apparatus 1 shown in FIG. 13 is different from that of FIG. 9 in that a receiver 23 for receiving data from the communicator 8 owned by the user is provided. The other elements are similar to those of FIG. 9.

Upon receiving the data (client ID, time data, and position data) from the communicator 8, the receiver 23 transfers the received signal to the client data manager 21. The client data manager 21 decodes the received data and stores it in the client-data database 22.

The client data manager 21, the client-data database 22, the picture-extracting/editing manager 13, the photographic manager 14, the picture database 15, the picture recording manager 16, the distribution manager 18, and the accounting manager 20 shown in FIG. 13 may be formed as independent computers so as to be connected in parallel with each other via the network 6. Alternatively, these elements may be connected in series with each other, for example, the computers serving as these elements may be connected by using a local area network (LAN), and this LAN is connected to a LAN implemented by the network 6 starting from a certain computer.

Alternatively, the client data manager 21, the client-data database 22, the picture-extracting/editing manager 13, the photographic manager 14, the picture recording manager 16, the distribution manager 18, and the accounting manager 20 are not formed independently, and may be wholly or partially implemented by the same computer.

The operation of the third example of the system is as follows.

It is now assumed that the user acts, as indicated by the broken lines in FIG. 12, by carrying the communicator 8 integrating the user medium 2 therein.

The user presents the user medium 2 (communicator 8) at time A at position P1. Then, the writer (or trigger device) 7a writes the time data and position data (or gives instruction to write or send data) into the user medium 2. The communicator 8 then sends, together with the client ID, the time data and position data corresponding to the writer (or trigger device) 7a to the picture production apparatus 1, as stated above.

The user then presents the user medium 2 to the writer (or trigger device) 7b at time B at position P2, and as a result, the communicator 8 sends, together with the client ID, the time data and position data corresponding to the writer (or trigger device) 7b to the picture production apparatus 1.

Likewise, processing similar to the above is performed at time C and at position P3 and at time D and at position P1.

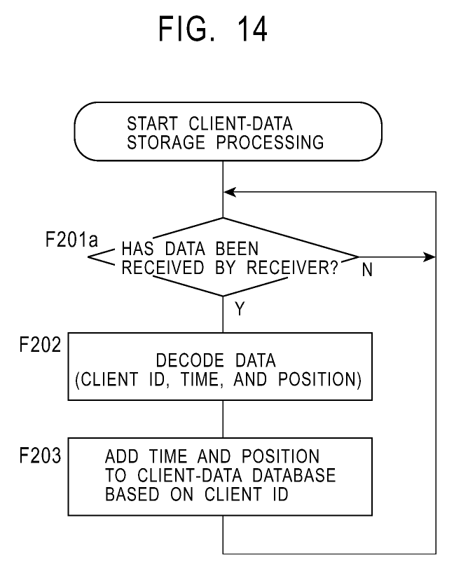

Upon receiving the data from the communicator 8, the picture production apparatus 1 performs processing shown in FIG. 14.

It is determined in step F201a whether data has been received from the communicator 8 by the receiver 23. If the outcome of step F201a is yes, the process proceeds to step F202 in which the client data manager 21 decodes the received data to obtain the client ID, the time data, and the position data.

Then, in step F203, the client data manager 21 adds the time data and position data to the client-data database 22 based on the client ID.

Accordingly, the client data manager 21 performs the above-described processing on the data sent from the communicator 8 so as to store the data in the client-data database 22. Thus, the client data including the client ID, the time data, and the position data is accumulated in the client-data database 22. In this case, the client data for many users having different client IDs are accumulated in the client-data database 22.

As described above, when the user presents the user medium 2, at least the client ID, the time data, and the position data are added to the client-data database 22.

Meanwhile, picture data constantly taken by the photographic devices 3α, 3β, and 3γ are sent to the picture production apparatus 1 via the network 6, and are stored in the picture database 15.

If the user wishes to purchase a picture package containing user's pictures after performing action, as described with reference to FIG. 12, the user presents the user medium 2 at the service reception.

At the service reception, the picture production apparatus 1 reads the client ID from the user medium 2 by using the reader 11 so as to start producing a picture package for the user.

The picture production processing to be subsequently performed by the picture production apparatus 1 is similar to that of the second example of the system discussed with reference to FIG. 11, and an explanation thereof is thus omitted.

In the third example, advantages similar to those obtained by the first example can be achieved. Advantages unique to the third example are as follows.

The medium access devices can be formed as writers or trigger devices, and do not require a function of reading data from the user medium 2 or a data communication function of performing communication via the network 6. Thus, a cost reduction can be achieved for commercial facilities, and the flexibility in the installment of the medium access devices or in the number of medium access devices can be increased.

It is sufficient that at least the client ID is stored in the user medium 2. If the writing of time data and position data is not performed, a read only medium in which the client ID is already written may be used. As the communicator 8, a cellular telephone or a PDA owned by the user can be directly used, and thus, the user does not have to buy a new device for the communicator 8.

### 5. Various Configurations of User Medium and Medium Access Device

Various examples of the configuration of the user medium 2 and the medium access devices that can be used in the first, second, and third examples of the system are discussed below.

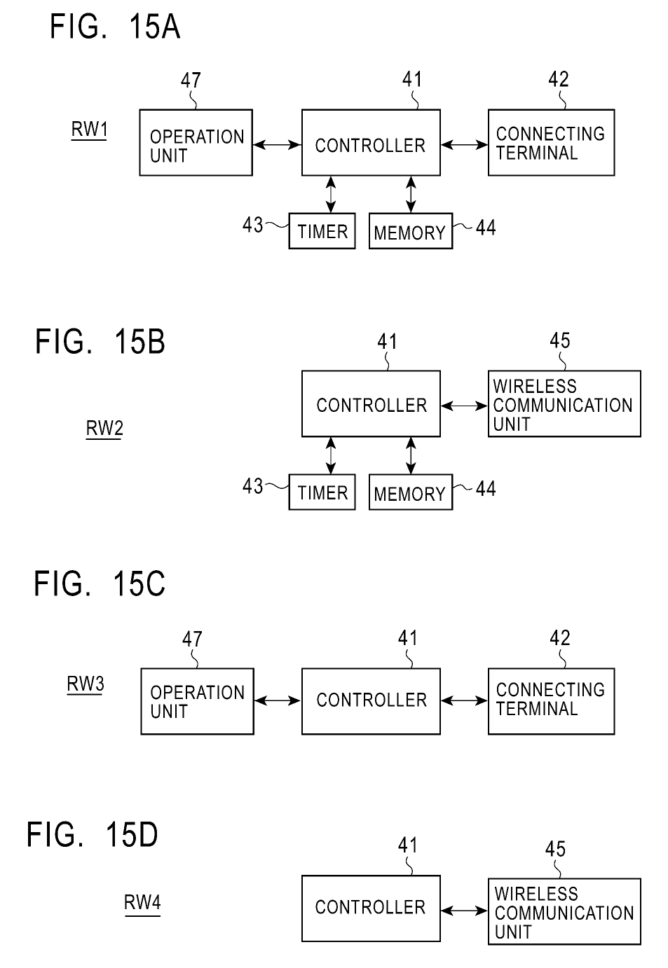

FIG. 15A through 15D illustrate various examples of the configuration of medium access devices RW1 through RW4 that can be used as the readers/writers 4 in the first example of the system.

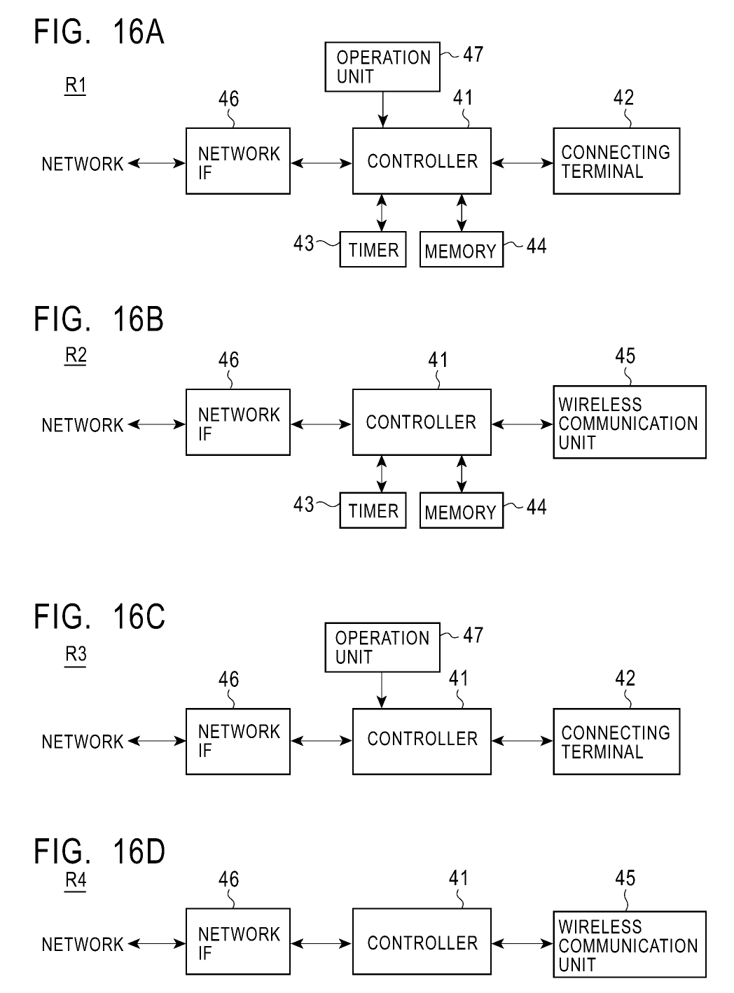

FIG. 16A through 16D illustrate various examples of the configuration of medium access devices R1 through R4 as the readers 5 in the second example of the system.

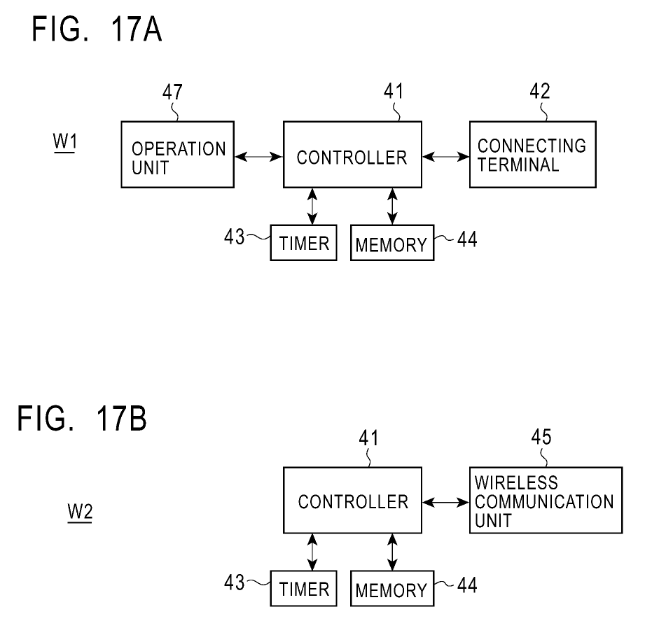

FIGS. 17A and 17B illustrate various examples of the configuration of medium access devices W1 and W2 as the writers 7 in the third example of the system.

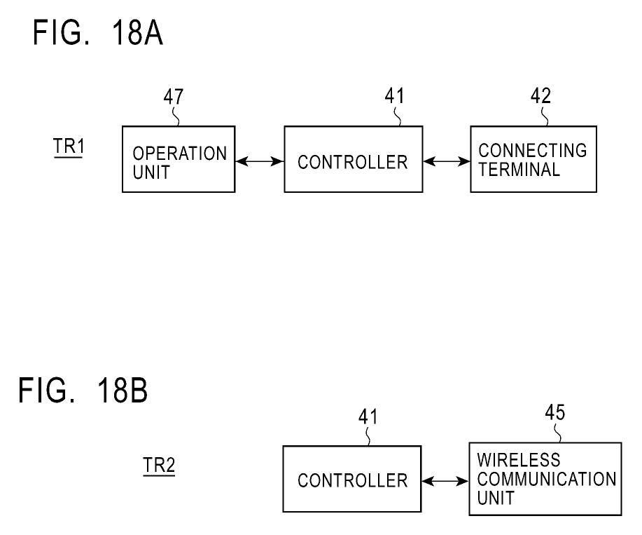

FIGS. 18A and 18B illustrate various examples of the configuration of medium access devices TR1 and TR2 as the trigger devices 7 in the third example of the system.

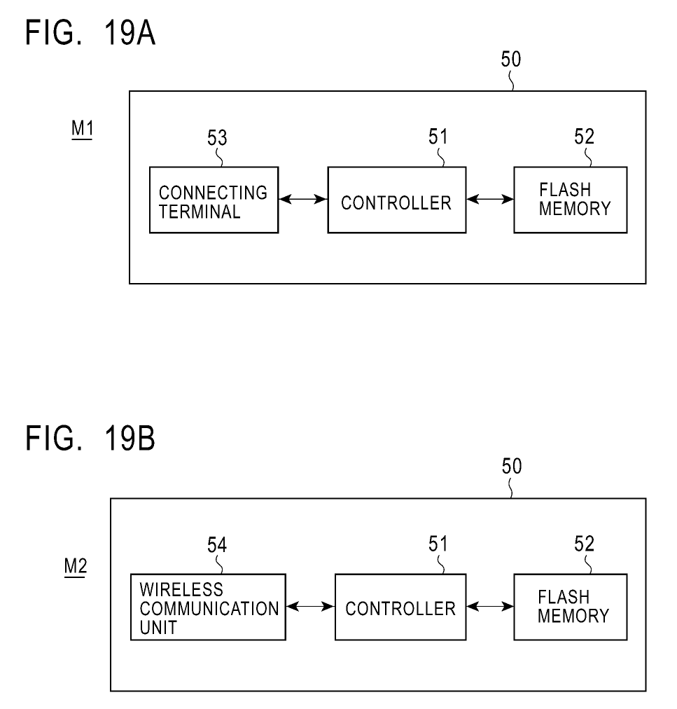

FIG. 19A through 23B illustrate various examples of the configuration of the user medium 2 as user media M1 through M10.

Various combinations of the user media M1 through M10 and the medium access devices RW1 through RW4, R1 through R4, W1 and W2, and TR1 and TR2 are given below.

### <Medium Access Device RW1 and User Medium M1>

This combination can be used in the first example of the system. The medium access device RW1 shown in FIG. 15A is a wired-connection (or contact) card reader/writer including a controller 41 for performing access processing, a connecting terminal 42, a timer 43 for counting the time and date, a memory 44 storing position information therein, and an operation unit 47.

The user medium M1 shown in FIG. 19A is a card 50, which is a card-type medium including a flash memory 52 for storing client data therein, a controller 51 for reading/writing data from/into the flash memory 52, and a connecting terminal 53.

With this combination, the user carries the card 50 as the user medium 2, and loads the card 50 into the medium access devices RW1 installed at certain places as the card readers/writers.

In this case, the connecting terminal 53 of the user medium M1 is connected to the connecting terminal 42 of the medium access device RW1. For example, the connecting terminals 53 and 42 are connected to each other by inserting/loading the card 50 into the medium access device RW1 or by using a connecting cable.

In this connection state, when the user or a staff of the commercial entity operates the operation unit 47 (for example, by pressing a key), access can be made to the user medium M1 by the controller 41. Access may be automatically made when the connection between the user medium M1 and the medium access device RW1 is established without the need to operate the operation unit 47. In this case, the provision of the operation unit 47 is not necessary. Alternatively, an operation unit for giving an access instruction may be provided for the card 50.

Various access operations can be considered, for example, simply writing time data and position data, or reading the client ID and other types of information from the user medium M1 and storing it in the medium access device RW1. Alternatively, time data and position data may be written into the user medium M1 after authenticating the card 50 as an authorized medium based on the read data. Management information for data stored in the user medium M1 may be read or updated. Similarly, various access operations can be considered for other combinations of the user medium and the medium access device.

When the medium access device RW1 reads data from the user medium M1, the controller 41 requests the controller 51 to read data, for example, the client ID, stored in the flash memory 52. In response to this request, the controller 51 reads the requested data from the flash memory 52 and transfers it to the controller 41.

When the medium access device RW1 writes data into the user medium M1, the controller 41 requests the controller 51 to write data into the flash memory 52 and also sends the data to be written to the controller 51. For example, the controller 41 obtains time data from the timer 43 and position data from the memory 44, and sends such data to the controller 51. The controller 51 writes the time data and position data into the flash memory 52 in response to a writing request.

### <Medium Access Device RW2 and User Medium M2>

This combination can be used in the first example of the system. The medium access device RW2 shown in FIG. 15B is a wireless-connection card reader/writer including the controller 41 for performing access processing, a wireless communication unit 45, the timer 43 for counting the time and date, and the memory 44 for storing position information therein.

The user medium M2 shown in FIG. 19B is a card 50, which is a card-type medium including the flash memory 52 for storing client data therein, the controller 51 for reading/writing data from/into the flash memory 52, and a wireless communication unit 54.

With this combination, the user carries the card 50 as the user medium 2, and then brings the card 50 close to the medium access device RW2 installed at certain places as the card reader/writers.

In this case, the wireless communication unit 54 of the user medium M2 and the wireless communication unit 45 of the medium access device RW2 perform wireless communication by radio waves or infrared. For implementing wireless connection, an antenna or an electromagnetic induction coil is provided for the wireless communication units 54 and 45.

That is, the user brings the user medium M2 close to the medium access device RW2 so that the medium access device RW2 can access the user medium M2 for reading or writing data.

When the medium access device RW2 reads data from the user medium M2, the controller 41 requests the controller 51 to read data, for example, the client ID, stored in the flash memory 52 by wireless communication. In response to this request, the controller 51 reads the requested data from the flash memory 52 and transfers it to the controller 41 by wireless communication.

When the medium access device RW2 writes data into the user medium M2, the controller 41 requests the controller 51 to write data into the flash memory 52, and also sends the data to be written. For example, the controller 41 obtains time data from the timer 43 and position data from the memory 44, and sends the data to the controller 51. In response to a writing request, the controller 51 writes the time data and position data received by wireless communication to the flash memory 52.

### <Medium Access Device RW1 and User Medium M3>

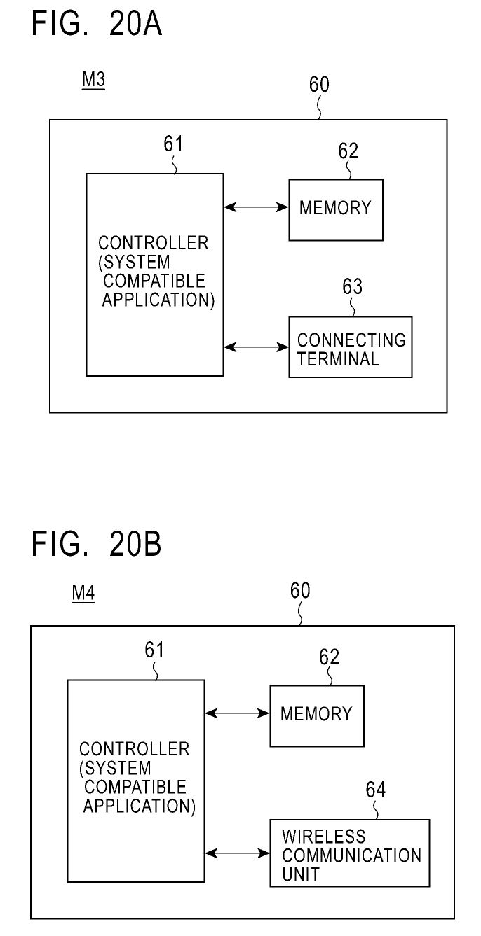

This combination can be used in the first example of the system. The user medium M3 shown in FIG. 20A is an information processing apparatus 60, for example, a mobile personal computer, a PDA, or a cellular telephone. A controller 61 of the information processing apparatus 60 contains application software compatible with the operation of the first example of the system so that it can perform processing in response to access from the medium access device RW1. Part of the area of a memory 62 is used for storing client data therein. A connecting terminal 63 is an external interface for the information processing apparatus 60, for example, a general-purpose interface such as a USB or IEEE1394 interface. The connecting terminal 63 may be a connecting terminal specially used for being connected to the medium access device RW1.

In the medium access device RW1 shown in FIG. 15A, the connecting terminal 42 can be connected to the information processing apparatus 60 shown in FIG. 20A to perform communication.

With this combination, the user carries the information processing apparatus 60 as the user medium 2, and then connects the information processing apparatus 60 to the medium access devices RW1 installed at certain places as the card readers/writers.

In this connection state, when the user or a staff operates the operation unit 47 (for example, by pressing the key), access can be made to the user medium M3 by the controller 41. Access may be automatically made when the connection between the user medium M3 and the medium access device RW1 is established without the need to operate the operation unit 47. In this case, the provision of the operation unit 47 is not necessary. Alternatively, an access instruction may be given from the information processing apparatus 60.

When the medium access device RW1 reads data from the user medium M3, the controller 41 requests the controller 61 to read the data stored in the memory 62. In response to this request, the controller 61 reads the requested data from the memory 62 and transfers it to the controller 41.

When the medium access device RW1 writes data into the user medium M3, the controller 41 requests the controller 61 to write data and also sends the data to be written. For example, the controller 41 obtains time data from the timer 43 and position data from the memory 44, and sends the data to the controller 61. In response to the writing instruction, the controller 61 writes the time data and position data into a predetermined area of the memory 62.

### <Medium Access Device RW2 and User Medium M4>

This combination can be used in the first example of the system. The user medium M4 shown in FIG. 20B is an information processing apparatus 60, for example, a mobile personal computer, a PDA, or a cellular telephone. The controller 61 of the information processing apparatus 60 contains application software compatible with the operation of the first example of the system so that it can perform processing in response to access from the medium access device RW2. Part of the area of the memory 62 is used for storing client data therein. A wireless communication unit 64 is an external wireless interface for the information processing apparatus 60, which serves as a communication processor for communication performed by radio waves or infrared.

In the medium access device RW2 shown in FIG. 15B, a wireless communication unit 45 can perform wireless communication with the information processing apparatus 60 shown in FIG. 20B.

With this combination, the user carries the information processing apparatus 60 as the user medium 2, and then brings the information processing apparatus 60 close to the medium access devices RW2 installed at certain places as the card readers/writers. Then, a communication connection between the medium access device RW2 and the information processing apparatus 60 is established, and the access can be made to the user medium M4 by the controller 41.

When the medium access device RW2 reads data from the user medium M4, the controller 41 requests the controller 61 to read data stored in the memory 62 by wireless communication. In response to this request, the controller 61 reads the requested data from the memory 62 and transfers it to the controller 41 by wireless communication.

When the medium access device RW2 writes data into the user medium M4, the controller 41 requests the controller 61 to write data into the memory 62 by wireless communication, and also sends the data to be written. For example, the controller 41 obtains time data from the timer 43 and the position data from the memory 44, and sends the data to the controller 61. In response to the writing request received by wireless communication, the controller 61 writes the time data and position data into the predetermined area of the memory 62.

### <Medium Access Device RW3 and User Medium M5>

This combination can be used in the first example of the system. The medium access device RW3 shown in FIG. 15C is a wired-connection (or contact) card reader/writer including the controller 41 for performing access processing, the connecting terminal 42, and the operation unit 47.

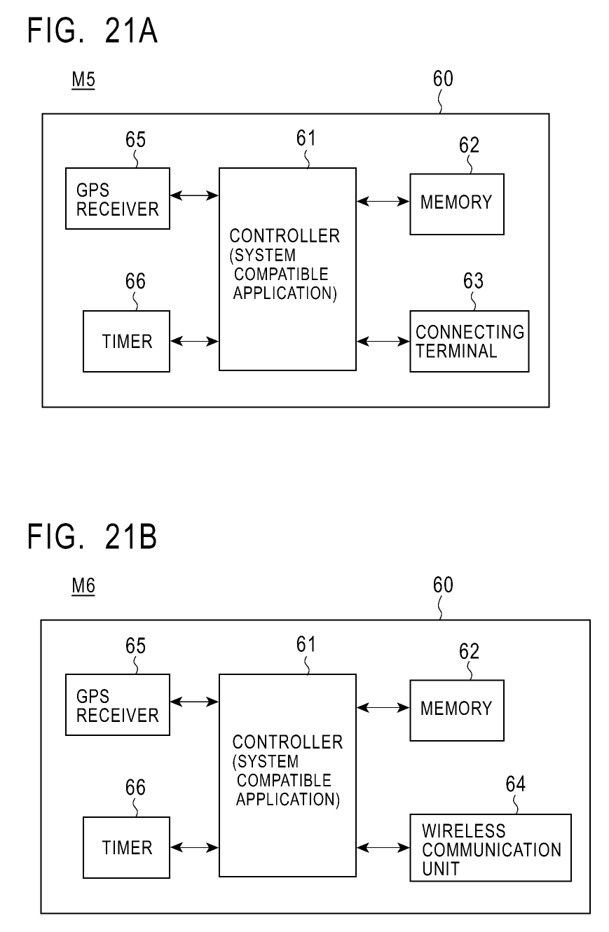

The user medium M5 shown in FIG. 21A is an information processing apparatus 60 similar to that shown in FIG. 20A, and includes the controller 61, the memory 62, and the connecting terminal 63. The information processing apparatus 60 shown in FIG. 21A also includes a GPS receiver 65 for detecting the current position, and a timer 66 for counting the current time and date. The GPS receiver 65 sends the current position information, so-called “GPS data”, to the controller 61. The controller 61 can obtain the current time from the timer 66.

With this combination, the user carries the information processing apparatus 60 (user medium M5) as the user medium 2, and then connects the information processing apparatus 60 to the medium access devices RW3 installed at certain places as the card readers/writers.

In this connection state, when the user or a staff operates the operation unit 47, access can be made to the user medium M5 by the controller 41. Access may be automatically made when the connection between the user medium M5 and the medium access device RW3 is established without the need to operate the operation unit 47. In this case, the provision of the operation unit 47 is not necessary. Alternatively, an access instruction may be given from the information processing apparatus 60.

When the medium access device RW3 reads data from the user medium M5, the controller 41 requests the controller 61 to read data stored in the memory 62. In response to this request, the controller 61 reads the requested data from the memory 62 and transfers it to the controller 41.

When the medium access device RW3 writes client data into the user medium M5, the controller 41 requests the controller 61 to write the client data into the memory 62. In this case, in response to the writing request, the controller 61 writes the current position information obtained from the GPS receiver 65 to the memory 62 as the position data, and the time and date information obtained from the timer 66 into the memory 62 as the time data.

### <Medium Access Device RW4 and User Medium M6>

This combination can be used in the first example of the system. The medium access device RW4 shown in FIG. 15D is a wireless-connection card reader/writer including the controller 41 and the wireless communication unit 45.

The user medium M6 shown in FIG. 21B is an information processing apparatus 60 similar to that shown in FIG. 20B, and includes the controller 61, the memory 62, and a wireless communication unit 64. The user medium M6 also includes the GPS receiver 65 for detecting the current position and the timer 66 for counting the current time and date, as in the user medium M5 in FIG. 21A.

With this combination, the user carries the information processing apparatus 60 as the user medium 2, and then brings the information processing apparatus 60 close to the medium access devices RW4 installed at certain places as the card readers/writers. Then, a communication connection between the medium access device RW4 and the information processing apparatus 60 (user medium M6) can be established, and access can be made to the user medium M6 by the controller 41.

When the medium access device RW4 reads data from the user medium M6, the controller 41 requests the controller 61 to read data stored in the memory 62 by wireless communication. In response to this request, the controller 61 reads the requested data from the memory 62 and transfers it to the controller 41 by wireless communication.

When the medium access device RW4 writes client data into the user medium M6, the controller 41 requests the controller 61 to write the client data. In this case, in response to this writing request, the controller 61 writes the current position information obtained from the GPS receiver 65 into the memory 62 as the position data, and the time and date information obtained from the timer 66 into the memory 62 as the time data.

### <Medium Access Device R1 and User Medium M1>

This combination can be used in the second example of the system. The medium access device R1 shown in FIG. 16A is a wired-connection (or contact) card reader including a controller 41 for performing access processing and network communication processing, a connecting terminal 42, a timer 43 for counting time and date, a memory 44 for storing position information therein, an operation unit 47, and a network interface 46 for the network 6.

According to the combination of the medium access device R1 with the user medium M1 shown in FIG. 19A, the user carries the card 50 as the user medium 2, and then loads the card 50 into the medium access devices R1 installed at certain places as the card readers, or connects the card 50 to the medium access devices R1 by a cable.

In this connection state, when the user or a staff operates the operation unit 47, access can be made to the user medium M1 by the controller 41. The provision of the operation unit 47 is not essential. Alternatively, an operation unit for giving an access instruction may be provided for the card 50.

In the second example of the system, only data reading is performed as the access operation.

When the medium access device R1 reads data from the user medium M1, the controller 41 requests the controller 51 to read data, for example, the client ID, stored in the flash memory 52. In response to this request, the controller 51 reads the requested data from the flash memory 52 and transfers it to the controller 41.

After reading the client ID, the medium access device R1 sends the client ID, together with the time data and position data, to the picture production apparatus 1. That is, the medium access device R1 obtains the time data from the timer 43 and position data from the memory 44, and encodes such data together with the client ID, and sends the encoded data to the network 6 from the network interface 46.

### <Medium Access Device R2 and User Medium M2>

This combination can be used in the second example of the system. The medium access device R2 shown in FIG. 16B is a wireless-connection card reader including the controller 41 for performing access processing and network communication processing, a wireless communication unit 45, the timer 43 for counting the time and date, the memory 44 for storing position information therein, the operation unit 47, and the network interface 46 for the network 6.

According to the combination of the medium access device R2 with the user medium M2 shown in FIG. 19B, the user carries the card 50 as the user medium 2, and then brings the card 50 close to the medium access device R2 installed at certain places as the card readers. Communication is then established, and access can be made to read data from the user medium M2 by the controller 41.

When the medium access device R2 reads data from the user medium M2, the controller 41 requests the controller 51 to read data stored in the flash memory 52 by wireless communication. In response to this request, the controller 51 reads the requested data from the flash memory 52 and transfers it to the controller 41 by wireless communication.

After reading the client ID, the medium access device R2 sends the client ID, together with the time data and position data, to the picture production apparatus 1. That is, the medium access device R2 obtains the time data from the timer 43 and the position data from the memory 44, encodes such data together with the client ID, and sends the encoded data to the network 6 from the network interface 46.

### <Medium Access Device R1 and User Medium M3>

This combination can be used in the second example of the system. When the user medium M3 shown in FIG. 20A is combined with the medium access device R1 shown in FIG. 16A, the user carries the information processing apparatus 60 as the user medium 2, and then connects the information processing apparatus 60 with the medium access devices R1 installed at certain places as the card readers.

In this state, when the user or a staff operates the operation unit 47, access can be made to the user medium M3 by the controller 41. The provision of the operation unit 47 is not essential, and an access instruction may be given from the information processing apparatus 60.

When the medium access device R1 reads data from the user medium M3, the controller 41 requests the controller 61 to read data stored in the memory 62. In response to this request, the controller 61 reads the requested data from the memory 62 and transfers it to the controller 41.

After reading the client ID, the medium access device R1 sends the client ID, together with the time data and position data, to the picture production apparatus 1. That is, the medium access device R1 obtains the time data from the timer 43 and position data from the memory 44, encodes the data, together with the client ID, and sends the encoded data to the network 6 from the network interface 46.

### <Medium Access Device R2 and User Medium M4>

This combination can be used in the second example of the system. When the user medium M4 shown in FIG. 20B is combined with the medium access device R2 shown in FIG. 16B, the user carries the information processing apparatus 60 as the user medium 2, and then brings the information processing apparatus 60 close to the medium access device R2 installed at certain places as the card readers. Then, communication is established to access the user medium M4 by the controller 41.

When the medium access device R2 reads data from the user medium M4, the controller 41 requests the controller 61 to read data stored in the memory 62 by wireless communication. In response to this request, the controller 61 reads the requested data from the memory 62 and transfers it to the controller 41.

After reading the client ID, the medium access device R2 sends the client ID, together with the time data and position data, to the picture production apparatus 1. That is, the medium access device R2 obtains the time data from the timer 43 and the position data from the memory 44, encodes such data together with the client ID, and sends the encoded data to the network 6 from the network interface 46.

### <Medium Access Device R3 and User Medium M5>

This combination can be used in the second example of the system. The medium access device R3 shown in FIG. 16C is a wired-connection (contact) card reader including the controller 41, the connecting terminal 42, the operation unit 47, and the network interface 46.

When the medium access device R3 is combined with the user medium M5 shown in FIG. 21A, the user carries the information processing apparatus 60 as the user medium 2, and then connects the information processing apparatus 60 to the medium access devices R3 installed at certain places as the card readers.

In this connection state, when the user or a staff operates the operation unit 47, access can be made to the user medium M5 by the controller 41. The provision of the operation unit 47 is not essential, or an access instruction may be given from the information processing apparatus 60.

When the medium access device R3 reads data from the user medium M5, the controller 41 requests the controller 61 to read data stored in the memory 62. In response to this request, the controller 61 reads the requested data from the memory 62 and transfers it to the controller 41.

In this case, the medium access device R3 obtains time data and position data from the user medium M5. That is, the controller 41 requests the controller 61 to send the time data and position data. Then, the controller 61 sends the current position information obtained from the GPS receiver 65 and the time and date information obtained from the timer 66 to the medium access device R3 as the position data and time data.

The medium access device R3 encodes the client ID, the time data, and the position data obtained from the user medium M5, and sends the encoded data to the network 6 from the network interface 46.

### <Medium Access Device R4 and User Medium M6>

This combination can be used in the second example of the system. The medium access device R4 shown in FIG. 16D is a wireless-connection card reader including the controller 41 for performing access processing, the wireless communication unit 45, and the network interface 46.

When the medium access device R4 is combined with the user medium M6 shown in FIG. 21B, the user carries the information processing apparatus 60 as the user medium 2, and then brings the information processing apparatus 60 close to the medium access devices R4 installed at certain places as the card readers. Communication is then established, and access can be made to read data from the user medium M6 by the controller 41.

When the medium access device R4 reads data from the user medium M6, the controller 41 requests the controller 61 to read data stored in the memory 62 by wireless communication. In response to this request, the controller 61 reads the requested data from the memory 62 and transfers it to the controller 41 by wireless communication.

In this case, the medium access device R4 obtains the time data and position data from the user medium M6. That is, the controller 41 requests the controller 61 to send the time data and position data. Then, the controller 61 sends the current position information obtained from the GPS receiver 65 and the time and date information obtained form the timer 66 to the medium access device R4 as the position data and the time data.

The medium access device R4 encodes the client ID, the time data, and the position data obtained from the user medium M5, and sends the encoded data to the network 6 from the network interface 46.

### <Medium Access Device W1 and User Medium M7>

This combination can be used in the third example of the system. The medium access device W1 shown in FIG. 17A is a wired-connection (contact) writer including the controller 41 for performing access processing, the connecting terminal 42, the timer 43 for counting the time and date, the memory 44 for storing position information therein, and the operation unit 47.

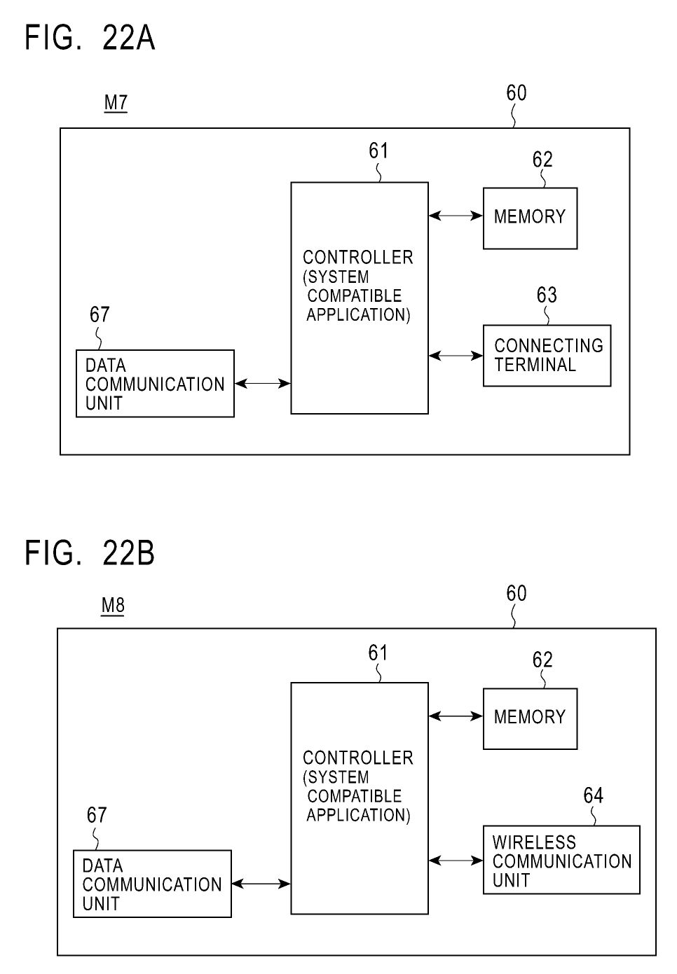

The user medium M7 shown in FIG. 22A is an information processing apparatus 60, for example, a mobile personal computer, a PDA, or a cellular telephone. The controller 61 of the information processing apparatus 60 contains application software compatible with the operation of the third example of the system so as to perform processing in response to access from the medium access device W1. Part of the area of the memory 62 of the information processing apparatus 60 is used for storing client data therein. The connecting terminal 63 is an external interface for the information processing apparatus 60, for example, a general-purpose interface such as a USB or IEEE1394 interface, or a connecting terminal specially used for being connected to the medium access medium W1.

In the medium access device W1 shown in FIG. 17A, the connecting terminal 42 can be connected to the information processing apparatus 60 shown in FIG. 22A so as to communicate with it.

The information processing apparatus 60 also includes a data communication unit 67, which performs data communication via a public line for cellular telephones, the Internet, or a predetermined LAN.

According to the combination of the medium access device W1 and the user medium M7, the user carries the information processing apparatus 60 as the user medium 2, and then connects the information processing apparatus 60 to the medium access devices W1 installed at certain places as the writers.

In this state, when the user or a staff operates the operation unit 47, access can be made to the user medium M7 by the controller 41. The provision of the operation unit 47 is not essential, and an operation unit for giving an access instruction may be provided for the information processing apparatus 60.

In the third example of the system, when the medium access device W1 (writer 7) is used, writing of time data and position data is performed as the access operation.

When the medium access device W1 writes data into the user medium M7, the controller 41 requests the controller 61 to write data into the memory 62, and also sends the data to be written. For example, the controller 41 obtains the time data from the timer 43 and the position data from the memory 44, and sends such data to the controller 61. In response to the writing request, the controller 61 writes the time data and position data into the predetermined area of the memory 62.

Then, the information processing apparatus 60 sends the client data stored in the memory 62 to the picture production apparatus 1. That is, the controller 61 reads the time data and position data, and the client ID from the memory 62, and transfers them to the data communication unit 67. The data communication unit 67 sends the time data, position data, and client data to the picture production apparatus 1.

### <Medium Access Device W2 and User Medium M8>

This combination can be used in the third example of the system. The medium access device W2 shown in FIG. 17B is a wireless-contact writer including the controller 41 for performing access processing, the wireless communication unit 45, the timer 43 for counting the time and date, and the memory 44 for storing position information therein.

The user medium M8 shown in FIG. 22B is an information processing apparatus 60, for example, a mobile personal computer, a PDA, or a cellular telephone. The controller 61 of the information processing apparatus 60 contains application software compatible with the third example of the system so as to perform processing in response to access from the medium access device W2. Part of the memory 62 is used for storing client data therein. The wireless communication unit 64 is an external wireless interface for the information processing apparatus 60, which serves as a communication processor for performing communication by radio waves or infrared.

In the medium access device W2 shown in FIG. 17B, the wireless communication unit 45 is able to perform wireless communication with the information processing apparatus 60 shown in FIG. 22B.

The information processing apparatus 60 is provided with the data communication unit 67 for performing data communication via a public line for cellular telephones, the Internet, or a predetermined LAN.

With this combination, the user carries the information processing apparatus 60 as the user medium 2, and then brings the information processing apparatus 60 close to the medium access devices W2 installed at certain places as the writers. Then, a communication connection between the medium access device W2 and the user medium M8 is established, and access can be made to write data into the user medium M8 by the controller 41.

When the medium access device W2 writes data into the user medium M8, the controller 41 requests the controller 61 to write data into the memory 62, and also sends the data to be written. For example, the controller 41 obtains the time data from the timer 43 and the position data from the memory 44, and sends such data to the controller 61 by wireless communication. In response to this writing request, the controller 61 writes the time and position data to the predetermined area of the memory 62.

Thereafter, the information processing apparatus 60 sends the client data stored in the memory 62 to the picture production apparatus 1. That is, the controller 61 reads the time data and position data, and ID data from the memory 62, and transfers them to the data communication unit 67. Then, the data communication unit 67 sends the time data, position data, client ID to the picture production apparatus 1.

### <Medium Access Device TR1 and User Medium M9>

This combination can be used in the third example of the system. The medium access device TR1 shown in FIG. 18A is a wired-connection (contact) trigger device including the controller 41 for performing access processing, the connecting terminal 42, and the operation unit 47.

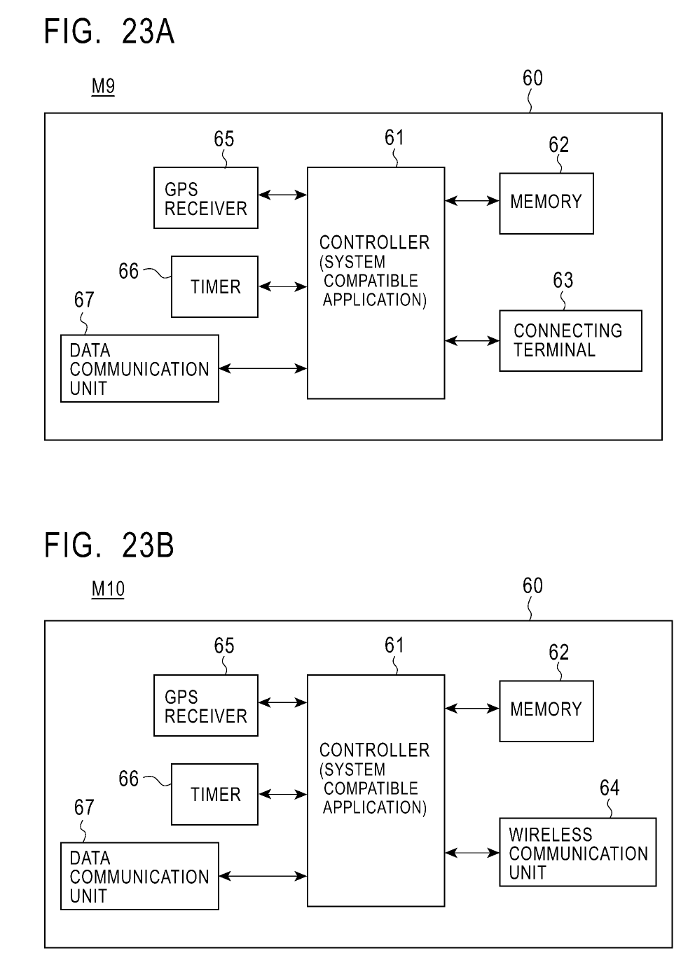

The user medium M9 shown in FIG. 23A is an information processing apparatus 60, for example, a mobile personal computer, a PDA, or a cellular telephone. The user medium M9 also includes the GPS receiver 65 for detecting the current position and the timer 66 for counting the current time and date. The GPS receiver 65 sends the current position information, so-called “GPS data”, to the controller 61. The controller 61 receives the GPS data from the GPS receiver 65, and also obtains the current time from the timer 66.

With this combination, the user carries the information processing apparatus 60 as the user medium 2, and then connects the information processing apparatus 60 to the medium access devices TR1 installed at certain places as the trigger devices.

In this connection state, the user operates the operation unit 47, and the controller 41 of the medium access device TR1 can access can the user medium M9. The provision of the operation unit 47 is not essential, and an operation unit for giving an access instruction may be provided for the information processing apparatus 60.

In the third example of the system, when the medium access device TR1 (trigger device 7) is used, a trigger signal indicating an instruction to write time data and position data or an instruction to send time data and position data is output as the access operation.

When a trigger signal indicating an instruction to write time data and position data is output, the following operation is performed.

The controller 41 of the medium access device TR1 requests the controller 61 to write data into the memory 62. In response to this request, the controller 61 obtains the time data and position data from the timer 66 and the GPS receiver 65, respectively, and writes the data into the predetermined area of the memory 62.

Thereafter, the information processing apparatus 60 sends the client data stored in the memory 62 to the picture production apparatus 1. That is, the controller 61 reads the time data, position data, client ID from the memory 62, and transfers them to the data communication unit 67. Then, the data communication unit 67 sends the time data, position data, client ID to the picture production apparatus 1.

When a trigger signal indicating an instruction to send time data and position data is output, the following operation is performed.

The controller 41 of the medium access device TR1 requests the controller 61 to send data to the memory 62. In response to this request, the controller 61 obtains the time data and position data from the timer 66 and the GPS receiver 65, respectively. The controller 61 also reads the client ID from the memory 62, and sends the client ID, together with the time data and position data to the data communication unit 67. Then, the data communication unit 67 sends the time data, position data, and client ID to the picture production apparatus 1.

### <Medium Access Device TR2 and User Medium M10>

This combination can be used in the third example of the system. The medium access device TR2 shown in FIG. 18B is a wireless-contact trigger device including the controller 41 for performing access processing and the wireless communication unit 45.

The user medium M10 shown in FIG. 23B is an information processing apparatus 60, for example, a mobile personal computer, a PDA, or a cellular telephone. The user medium M10 also includes the GPS receiver 65 for detecting the current position and the timer 66 for counting the current time and date. The GPS receiver 65 sends the current position information, so-called “GPS data”, to the controller 61. The controller 61 receives the GPS data and also obtains the current time from the timer 66.

With this combination, the user carries the information processing apparatus 60 as the user medium 2, and then brings the information processing apparatus 60 close to the medium access devices TR2 installed at certain places as the trigger devices. Then, wireless communication between the medium access device TR2 and the information processing apparatus 60 can be performed.

In the third example of the system, as the access operation using the medium access device TR2 (trigger device 7), a trigger signal indicating an instruction to write time data and position data or an instruction to send time data and position data is output.

When a trigger signal indicating an instruction to write time data and position data is output, the controller 41 of the medium access device TR2 requests the controller 61 to write data into the memory 62 by wireless communication. In response to this request, the controller 61 obtains time data and position data from the timer 66 and the GPS receiver 65, respectively, and writes the data to the predetermined area of the memory 62.

Thereafter, the information processing apparatus 60 sends the client data stored in the memory 62 to the picture production apparatus 1. That is, the controller 61 reads the time data, position data, client ID from the memory 62, and transfers them to the data communication unit 67. The data communication unit 67 then sends the time data, position data, client ID to the picture production apparatus 1.

When a trigger signal indicating an instruction to send time data and position data is output, the controller 41 of the medium access device TR2 requests the controller 61 to send data to the memory 62 by wireless communication. In response to this request, the controller 61 obtains time data and position data from the timer 66 and the GPS receiver 65, respectively. The controller 61 also reads the client ID from the memory 62, and transfers the client ID, together with the time data and position data, to the data communication unit 67. The data communication unit 67 then sends the time data, position data, and client ID to the picture production apparatus 1.

Examples of the configurations and combinations of the user medium 2 and the medium access device (reader/writer 4, reader 5, writer 7, or trigger device 7) have been discussed above. Of course, other examples of the configurations and combinations can be considered.

When the user medium 2 is formed as the card medium 50, it is not burdensome for the user to carry the user medium 2. It is also advantageous for commercial entities because they can provide the user medium 2 at low cost. In this case, the card medium 50 is not restricted to the form of a card, and may be in any form, for example, a tag.

The storage medium in the card medium 50 is not limited to a flash memory, and may be another type of a non-volatile memory, or a volatile memory with batteries.

When the information processing apparatus 60 is formed as a cellular telephone, a PDA, or a personal computer owned by the user, the user does not have to buy a new device for the user medium 2.

When the information processing apparatus 60 is provided with the timer 66 and a position detector, such as the GPS receiver 65, the medium access device does not have to generate time data or position data, thereby simplifying the medium access device.

If the user is able to store client data by operating the information processing apparatus 60 at certain times and places, the provision of the medium access device is not essential, thereby further reducing the facility cost.

The memory 62 within the information processing apparatus 60 may be a built-in memory, for example, a DRAM, an SRAM, or a flash memory, or may be a portable medium, for example, a card or a disk to be loaded in the information processing apparatus 60. For example, the card 50 shown in FIG. 19A or 19B may be loaded into the information processing apparatus 60.

When wired connection is performed between the medium access device and the user medium 2, access can be reliably made while the user is able to visually check access, thereby reducing errors in storing or sending client data.

When wireless connection is performed between the medium access device and the user medium 2, the work load and time load for the users and staffs is significantly reduced.

### 6. Use of Recorded User's Voice

The system for easily and efficiently producing picture packages for individual users has been described by means of the first, second, and third examples. As discussed above, picture packages may contain sound. For example, the photographic device 3 may be provided with a microphone so as to record sound as well as pictures. Accordingly, the picture database 15 of the picture production apparatus 1 may store audio data that is recorded simultaneously with the pictures in the above-described examples. Additional pictures also contain accompanying sound.

Such audio data may be the sound of an attraction or the sound of a place where the microphone is installed, or BGM prepared by a commercial entity, however, it does not always reflect the user's voice or surrounding sound. That is, the microphone does not follow the actions of each user.

If the sound attached to the user, for example, the user's voice, is contained in a picture package, that picture package becomes more interesting.

Accordingly, a system for producing picture packages including sound attached to the user (hereinafter referred to as “recorded user's voice”) by using the information processing apparatus 60 owned by the user as a recorder 100 is now described below.

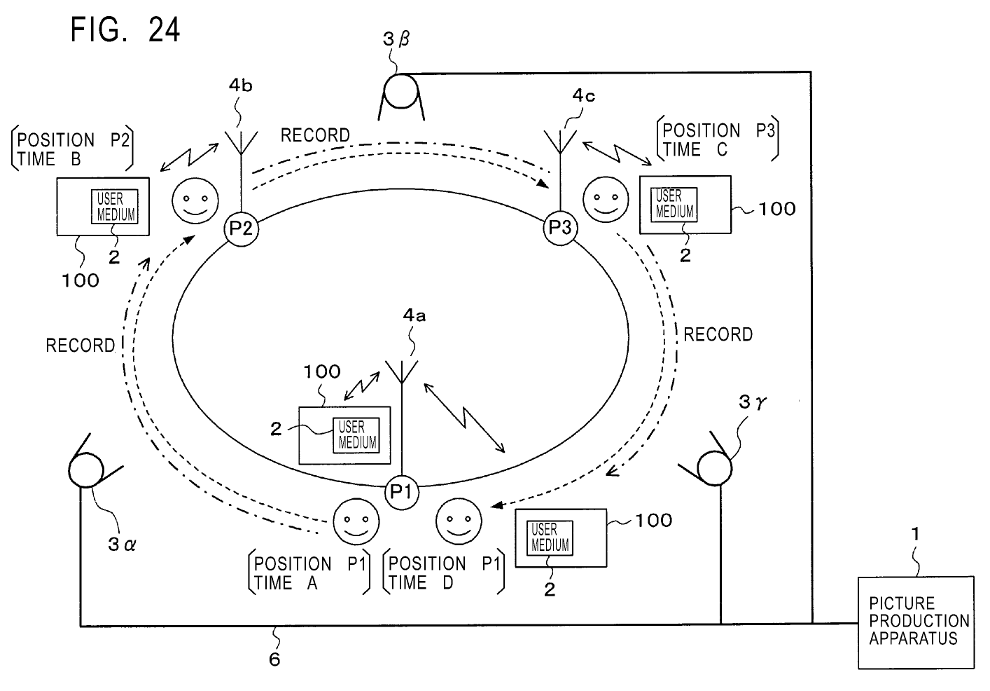

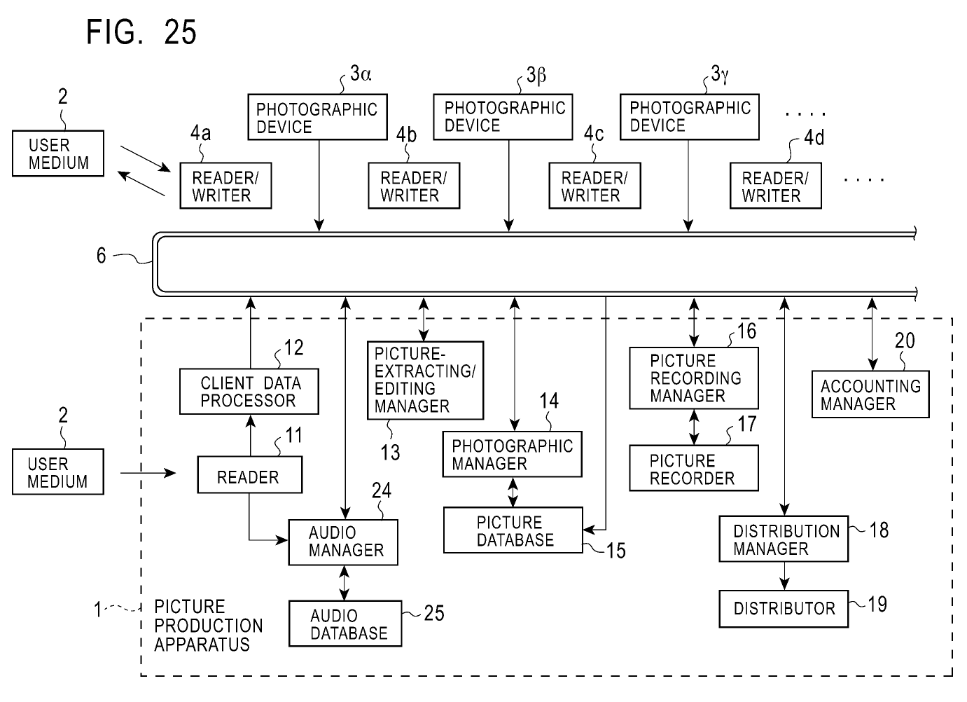

FIGS. 24 and 25 illustrate the above-described first example of the system in which the user's voice can be recorded.

As shown in FIG. 24, the user owns the recorder 100 as well as the user medium 2. The recorder 100 is equivalent to the information processing apparatus 60, for example, a personal computer, a PDA, or a cellular telephone, with a recording function. The user medium 2 is a memory loaded or integrated into the recorder 100.

Basic points, such as the reading/writing of time data and position data from/into the user medium 2, the operation of the reader/writer 4, and the operation of the photographic device 3, are similar to those discussed in the above-described first example of the system.

In the system shown in FIG. 24, however, the recorder 100 constantly performs a recording operation while the user performs actions, as indicated by one-dot-chain lines in FIG. 24. That is, the recorder 100 records user's voice or the surrounding sound. The recorded voice and sound may be stored in the user medium 2 integrated into the recorder 100 or another medium (solid memory, disk, or tape) in the recorder 100.

In the picture production apparatus 1, as shown in FIG. 25, an audio manager 24 and an audio database 25 are provided in addition to the elements shown in FIGS. 2 and 9.

When the user presents the user medium 2 at the service reception, the reader 11 reads client data (client ID, time data, and position data) from the user medium 2 and also reads recorded audio data. The recorded audio data is then delivered to the audio manager 24 together with the client ID, and is stored in the audio database 25.

If the audio data is recorded in a medium different from the user medium 2 by the recorder 100, it is also read from the corresponding medium at the service reception, and is stored in the audio database 25.

Package production processing by integrating the user's voice into pictures is as follows. It is now assumed that the user carrying the user medium 2 performs actions, as indicated by broken lines in FIG. 24, i.e., as in positions P1→P2→P3→P1, and that the recorder 100 performs recording during the user's actions.

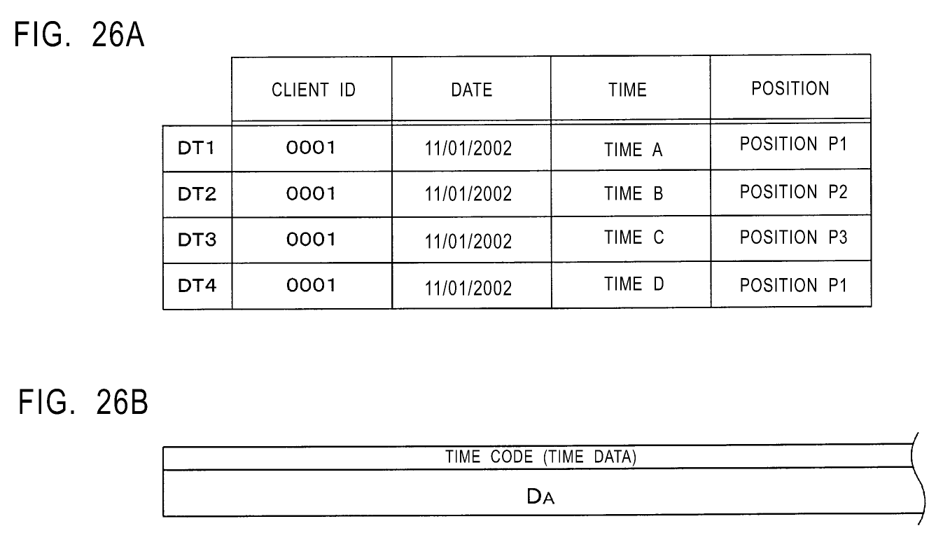

As a result of the user's actions described above, in the user medium 2 presented by the user, client data, such as that indicated by FIG. 26A, is recorded, and in the user medium 2 (or another medium), audio data D_{A}, such as that shown in FIG. 26B, for example, audio data recorded from time A to time D, is recorded.

Time code data, for example, as the actual time information, is added to this audio data D_{A}. Alternatively, the time code data may be management information, for example, in which a time code is added by setting the record start point as 0 seconds, 0 minutes, 0 hours, together with the record start time. The time code data may be added or managed in any manner as long as audio data can be read in accordance with the time. The audio data provided with the time code is stored in the audio database 25 together with the client ID.

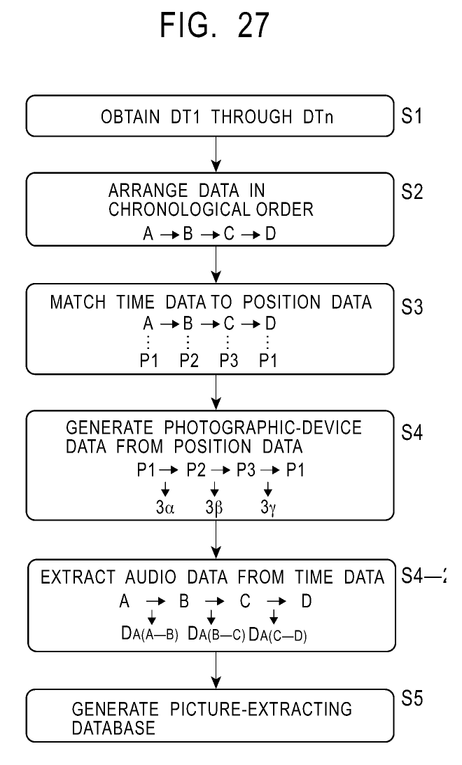

The picture production processing performed by the picture production apparatus 1 has been discussed with reference to FIG. 3. In this case, however, when the client data processor 12 and the picture-extracting/editing manager 13 generate a picture-extracting database in steps F102 and F103, the recorded user's voice is also extracted. This processing is discussed below with reference to FIG. 27 as processing for generating a picture/audio-extracting database.

Steps S1 through S4 are similar to those of FIG. 5. More specifically, for client data DT1 through DTn (DT1 through DT4 in FIG. 26A), time data is rearranged in chronological order, and the rearranged time data is matched to position data. Then, photographic data is generated from the position data. Accordingly, when the user performs actions, as shown in FIG. 24, photographic-device data taken by the photographic device 3α in the zone between position P1 and position P2 at time A to time B, photographic-device data taken by the photographic device 3β in the zone between position P2 and position P3 at time B to time C, and photographic-device data taken by the photographic device 3γ in the zone between position P3 and position P1 at time C to time D are produced.

Then, in step S4-2 of FIG. 27, audio data is extracted from the time data rearranged in step S2. Audio data D_{A(A-B)} corresponding to the time code from time A to time B, audio data D_{A(B-C)} corresponding to the time code from time B to time C, and audio data D_{A(C-D)} corresponding to the time code from time C to time D are extracted.

Subsequently, in step S5, a picture/audio-extracting database in which the photographic device data and the audio data are correlated to the time data is generated.

That is, the picture/audio-extracting database is a list indicating picture data from the photographic device 3α from time A to time B, picture data from the photographic device 3β from time B to time C, and picture data from the photographic device 3γ from time C to time D, and also indicating audio data associated with the time zone.

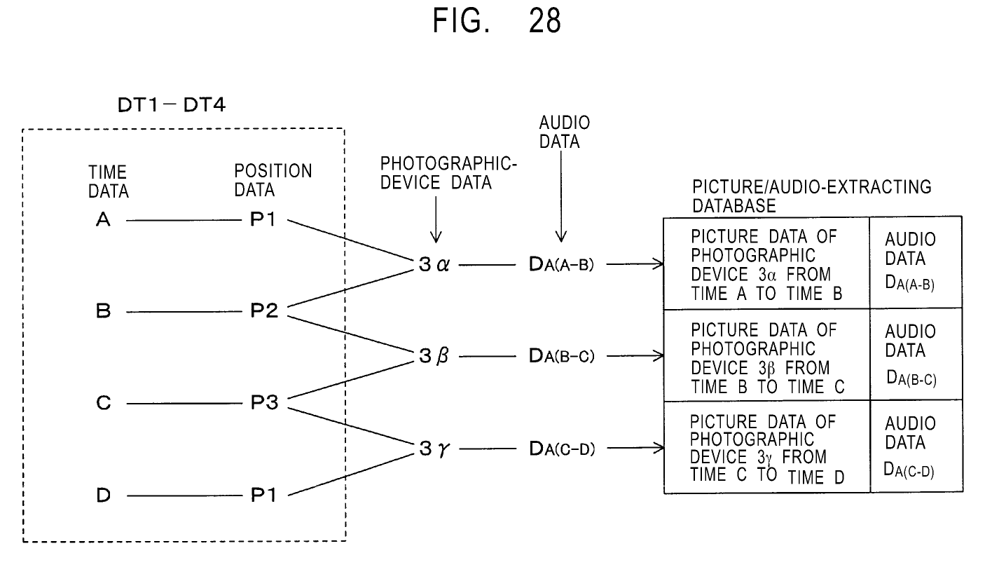

The processing of step S2 through S5 is schematically shown in FIG. 28.

As shown in FIG. 28, the photographic device data “3α”, “3β”, and “3γ” that specify the photographic devices for the corresponding zones are obtained from position data P1, P2, P3, and P1 that are rearranged in chronological order, and also the corresponding audio data D_{A(A-B)}, D_{A(B-C)}, and D_{A(C-D)} are obtained. As a result, a picture/audio-extracting database indicating the picture data and audio data in each zone is generated. In this manner, by performing matching between the time data, position data, photographic device data, and audio data, a database that allows picture data and audio data for each user to be extracted is generated.

After completing the creation of the picture/audio-extracting database in steps F102 and F103 of FIG. 3 by performing the processing discussed with reference to FIGS. 27 and 28, the process proceeds to step F104 in which picture data and audio data are extracted based on the picture/audio-extracting database.

That is, the picture-extracting/editing manager 13 instructs the photographic manager 14 to extract the required pictures based on the picture/audio-extracting database.

More specifically, the picture-extracting/editing manager 13 instructs the photographic manager 14 to read the picture data from the photographic device 3α from time A to time B, the picture data from the photographic device 3β from time B to time C, and the picture data from the photographic device 3γ from time C to time D from the picture database 15.

In response to this instruction, the photographic manager 14 selects and extracts the specified pictures from the picture data of the photographic devices 3α, 3β, and 3γ recorded in the picture database 15, and transfers the extracted picture data to the picture-extracting/editing manager 13.

The picture-extracting/editing manager 13 also instructs the audio manager 24 to extract required user's voice data based on the picture/audio-extracting database.

More specifically, the picture-extracting/editing manager 13 specifies the client ID and instructs the audio manager 24 to extract the audio data D_{A(A-B)}, D_{A(B-C)}, and D_{A(C-D)} from the audio database 25.

In response to this instruction, the audio manager 24 searches the audio database 25 for the user's voice data based on the client ID of the user, extracts the audio data D_{A(A-B)}, D_{A(B-C)}, and D_{A(C-D)} associated with the time code from the audio database 25, and transfers the audio data to the picture-extracting/editing manager 13.

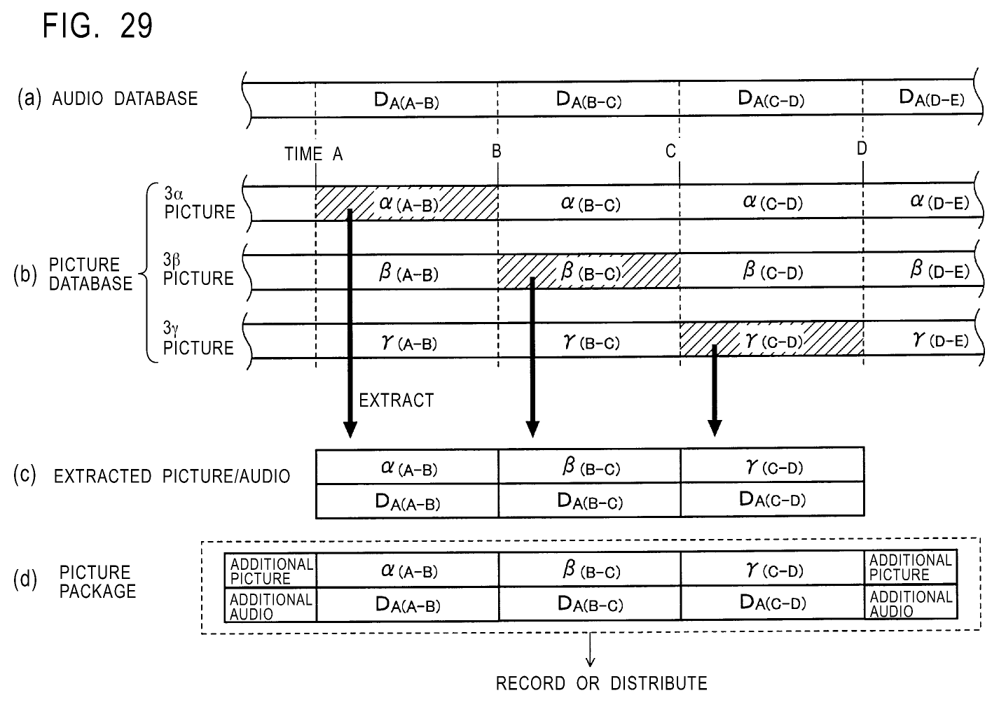

FIG. 29 schematically illustrates the extraction of picture data and audio data.

As indicated by (a) of FIG. 29, user's voice data associated with a client ID is stored in the audio database 25. Then, the audio data D_{A(A-B)}, D_{A(B-C)}, and D_{A(C-D)} in the time zones designated by the picture/audio-extracting database are extracted from the user's voice data.

As indicated by (b) of FIG. 29, the picture data taken by the photographic devices 3α, 3β, and 3γ are stored in the picture database 15. As described in the first example of the system, picture data α_{(A-B)} taken by the photographic device 3α, picture data β_{(B-C)} taken by the photographic device 3β, and picture data γ_{(C-D)} taken by the photographic device 3γ are extracted.

In step F105 of FIG. 3, the picture-extracting/editing manager 13 performs predetermined processing, for example, editing of the picture data α_{(A-B)}, β_{(B-C)}, and γ_{(C-D)} transferred from the photographic manager 14 and the audio data D_{A(A-B)}, D_{A(B-C)}, and D_{A(C-D)} transferred from the audio manager 24 in chronological order, or cutting of the time length, thus resulting in the edited pictures/audio data, as shown in (c) of FIG. 29.

In some cases, a picture showing the entire attraction or a promotional picture of the attraction or the facility may be inserted before or after, or in the middle of the picture data α_{(A-B)}, β_{(B-C)}, and γ_{(C-D)} as an additional picture.

By performing such editing processing, a picture package can be generated. An example of the picture package by using the picture data α_{(A-B)}, β_{(B-C)}, and γ_{(C-D)} and the audio data D_{A(A-B)}, D_{A(B-C)}, and D_{A(C-D)} and by inserting additional pictures and additional sound before and after the picture data and audio data is shown in (d) of FIG. 29.

After completing the production of a picture/audio package, the package is provided to the user in step F106 and accounting processing is performed in step F107, as discussed above.

As described above, picture packages with audio data can be produced by using user's voice, and the user is able to obtain a more interesting picture package. Since the information processing apparatus 60 owned by the user can be used as the recorder 100, the commercial entity does not have to provide a recorder for the user. In other words, if the user has a device with a recording function, the commercial entity can also use it, and the user is able to receive a picture package with a high value.

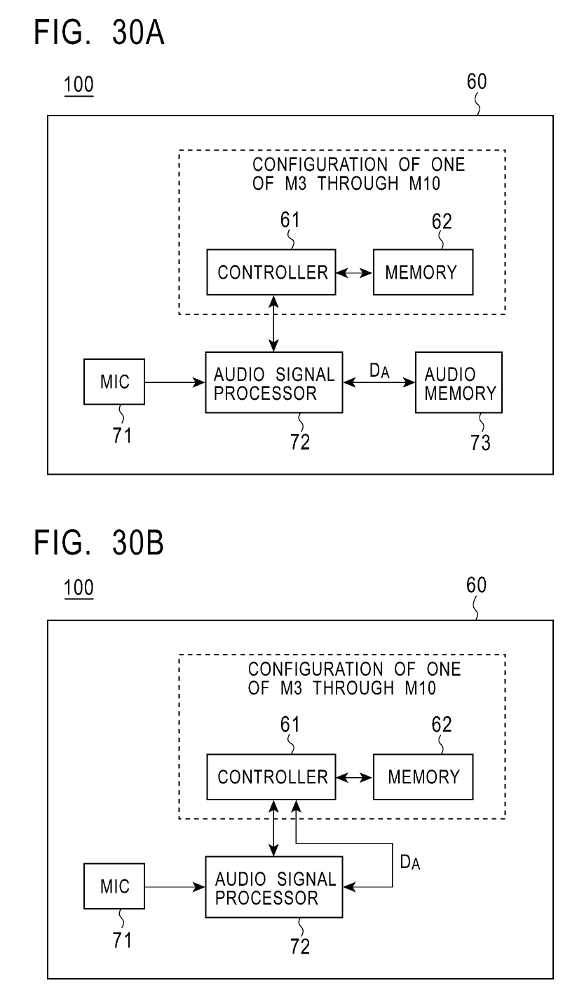

The recorder 100 can be formed, such as that shown in FIG. 30A or 30B.

The information processing apparatus 60 shown in FIG. 30A includes a microphone 71, an audio signal processor 72, and an audio memory 73. The configuration of the controller 61 and the memory 62 surrounded by the broken lines in FIG. 30A may be configured as one of the user media M3 through M10 shown in FIGS. 20A through 23B.

In the information processing apparatus 60 shown in FIG. 30A, an audio signal collected by the microphone 71 is analog-to-digital (A/D) converted or record-encoded in the audio signal processor 72, and is recorded in the audio memory 73 as the user's voice data D_{A}. The audio memory 73 may be a portable medium, for example, a disk, tape, or a memory card, or a fixed built-in medium, for example, a hard disk (HDD) or a built-in memory.

The information processing apparatus 60 shown in FIG. 30B includes the microphone 71 and the audio signal processor 72. As in the information processing apparatus 60 shown in FIG. 30A, the controller 61 and the memory 62 surrounded by the broken lines in FIG. 30B may be configured as one of the user media M3 through M10.

In the information processing apparatus 60 shown in FIG. 30B, an audio signal collected by the microphone 71 is A/D converted or record-encoded in the audio signal processor 72, and is recorded in the memory 62 via the controller 61 as the user's voice data D_{A}. That is, the user's voice data D_{A} is recorded in the memory 62 together with the client data including the client ID, time data, and position data.

With this configuration, the user delivers the audio data D_{A} recorded in the audio memory 73 or the memory 62 to the picture production apparatus 1 together with the client data in the memory 62, and stores them in the audio database 25.

If the memory 62 or the audio memory 73 is a portable medium, the user simply hands the medium at the service reception, and the commercial entity reads the data.

Regardless of whether the memory 62 or the audio memory 73 is a built-in memory or a portable memory, the audio data D_{A} in the memory 62 or the audio memory 73 can be transferred to the picture production apparatus 1 by wired or wireless interfaces between the user medium 2 and the medium access device, as discussed with reference to FIGS. 20A through 23B illustrating the user media M3 through M10.

Although the recording of the user's voice has been described in the context of the first example of the system, user's voice may be recorded by using the recorder 100 (information processing apparatus 60) in the second or third example of the system.

Particularly in the second example of the system, since the medium access device (reader 5) has a communication function of performing communication via the network 6, it can read the audio data D_{A} recorded in the user medium 2 and sends it to the picture production apparatus 1 together with the client ID, time data, and position data. In this case, the picture production apparatus 1 should be provided with the audio manager 24 and the audio database 25 in addition to the elements shown in FIG. 9.

In the third example of the system, since the information processing apparatus 60 has a communication function, it can send the audio data D_{A} to the picture production apparatus 1. In this case, the audio data D_{A} may be sent in response to a user's operation or access from the medium access device. Alternatively, the audio data may be automatically sent at regular intervals or when the capacity of the memory becomes small. Instead of recording the audio data in the information processing apparatus 60, the audio data D_{A} collected by the microphone 71 may be directly sent to the picture production apparatus 1 by embedding the client ID into the audio data D_{A}. In this case, the picture production apparatus 1 should be provided with the audio manager 24 and the audio database 25 shown in FIG. 25 in addition to the elements shown in FIG. 13.

In the above-described system, the recorder 100 constantly records sound during the user's actions. However, sound does not have to be constantly recorded.

For example, the recorder 100 may record sound for a predetermined period of time after the user passes each medium access device, or the user may instruct the recording start/end time. Alternatively, the medium access devices serving as trigger devices in the third example of the system may generate a trigger signal indicating the recording start/end time, and then, recording is automatically performed at a corresponding place in accordance with the trigger signal.

The control of recording the audio data D_{A} and the sending/transferring, and management of the audio data D_{A} is performed by the information processing apparatus 60. To implement these operations, the commercial entity simply distributes application software for allowing the information processing apparatus 60 to perform such operations.

### 7. Use of Pictures Taken by User

A description is now given of a system for producing picture packages including moving pictures or still images taken by the user himself/herself (hereinafter also referred to as “user pictures”).

If pictures taken by the user himself/herself are contained in a picture package, that picture package becomes more interesting for the user. It is also possible to include pictures of the places that are not taken by a commercial entity by using the photographic device 3.

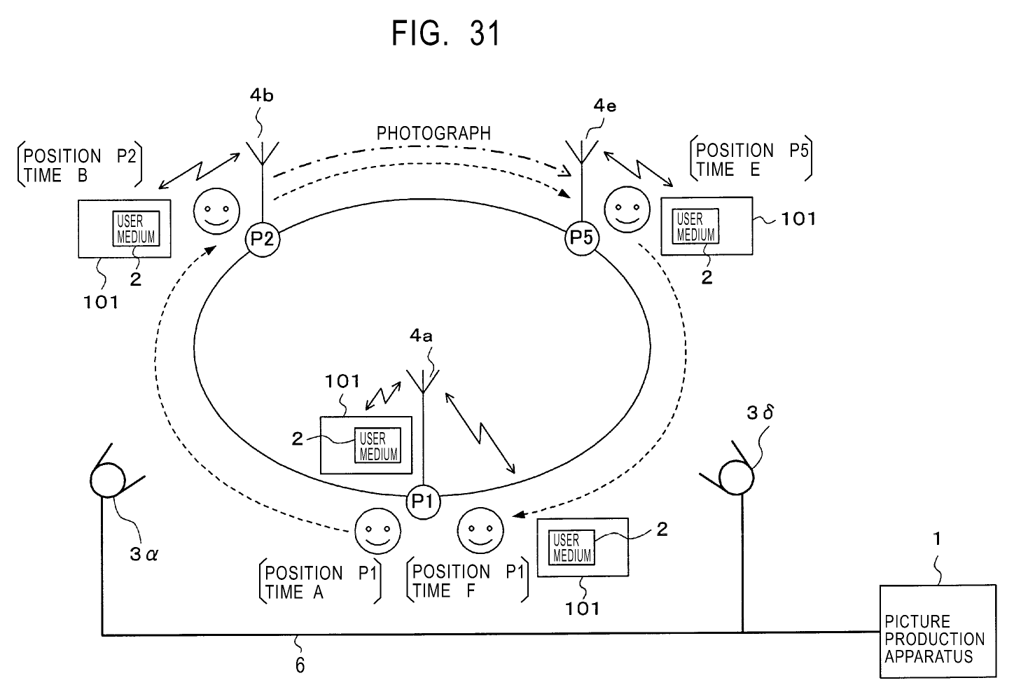

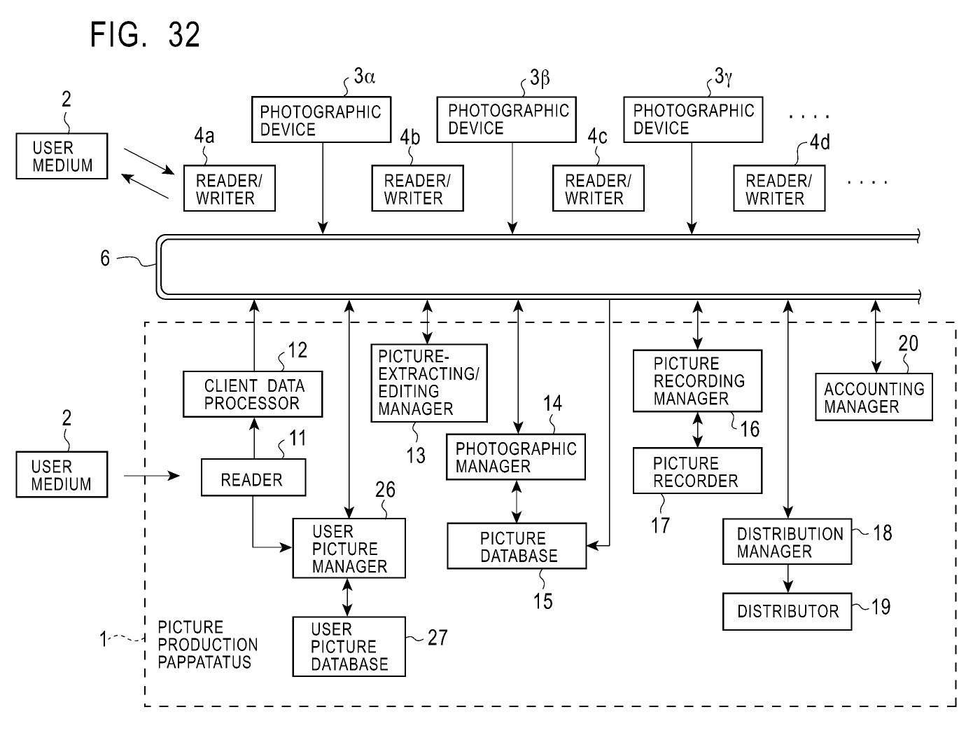

FIGS. 31 and 32 illustrate the configuration of the first example of the system in which pictures taken by the user can be obtained.

As shown in FIG. 31, the user carries a photographic machine 101 as well as the user medium 2. The photographic machine 101 is the information processing apparatus 60, for example, a personal computer, a PDA, or a cellular telephone, having a photographic function. The user medium 2 is a memory loaded or integrated into the photographic machine 101.

Basic points, for example, the reading/writing of time data and position data from/into the user medium 2, the operation of the reader/writer 4, the operation of the photographic device 3, are similar to those of the first example of the system.

In the configuration of the system shown in FIG. 31, however, a reader/writer 4e is disposed at position P5, and the photographic device 3 of the commercial entity is not disposed in the zone from position P2 to position P5. A photographic device 3δ of the commercial entity is disposed in the zone from position P5 to position P1.

In this case, the user takes pictures in the zone from position P2 to position P5, as indicated by the one-dot-chain line in FIG. 31, by using the photographic machine 101. The user may take pictures at any time and select any subject at his/her discretion.

Pictures taken by the user may be stored in the user medium 2 or another medium (solid memory, disk, or tape) in the photographic machine 101.

The picture production apparatus 1 includes, as shown in FIG. 32, a user picture manager 26 and a user picture database 27 in addition to the elements shown in FIG. 2.

When the user presents the user medium 2 at the service reception, the reader 11 reads the client data (client ID, time data, and position data) from the user medium 2, and also reads recorded picture data. The picture data is delivered to the user picture manager 26 together with the client ID, and is stored in the user picture database 27.

If the picture data is recorded in a medium different form the user medium 2 by the photographic machine 101, the picture data is read from that medium at the service reception, and is stored in the user picture database 27.

Picture-package production processing using user pictures is as follows.

It is now assumed that the user carrying the user medium 2 acts, as indicated by the broken lines in FIG. 31, i.e., as in positions P1→P2→P5→P1, at time A, time B, time E, and time F, and that the user takes pictures by using the photographic machine 101 in the zone from position P2 to P5.

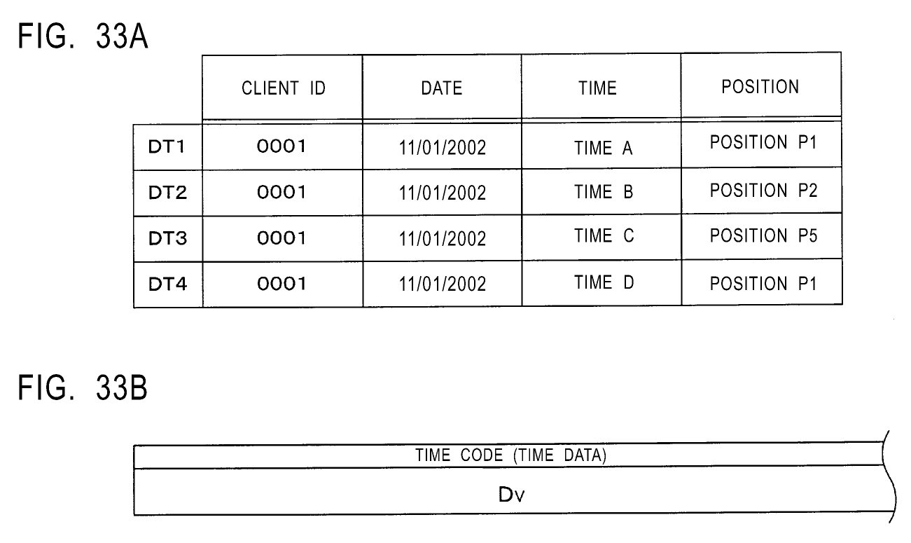

Then, in the user medium 2 presented by the user, the client data, such as that shown in FIG. 33A, is recorded, and also, in the user medium 2 (or another medium), picture data D_{V}, for example, picture data taken from time B to time E, such as that shown in FIG. 33B, is recorded.

Time code data, for example, as the actual time information, is added to this picture data Dᵥ. Alternatively, the time code data may be management information, for example, in which a time code is added by setting the picture-taking start point as 0 seconds, 0 minutes, 0 hours, together with the picture-taking start time. The time code data may be added or managed in any manner as long as picture data can be read in accordance with the time. The picture data with the time code is stored in the user picture database 27 together with the client ID.

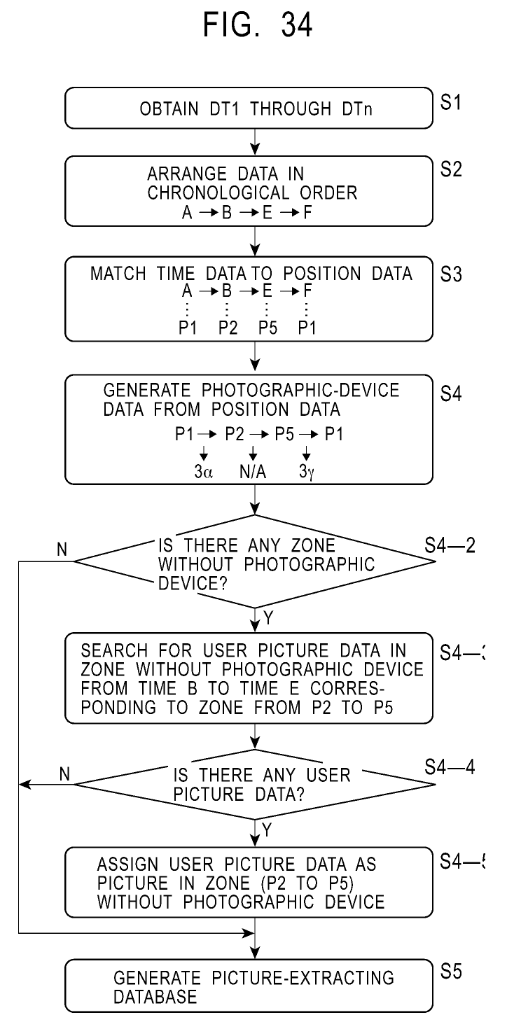

The picture production processing performed by the picture production apparatus 1 is similar to that discussed with reference to FIG. 3. In this case, however, when the client data processor 12 and the picture-extracting/editing manager 13 generate a picture-extracting database in steps F102 and F103, user pictures are also extracted. This processing is discussed below with reference to FIG. 34.

Steps S1 through S4 are similar to those of FIG. 5. More specifically, for client data DT1 through DTn (DT1 through DT4 in FIG. 33A), time data is rearranged in chronological order, and the rearranged time data is matched to position data. Then, photographic-device data is generated from the position data.

More specifically, the client data DT1 through DT4 shown in FIG. 33A are rearranged in chronological order in step S2, resulting in time data A→B→E→F. Then, in step S3, the rearranged time data is matched to position data, resulting in the position data P1→P2→P5→P1. In step S4, photographic-device data is generated from the position data. In this case, according to the arrangement of the photographic devices 3 in FIG. 31, the photographic device 3α corresponds to the zone from position P1 to position P2, and the photographic device 3δ corresponds to the zone from position P5 to position P1. However, there is no photographic device 3 between position P2 and P5.

Subsequent to step S4, step S4-2 is performed. In step S4-2, it is determined whether there is a zone without the photographic device 3 in step S4. If there is a zone without the photographic device 3 (for example, in the zone from position P2 to P5), the process proceeds to step S4-3 in which user picture data is searched for in the corresponding zone.

More specifically, the picture-extracting/editing manager 13 sends the time (in this case, time B and time E) of the corresponding zone and the client ID to the user picture manager 26, and requests the user picture manager 26 to search the user picture database 27 for the picture data D_{V}.

In step S4-4, the picture-extracting/editing manager 13 checks for the picture data D_{V(B-E)} in the corresponding zone from the response from the user picture manager 26. If the picture data D_{V(B-E)} has been found, the process proceeds to step S4-5 in which the picture data D_{V(B-E)} is assigned as the picture in the zone from position P2 to P5 without the photographic device 3.

Subsequently, in step S5, a picture-extracting database in which the photographic-device data is correlated to the time data is generated.

That is, in the example shown in FIGS. 31 and 33, the picture-extracting database is a list indicating picture data from the photographic device 3α from time A to time B, user picture data D_{V(B-E)} from time B to time E, and picture data from the photographic device 3δ from time E to time F.

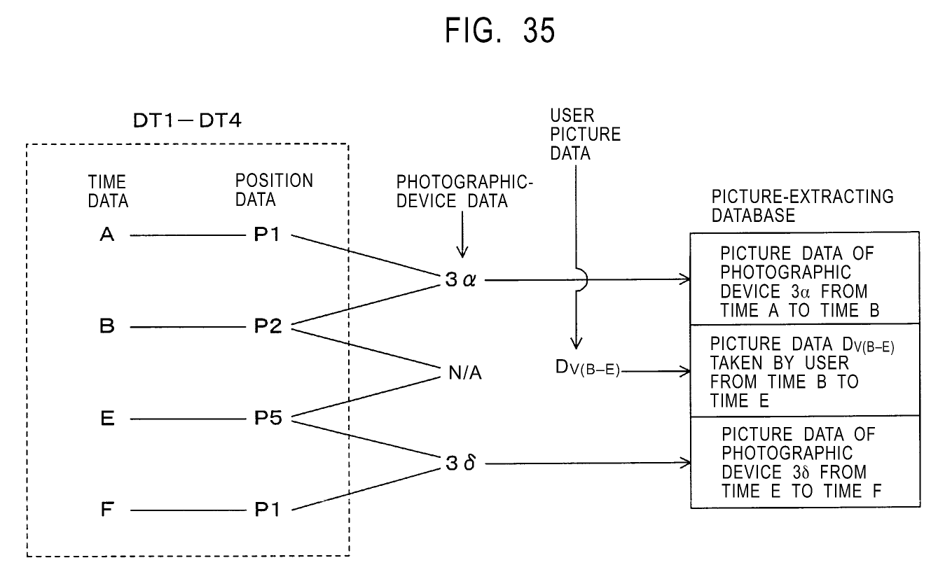

The processing of step S2 through S5 is schematically shown in FIG. 35.

As shown in FIG. 35, the photographic device data “3α”, “N/A”, and “3δ” that specify the photographic devices for the zones A→B, B→E, and E→F are obtained from position data P1, P2, P5, and P1 rearranged in chronological order.

In the period B→E without a photographic device, the user picture data D_{V(B-E)} is assigned. As a result, a picture-extracting database indicating pictures to be extracted in each period can be formed.

After generating the picture-extracting database in steps F102 and F103 by performing processing discussed with reference to FIGS. 34 and 35, picture data is extracted based on the picture-extracting database in step F104 of FIG. 3. That is, the picture-extracting/editing manager 13 instructs the photographic manager 14 and the user picture manager 26 to extract required pictures based on the picture-extracting database.

More specifically, the picture-extracting/editing manger 13 instructs the photographic manager 14 to read the picture data from the photographic device 3α from time A to B, and the picture data from the photographic device 3δ from time E to F from the picture database 15.

In response to this instruction, the photographic manager 14 selects and extracts the pictures in the designated periods from the picture data from the photographic device 3α and the picture data from the photographic device 3δ stored in the picture database 15, and transfers the extracted pictures to the picture-extracting/editing manager 13.

The picture-extracting/editing manager 13 also instructs the user picture manger 26 to read the user picture data D_{V(B-E)} in the period from time B to E from the user picture database 27.

In response to this instruction, the user picture manager 26 extracts the user picture data D_{V(B-E)} based on the client ID and the time code corresponding to time B and E from the user picture database 27, and transfers the extracted picture data D_{V(B-E)} to the picture-extracting/editing manager 13.

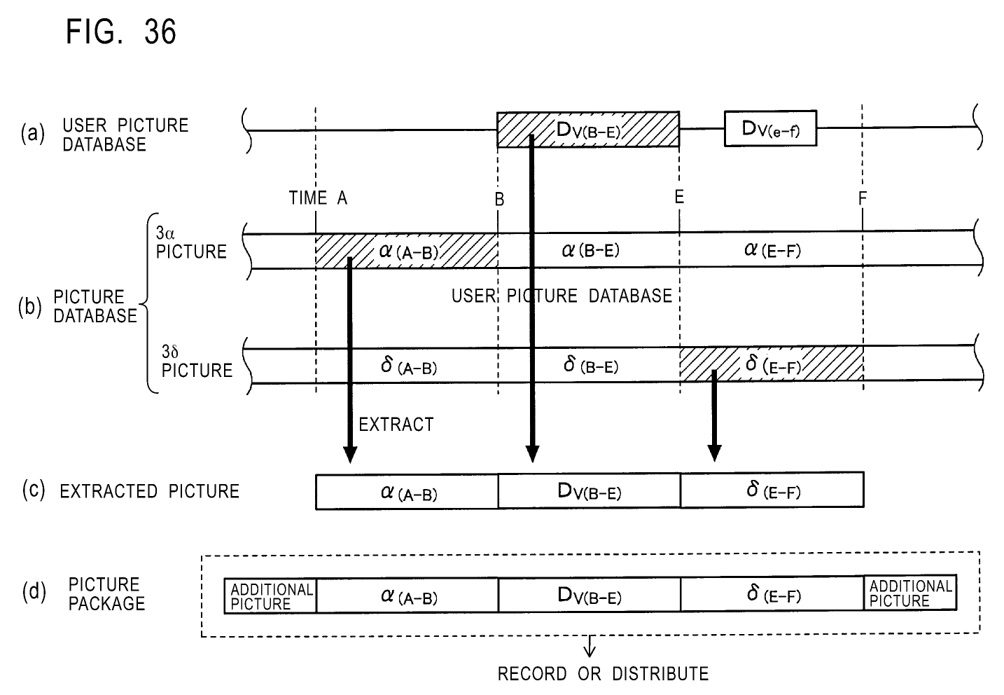

FIG. 36 schematically illustrates the extraction of picture data.

In the user picture database 27, as indicated by (a) of FIG. 36, user picture data D_{V} according to a client ID is stored, assuming that the user of the client ID has taken pictures during the period from time B to time E and the period form time e to f.

Also as indicated by (b) of FIG. 36, in the picture database 15, picture data taken by the photographic devices 3α and 3δ is stored.

From these databases, as indicated by (c) of FIG. 36, picture data α_{(A-B)} by the photographic device 3α, user picture data D_{V(B-E)}, and picture data δ_{(E-F)} by the photographic device 3δ are extracted.

Then, in step F105 of FIG. 3, the picture-extracting/editing manager 13 performs predetermined processing, for example, editing of the picture data α_{(A-B)}, D_{V(B-E)}, and δ_{(E-F)} transferred from the photographic manager 14 and the user picture manager 26 in chronological order, or cutting of the time length, thus resulting in a package picture as indicated in (c) of FIG. 36.

In some cases, a picture showing the entire attraction or a promotional picture of the attraction or the facility may be inserted before or after, or in the middle of the picture data α_{(A-B)}, D_{V(B-E)}, and δ_{(E-F)} as an additional picture.

By performing such editing processing, a picture package can be generated. An example of the picture package by using the picture data α_{(A-B)}, D_{V(B-E)}, and δ_{(E-F)} and by inserting additional pictures before and after the picture data is shown in (d) of FIG. 36.

After completing the production of a picture package, the package is provided to the user in step F106 and accounting processing is performed in step F107, as discussed above.

As described above, picture packages can be produced by using user pictures, and the user is able to obtain a more interesting picture package. Since the information processing apparatus 60 owned by the user can be used as the photographic machine 101, the commercial entity does not have to provide a photographic machine for the user.

Additionally, pictures taken by the user, such as pictures showing a place without the photographic device 3, can be contained in a picture package. Thus, the user is able to take pictures as he/she likes, and also enjoy participating in the picture production, and at the same time, the cost of the facility for the commercial entity can be reduced.

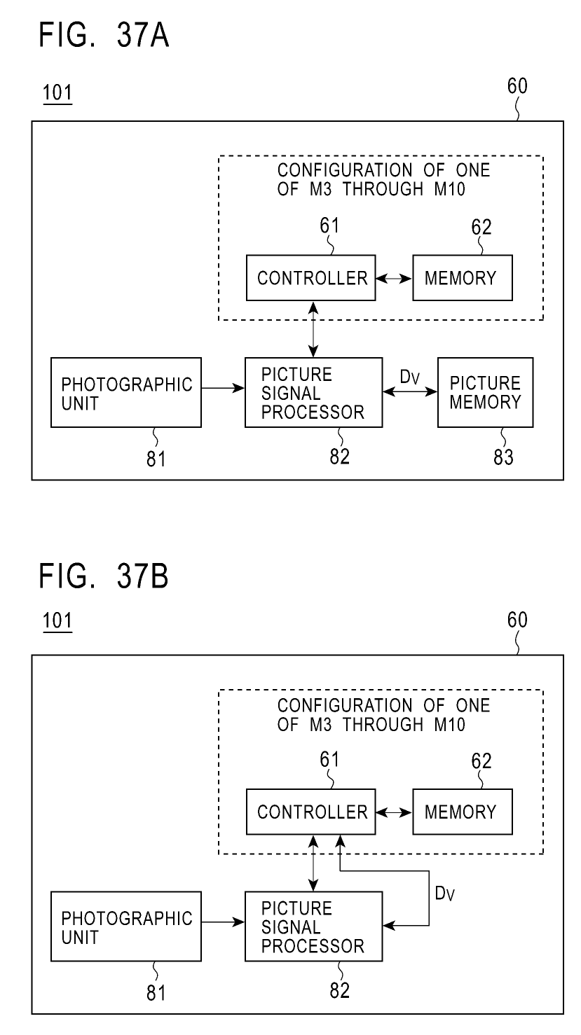

The photographic machine 101 owned by the user as the information processing apparatus 60 may be configured, as that shown in FIG. 37A or 37B.

The photographic machine 101 shown in FIG. 37A includes a photographic unit 81 provided with, for example, a lens system, a charge-coupled-device (CCD) image-capturing device, and a photographic-signal processing circuit, a picture signal processor 82 for record-encoding a picture signal captured by the photographic unit 81, and a picture memory 83.

The controller 61 and the memory 62 surrounded by the broken lines in FIG. 37A can be configured as one of the user media M3 through M10 shown in FIGS. 20A through 23B, respectively.

With this configuration, a picture signal captured by the photographic unit 81 is record-encoded in the picture signal processor 82, and is recorded in the picture memory 83 as the user picture data D_{V}. The picture memory 83 may be a portable medium, for example, a disk, tape, or a memory card, or a fixed built-in medium, for example, a hard disk (HDD) or a built-in memory.

The photographic machine 101 shown in FIG. 37B includes the photographic unit 81 and the picture signal processor 82, and as in FIG. 37A, the controller 61 and the memory 62 surrounded by the broken lines can be configured as one of the user media M3 through M10.

With this configuration, a picture signal captured by the photographic unit 81 is record-encoded in the picture signal processor 82, and is recorded in the memory 62 via the controller 61 as the user picture data D_{V}, together with the client data such as the client ID, time data, and position data.

In the user medium shown in FIG. 37A or 37B, the user delivers, together with the client data in the memory 62, the picture data D_{V} recorded in the picture memory 83 or the memory 62 to the picture production apparatus 1, and stores the data in the user database 27.

If the memory 62 or the picture memory 83 is a portable memory, the user simply hands it at the service reception, and the commercial entity reads the data.

Regardless of whether the memory 62 or the picture memory 83 is a built-in memory or a portable memory, the picture data D_{V} in the memory 62 or the picture memory 83 can be transferred to the picture production apparatus 1 by wired or wireless interfaces between the user medium 2 and the medium access device, as discussed with reference to FIGS. 20A through 23B illustrating the user media M3 through M10.

Although the use of user pictures has been described in the context of the first example of the system, user pictures can be used by using the photographic machine 101 (information processing apparatus 60) in the second or third example of the system.

Particularly in the second example of the system, since the medium access device (reader 5) has a communication function of performing communication via the network 6, it can read the picture data D_{V} recorded in the user medium 2 and sends it to the picture production apparatus 1 together with the client ID, time data, and position data. In this case, the picture production apparatus 1 should be provided with the user picture manager 26 and the user picture database 27 shown in FIG. 32 in addition to the elements shown in FIG. 9.

In the third example of the system, since the information processing apparatus 60 has a communication function, it can send the picture data D_{V} to the picture production apparatus 1. In this case, the picture data D_{V} may be sent in response to a user's operation or access from the medium access device. Alternatively, the picture data may be automatically sent at regular intervals or when the capacity of the memory becomes small. Instead of recording the picture data in the information processing apparatus 60, the picture data D_{V} obtained by the photographic unit 81 may be directly sent to the picture production apparatus 1 by embedding the client ID into the picture data D_{V}. In this case, the picture production apparatus 1 should be provided with the user picture manager 26 and the user picture database 27 shown in FIG. 32 in addition to the elements shown in FIG. 13.

The sending/transferring and management of the picture data D_{V} is performed by the information processing apparatus 60. To implement these operations, the commercial entity simply distributes application software for allowing the information processing apparatus 60 to perform such operations.

In the picture package production processing described with reference to FIGS. 34 through 36, user pictures taken in a time period at a place without the photographic device 3 installed by the commercial entity are used. This is based on the concept that a picture package is produced while giving priority to the pictures taken by the photographic devices 3. That is, pictures taken by the user are complementarily used.

However, a picture package may be produced by using user pictures more actively, and the resulting package becomes more preferable to the user.

Accordingly, a picture package can be produced while giving priority to user pictures, and pictures taken by the photographic devices 3 in a time period without user pictures may be used. More specifically, time data is rearranged in chronological order, and the rearranged time data is matched to position data. Then, user picture data D_{V} is extracted and assigned to a picture in each time period, and pictures taken by the photographic machine 3 are assigned to a time period in which user pictures are not available.

In the example shown in FIGS. 36A through 36C, user picture data D_{V} is available during the time period e-f in time E to F. By using such user picture data D_{V}, a picture package including picture data α_{(A-B)}, D_{V(B-E)}, and D_{V(e-f)} may be produced.

Both the pictures taken by the photographic device 3 of the commercial entity and the user picture data D_{V} can be effectively used. In the example shown in FIG. 36, as the picture from time E to F, both the picture data δ_{(E-F)} and user picture data D_{V(e-f)} may be used.

Of course, the system using user pictures may be combined with the above-described system using recorded user's voice.

### 8. Wireless-Connection Access to User Medium and Corresponding System

A description is now given of various arrangements of the user medium 2 formed as, for example, an IC card, the medium access devices 10 (reader/writers 4, readers 5, or writers or trigger devices 7), and the photographic devices 3 fixed in the system.

As described above, personal authentication or client-data access is made by connecting the user medium 2 (card 50 or information processing apparatus 60) to the corresponding medium access device 10 or by bringing the user medium 2 close to the medium access device 10. Basically, the photographic device 3 is disposed in a zone between two medium access devices 10.

However, there may be the following case. If photographic positions suitable for the user can be specified, it is sometimes desired that the positions of the medium access devices be set as photographic points, and the photographic devices 3 take pictures by focusing on such positions. That is, the photographic devices 3 take pictures by pinpointing the user, and then, the corresponding time and positions are specified, thereby producing a picture package. Although this can be implemented in the above-described system, the following disadvantages are encountered.

At each access point where the medium access device 10 is disposed, the user is required to connect to or make contact with the medium access device 10 by using the user medium 2 or bring the user medium 2 close to the medium access device 10. Accordingly, the user does not look natural in the resulting pictures. When it is desired that pictures be taken by pinpointing the user during an attraction, the user is unable to connect to or make contact with the medium access device 10 by using the user medium 2 or bring the user medium 2 close to the medium access device 10.

If the user with the user medium 2 in hand is photographed by the photographic devices 3, the user medium 2 always appears in the resulting pictures, thus causing the pictures to look unnatural.

Such drawbacks can be overcome by displacing the positions of the medium access devices 10 from photographic points. In this case, however, the time and position on the pictures differ from the time data and position data as the client data, which makes it difficult to extract, for example, close-up pictures of the user.

In this case, it is preferable that access can be made to the user medium 2 by the medium access device 10 without making the user aware of the user medium 2.

In order to implement this, the user medium 2 is formed as the non-contact wireless card 50, such as that shown in FIG. 19B. The card 50 may be any shape, such as a card, a tag, etc. However, the user medium 2 may be formed as the information processing apparatus 60 if it can be attached in the following manner.

The user medium 2, for example, the non-contact wireless card 50, can be attached to the user's body, for example, the hip, the back, or the sole.

For example, the user wears a belt or clothes so that the card 50 can be attached to the user's hip or the back. It is now assumed that the “belt” or “clothes” used here are a belt, a shirt, etc., which are directly in contact with the back of a chair or a seat used by the user, or trousers or pants that are in contact with the user's hip or back.

Alternatively, the user wears shoes having the card 50 therein, and then, the card 50 can be in contact with the sole. It is now assumed that the “shoes” include shoes, slippers, etc., which are directly in contact with the floor or the ground, or socks or tights, which are directly in contact with the feet.

The medium access devices 10 are disposed at positions in which they can wirelessly communicate with the user medium 2, for example, the card 50, which is attached to the user's back, hip, or sole.

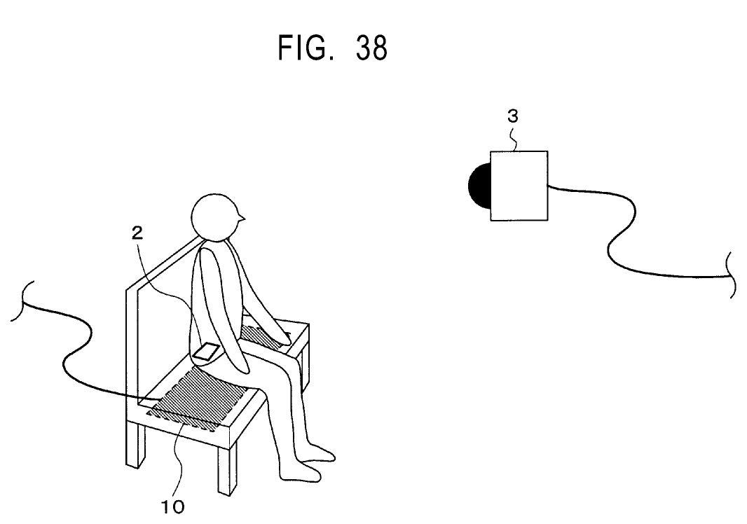

FIG. 38 illustrates an example in which the user wears the user medium 2, i.e., the card 50, at the hip. The medium access device 10 is disposed, for example, within a chair, and the user sits on the chair so that the user medium 2 and the medium access device 10 can perform wireless communication with each other. That is, as stated above, access, recording, or sending of position data, time data, and client ID is performed. In this case, the photographic device 3 is disposed so that it can aim at the user sitting on the chair as the subject.

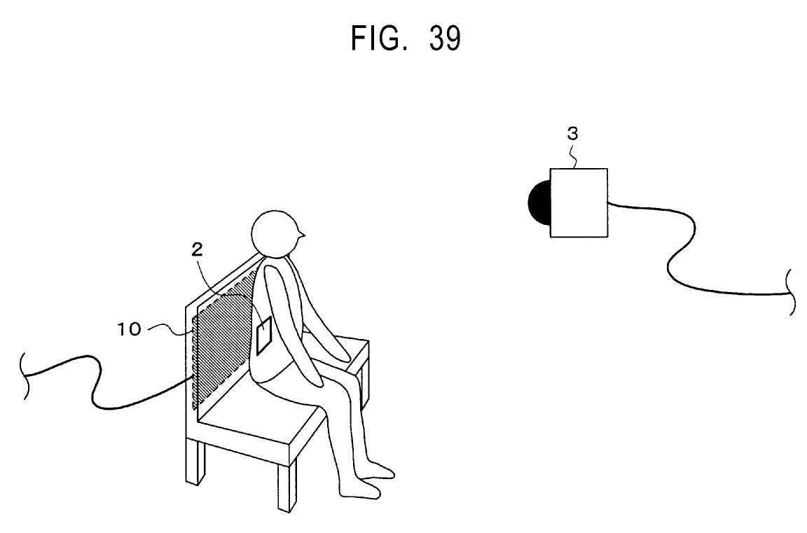

FIG. 39 illustrates an example in which the user wears the user medium 2, i.e., the card 50, on his/her back. The medium access device 10 is disposed, for example, within the back of a chair, and the user sits on the chair so that the user medium 2 and the medium access device 10 can perform wireless communication with each other. That is, as stated above, access, recording, or sending of position data, time data, and client ID is performed. In this case, the photographic device 3 is also disposed so that it can aim at the user sitting on the chair as the subject.

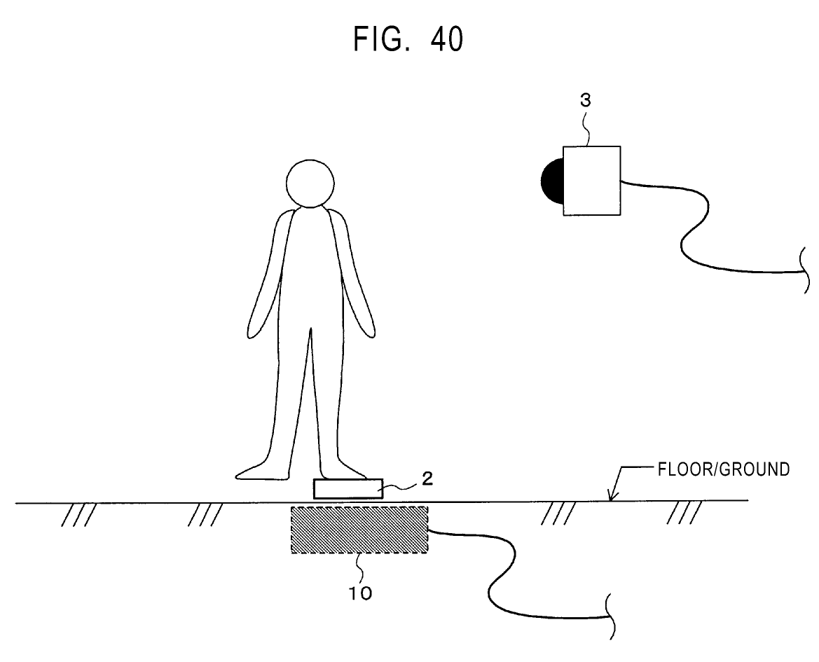

FIG. 40 illustrates an example in which the user wears the user medium 2, i.e., the card 50, on the sole. The medium access device 10 is disposed, for example, under the floor of the facility or under the ground, and when the user passes or stops at the position under which the medium access device 10 is disposed, the user medium 2 and the medium access device 10 can perform wireless communication with each other. In this case, the photographic device 3 aims at the user passing or stopping at the corresponding position as the subject.

In this mode, the photographic devices 3 can take pictures by pinpointing the user setting on the chair or standing at the corresponding position. By performing communication between the user medium 2 and the medium access device 10, the position and the time at which the user is present can be precisely identified as the client data. Thus, pictures of a certain user can be precisely extracted from the pictures that are constantly being taken by the photographic devices 3.

A picture-package production method employed in the above-described system is described below. The picture production apparatus 1 is configured, for example, as one of the first, second, and third examples of the systems.

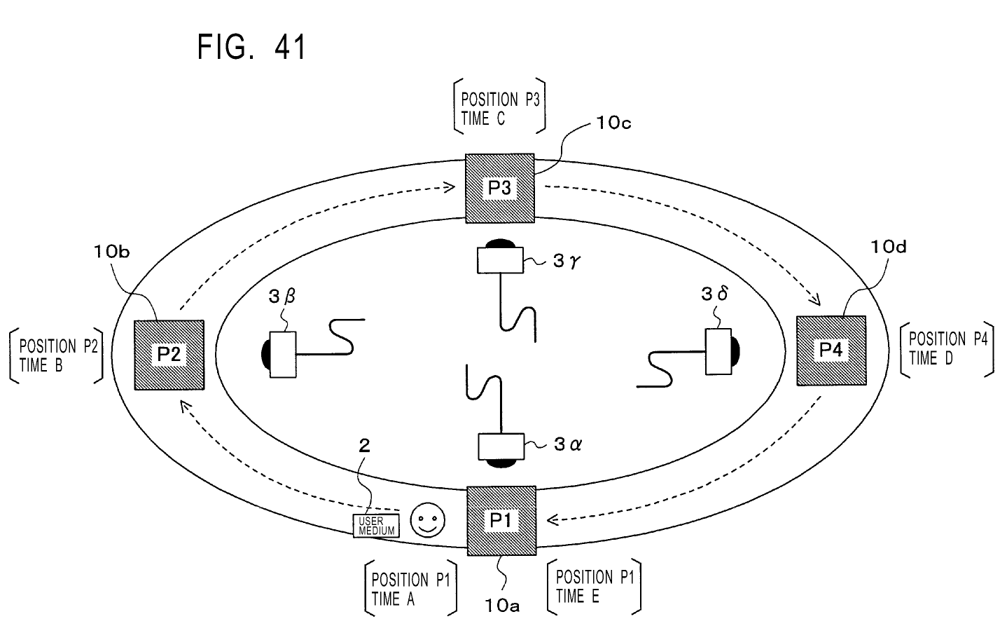

FIG. 41 illustrates the arrangement of medium access devices 10 and photographic devices 3 and user's actions in the service receiving area.

The medium access devices 10 are disposed at positions P1, P2, P3, and P4, i.e., within the chairs or under the floor as described above. The photographic devices 3α, 3β, 3γ, and 3δ are disposed at positions in which they can pinpoint the positions P1, P2, P3, and P4, while constantly taking pictures.

It is now assumed that the user wearing the user medium 2 on the back, the hip, or the sole acts, as indicated by broken lines in FIG. 41, i.e., as in positions P1→P2→P3→P4→P1 at time A, B, C, D, and E, respectively.

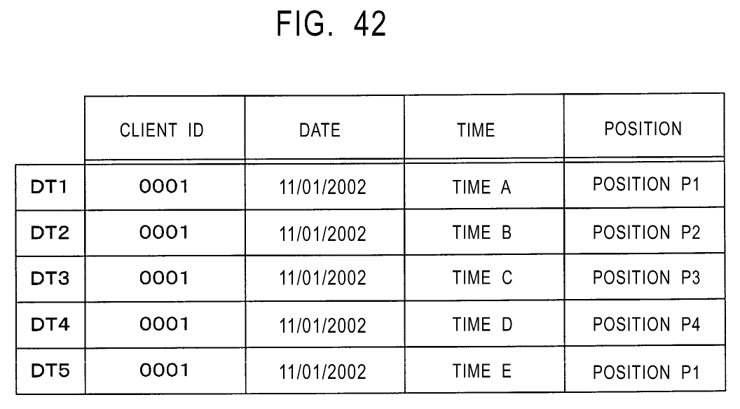

Then, the client data read from the user medium 2 by the user, or the client data sent by using a communication function of the medium access device 10 or the user medium 2 to the picture production apparatus 1 contains, for example, client data DT1 through DT5 shown in FIG. 42.

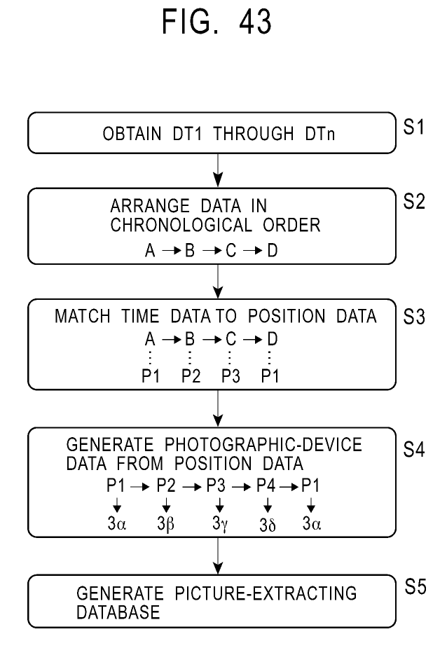

The picture production processing performed by the picture production apparatus 1 based on such client data is similar to that discussed with reference to FIG. 3. In this case, however, in the processing for generating a picture-extracting database performed by the client data processor 12 and the picture-extracting/editing manager 13 in steps F102 and F103, the matching for generating photographic-device data is different from that of FIG. 3. The processing in steps F102 and F103 is described below with reference to FIG. 43.

Steps S1 through S3 of FIG. 43 are similar to those of FIG. 5. That is, the client data DT1 through DTn (DT1 through DT5 in the example of FIG. 42) is rearranged in chronological order, and the rearranged time data is matched to position data.

In step S4, the corresponding photographic-device data is generated from the position data. In this case, there is a one-to-one correspondence between the position data and the photographic devices 3 because the position data generated by the medium access devices 10 are equivalent to the positions at which the photographic devices 3 take pictures.

Accordingly, as indicated by step S4 of FIG. 43, photographic-device data is generated from the corresponding position data such that there is a one-to-one correspondence therebetween. In the client data shown in FIG. 42, photographic device data 3α, 3β, 3γ, 3δ, and 3α are assigned to the position data P1, P2, P3, P4, and P1, respectively, rearranged in chronological order.

Then, in step S5, a picture-extracting database is generated.

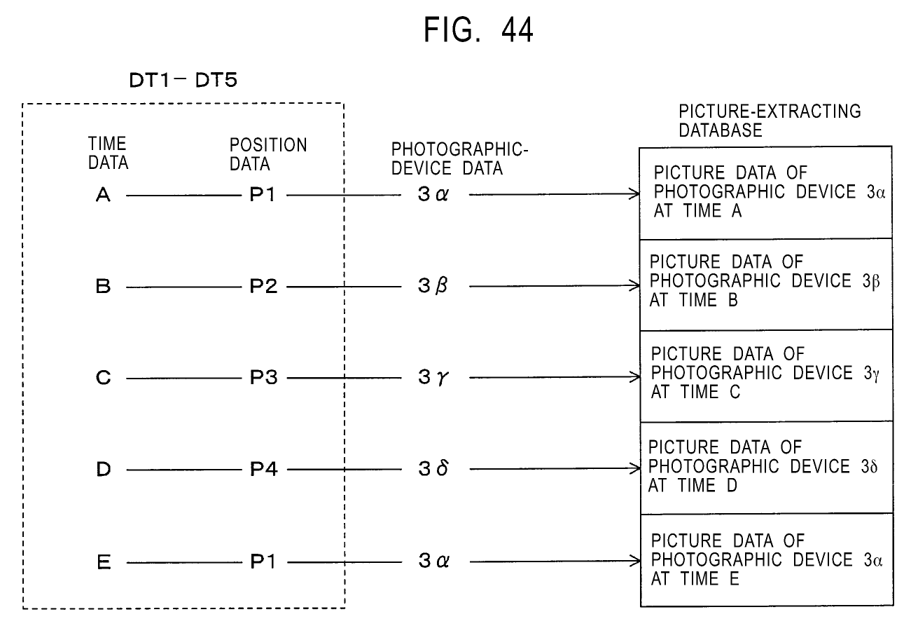

The processing of steps S2 through S5 is schematically shown in FIG. 44. As shown in FIG. 44, the position data P1, P2, P3, P4, and P1 rearranged in chronological order are assigned to the photographic data 3α, 3β, 3γ, 3δ, and 3α, respectively, and as a result, a picture-extracting database indicating pictures to be extracted in the corresponding periods is formed.

After generating the picture-extracting database in steps F102 and F103 of FIG. 3 by performing the processing shown in FIGS. 43 and 44, pictures are extracted based on the picture-extracting database in step F104 of FIG. 3.

That is, the picture-extracting/editing manager 13 instructs the photographic manager 14 and the user picture manager 26 to extract required pictures based on the picture-extracting database. More specifically, the picture-extracting/editing manager 13 instructs the photographic manager 14 to read the picture data taken by the photographic device 3α at time A, the picture data taken by the photographic device 3β at time B, the picture data taken by the photographic device 3γ at time C, the picture data taken by the photographic device 3δ at time D, and the picture data taken by the photographic device 3α at time E from the picture database 15.

In response to this instruction, the photographic manager 14 selects and extracts the pictures at designated times from the picture data taken by the photographic devices 3α, 3β, 3γ, and 3δ recorded in the picture database 15, and transfers the extracted pictures to the picture-extracting/editing manager 13.

If the picture data indicates moving pictures, pictures around the designated times can be extracted.

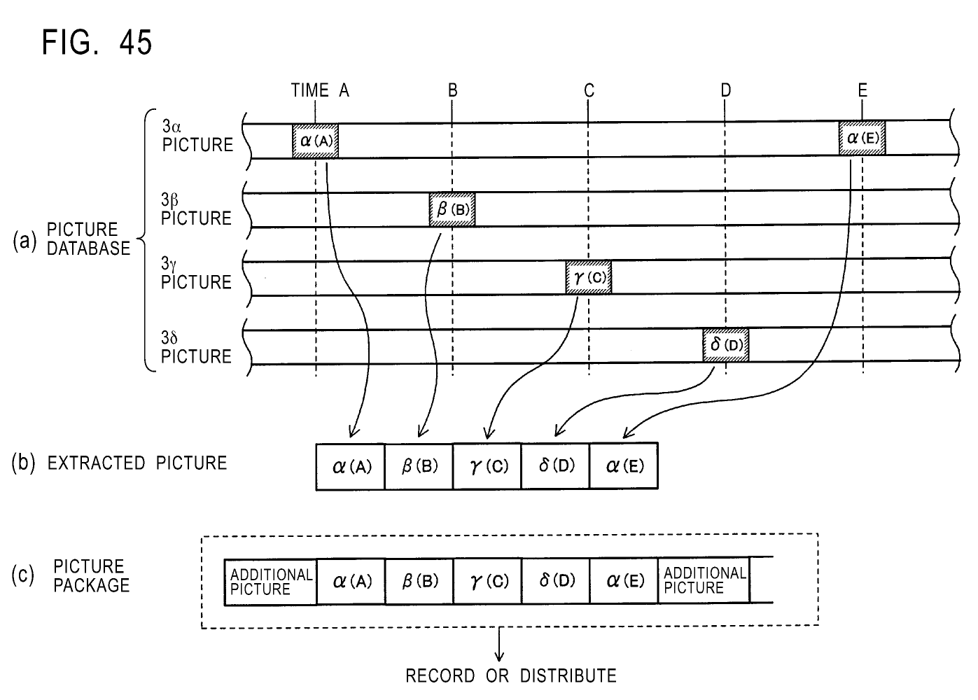

FIG. 45 schematically illustrates the extraction of pictures.

As indicated by (a) of FIG. 45, the picture data taken by the photographic devices 3α through 3δ are stored in the picture database 15.

Based on the picture-extracting database, picture data α_{(A)} and α_{(E)} taken by the photographic device 3α, picture data β_{(B)} taken by the photographic device 3β, picture data γ_{(C)} taken by the photographic device 3γ, and picture data δ_{(D)} taken by the photographic device 3δ are extracted from the picture database 15.

In step F105 of FIG. 3, the picture-extracting/editing manager 13 performs predetermined processing, for example, editing of the picture data α_{(A)}, α_{(E)}, β_{(B)}, and γ_{(C)}, and δ_{(D)} transferred from the photographic manager 14 in chronological order, or cutting of the time length, thus resulting in the pictures as indicated by (b) of FIG. 45.

In some cases, the entire picture of an attraction or a promotional picture of an attraction or a facility may be inserted before or after, or in the middle of the picture data α_{(A)}, β_{(B)}, γ_{(C)}, δ_{(D)}, and α_{(E)} as additional pictures.

By performing such editing processing, a picture package can be generated. An example of the picture package by using the picture data α_{(A)}, β_{(B)}, γ_{(C)}, δ_{(D)}, and α_{(E)} and by inserting additional pictures before and after the picture data is indicated by (c) of FIG. 45.

After completing the production of a picture package, the package is provided to the user in step F106 and accounting processing is performed in step F107, as discussed above.

According to the above-described method, by using pictures taken by pinpointing the user, a more interesting picture package can be produced. For example, the photographic device 3 is disposed above the chair or seat used by the user, or above a place where the user passes by suitably setting the view angle or the view field. With this arrangement, pictures of the user containing the user's face or upper body can be taken. As a result, picture packages featuring the individual users can be produced.

Pictures can be taken of the user, for example, enjoying an attraction while the user is unaware of the user medium 2. The resulting pictures are thus more natural, and at the same time, user's pictures can be more precisely extracted.

Since the user does not have to consider accessing the medium access device 10 by using the user medium 2, the work load for the user can be reduced, and the user can concentrate on enjoying attractions.

The non-contact wireless medium access devices 10 can be installed in the chair or seat, or under the floor, thereby enabling the commercial entities to perform maintenance or management of the individual devices.

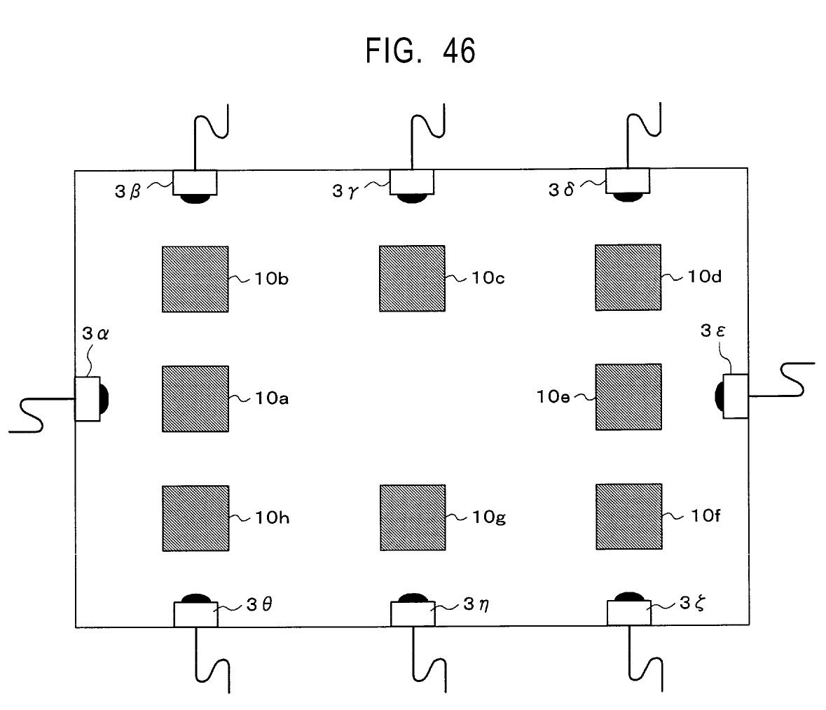

The medium access devices 10 may be disposed under the floor, as shown in FIG. 46. More specifically, in a certain room, medium access devices 10a through 10h are disposed under the floor, as shown in FIG. 46, and photographic devices 3α through 3θ are disposed to aim at the positions of the medium access devices 10a through 10h, respectively. The user wears the user medium 2 on the sole, as stated above.

Various arrangements of the medium access devices 10 and the photographic devices 3 can be made so that a variety of services can be provided. For example, in a kindergarten room or a playroom, the medium access devices 10 and the photographic devices 3 may be disposed in various manners, thereby making it possible to provide pictures of individual children. The same applies to, for example, sport athletic fields, in which case, pictures of individual athletes can be provided, and also, such pictures can be suitably used for holding interviews or producing videos.

### 9. Time Calibration

In the above-described examples, time code is added to picture data taken by the photographic devices 3 as the actual time information, thereby making it possible to extract pictures of a specific user from the time data obtained as the client data.

However, certain types of photographic devices 3 do not have a function of adding time code as the actual time. In many of such photographic devices 3, time code represents a period of time counted from the photographic start point, which is set as 0 seconds, 0 minutes, 0 hours.

The extraction of pictures of a certain user, as described above, cannot be performed from picture data having the time code representing the relative time from the photographic start point (hereinafter referred to as “relative time code”).

Thus, a time conversion method when the photographic device 3 is a type which adds the relative time code to picture data is discussed below.

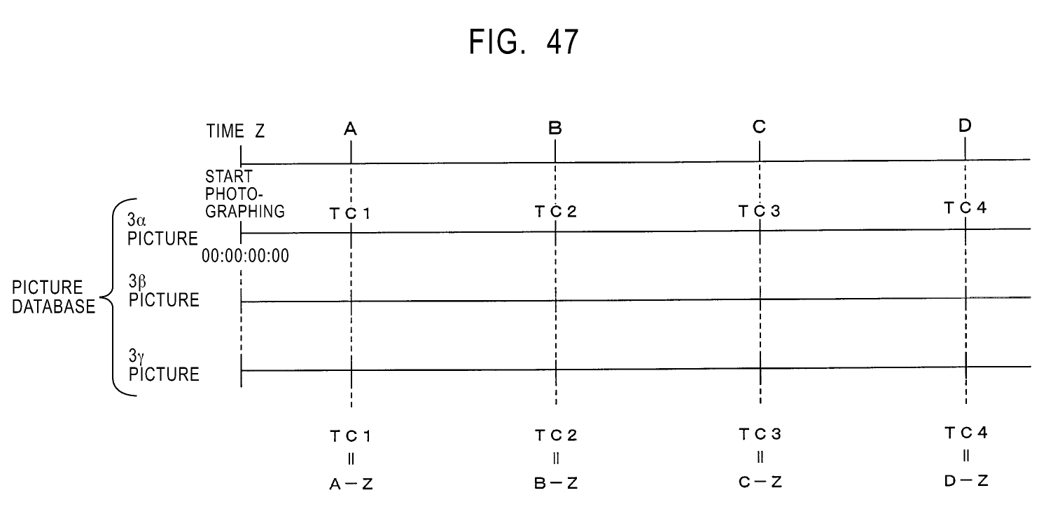

FIG. 47 illustrates the relationship between the relative time code and the actual time when the photographic devices 3α, 3β, and 3γ are the type which adds the relative time code to picture data.

Times Z, A, B, C, and D indicate the actual time. When the photographic devices 3α, 3β, and 3γ start taking pictures at time Z, the time code of the start point is 0 seconds, 0 minutes, 0 hours, and then, at times A, B, C, and D, the relative time codes are TC1, TC2, TC3, and TC4, respectively.

In this case, the relative time codes are added to the picture data taken by the photographic devices 3α, 3β, and 3γ to be stored in the picture database 15 of the picture production apparatus 1. When extracting pictures based on client data, however, the picture production apparatus 1 converts the time data (that is, the actual time information) of the client data into the relative time codes.

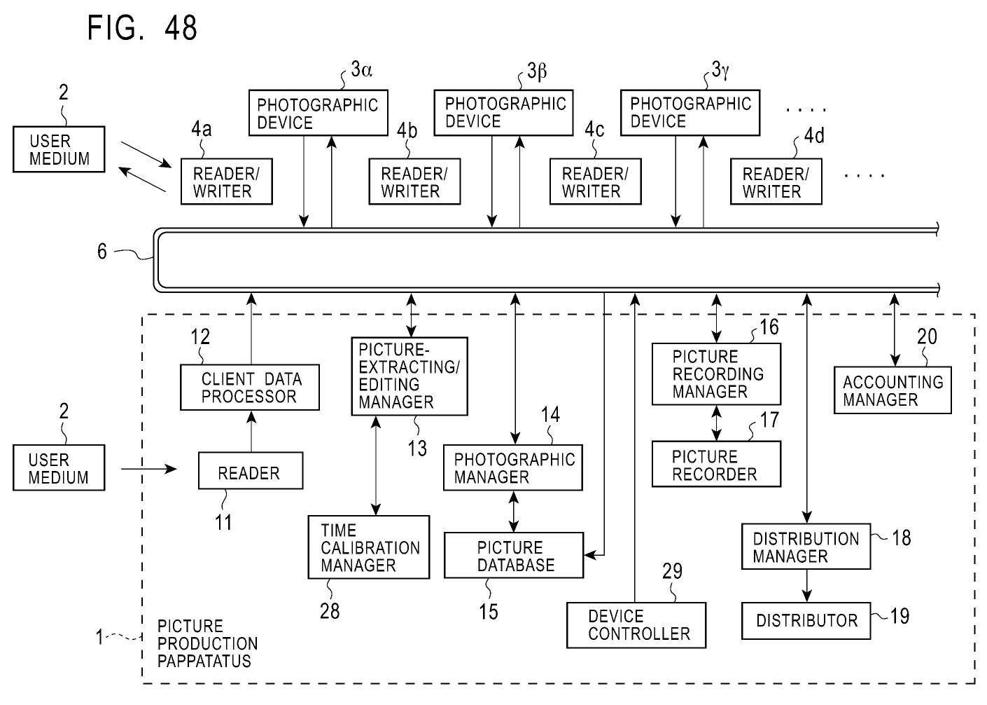

The configuration of the picture production apparatus 1 is shown in FIG. 48. The picture production apparatus 1 includes a time calibration manager 28 and a device controller 29 in addition to the elements shown in FIG. 2.

The device controller 29 controls the start/end of a photographic operation of each photographic device 3. More specifically, the device controller 29 sends via the network 6 a control signal for instructing each photographic device 3 to start/end a photographic operation, and the photographic device 3 starts/ends the photographic operation in response to this instruction. The device controller 29 also manages/stores information indicating the actual time at which each photographic device 3 starts a photographic operation in response to an operation-start control signal.

The time calibration manager 28 performs time calibration for converting the actual time data into the relative time code when the picture-extracting/editing manager 13 extracts pictures according to the client information.

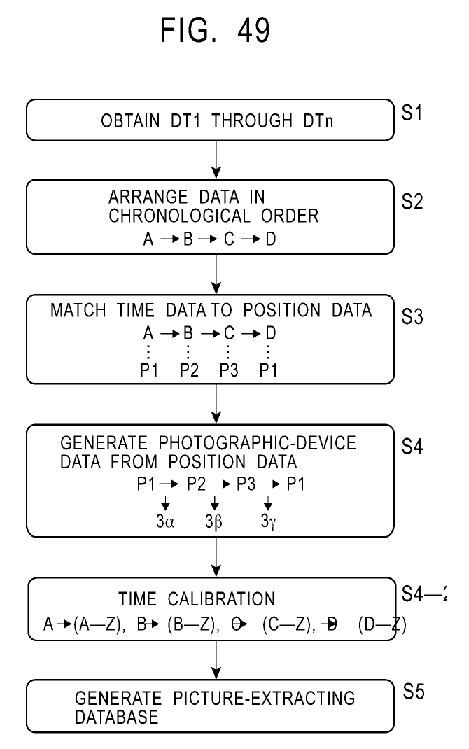

The processing for generating a picture-extracting database is shown in FIG. 49. Steps S1 through S4 are similar to those of FIG. 5.

After generating photographic-device data corresponding to the time data and position data in step S4, time calibration processing is performed in step S4-2. In this processing, the time data A, B, C, and D as the client data are converted into relative time codes.

As is seen from FIG. 47, since the relative time code indicates 0 seconds, 0 minutes, 0 hours at time Z when the photographic devices 3 starts taking pictures, the relative time code TC1 at time A can be calculated by subtracting time Z from time A, i.e., A-Z.

Similarly, the relative time code TC2 at time B can be calculated by subtracting time Z from time B, i.e., B-Z; the relative time code TC3 at time C can be calculated by subtracting time Z from time C, i.e., C-Z; and the relative time code TC4 at time D can be calculated by subtracting time Z from time D, i.e., D-Z.

The time calibration manager 28 obtains the photograph start time Z from the device controller 29 as for the time data A, B, C, and D of the client data from the picture-extracting/editing manager 13, and then, performs the above-described calculations, thereby converting the time data into the relative time codes.

In step S5, the picture-extracting/editing manager 13 generates a picture-extracting database by using the time information converted into the relative time codes.

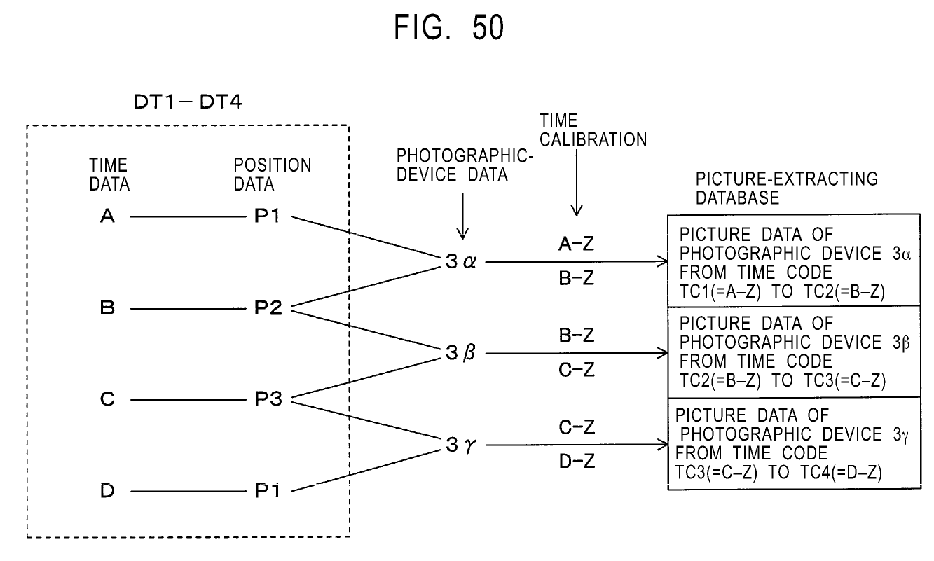

The processing of step S2 through S5 is schematically shown in FIG. 50. As shown in FIG. 50, a picture-extracting database that specifies required pictures is generated by using the time information converted into the relative time codes TC1, TC2, TC3, and TC4.

After generating the picture-extracting database in steps F102 and F103 of FIG. 3 by performing the processing shown in FIG. 49 including the time calibration processing, pictures are extracted based on the picture-extracting database in step F104 of FIG. 3. More specifically, the picture-extracting/editing manager 13 instructs the photographic manager 14 and the user picture manager 26 to extract required pictures based on the picture-extracting database. In this case, the picture-extracting/editing manager 13 gives an instruction to the photographic manager 14 by using the relative time codes. More specifically, the picture-extracting/editing manager 13 instructs the photographic manager 14 to read the picture data taken by the photographic device 3α from the relative time code TC1 to TC2, the picture data taken by the photographic device 3β from the time code TC2 to TC3, and the picture data taken by the photographic device 3γ from the time code TC3 to TC4 from the picture database 15.

In response to this instruction, the photographic manager 14 selects and extracts the pictures at the designated time codes from the picture data of the photographic devices 3α, 3β, and 3γ stored in the picture database 15, and transfers the extracted pictures to the picture-extracting/editing manager 13.

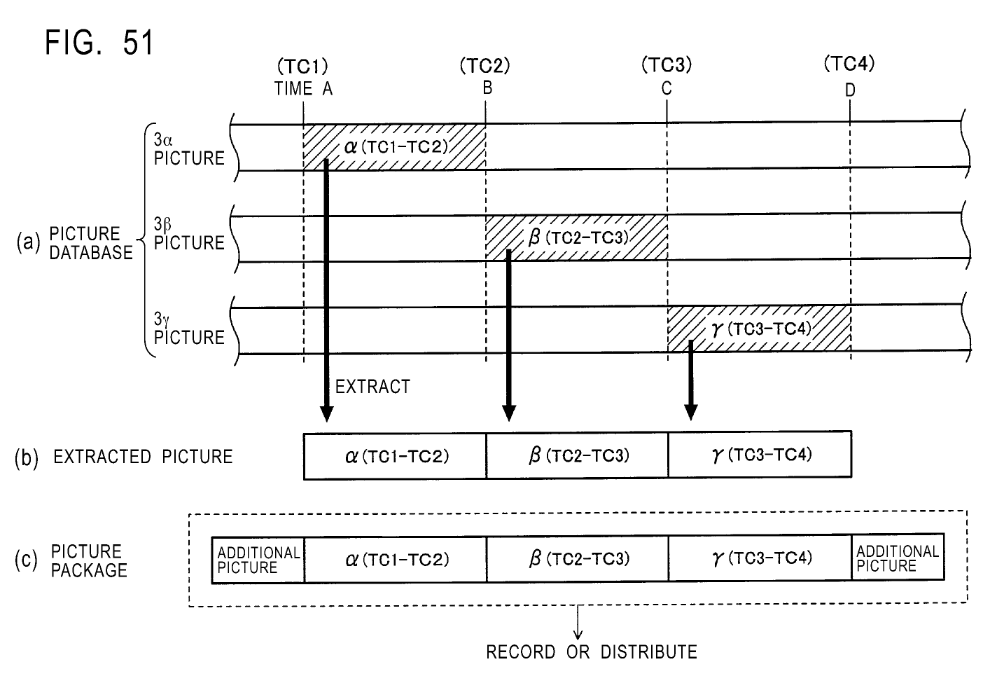

FIG. 51 schematically illustrates the extraction of picture data.

As indicated by (a) of FIG. 51, picture data taken by the photographic devices 3α, 3β, and 3γ to which the relative time codes TC1, TC2, TC3, and TC4 are added are stored in the picture database 15.

From this database 15, as indicated by (a) of FIG. 51, a picture from time A to B is extracted as picture data α_{(TC1-TC2)} taken by the photographic device 3α with the time code TC1-TC2; a picture from time B to C is extracted as picture data β_{(TC2-TC3)} taken by the photographic device 3β with the time code TC2-TC3; and a picture from time C to D is extracted as picture data γ_{(TC3-TC4)} taken by the photographic device 3γ with the time code TC3-TC4.

Then, in step F105 of FIG. 3, the picture-extracting/editing manager 13 performs predetermined processing, for example, editing of the picture data α_{(TC1-TC2)}, β_{(TC2-TC3)}, and γ_{(TC3-TC4)} transferred from the photographic manager 14 in chronological order, or cutting of the time length, thus resulting in the pictures indicated by (b) of FIG. 51.

In some cases, the entire picture of an attraction or a promotional picture of an attraction or a facility may be inserted before or after, or in the middle of the picture data α_{(TC1-TC2)}, β_{(TC2-TC3)}, and γ_{(TC3-TC4)} as an additional picture.

By performing such editing processing, a picture package can be generated. An example of the picture package by using the picture data α_{(TC1-TC2)}, β_{(TC2-TC3)}, and γ_{(TC3-TC4)} and by inserting additional pictures before and after the picture data is shown in (c) of FIG. 51.

Thus, even when the photographic device 3 only has a function of adding relative time codes rather than actual time information, picture-package production services can be provided by performing the time calibration processing as described above. Accordingly, the flexibility to select the types of photographic devices 3 can be increased. This is advantageous for the commercial entities in planning facilities.

The above-described example has been given, assuming that the photographic devices 3α, 3β, and 3γ start taking pictures at the same time, as shown in FIG. 47. In actuality, however, the photographic devices 3α, 3β, and 3γ may take pictures at different times.

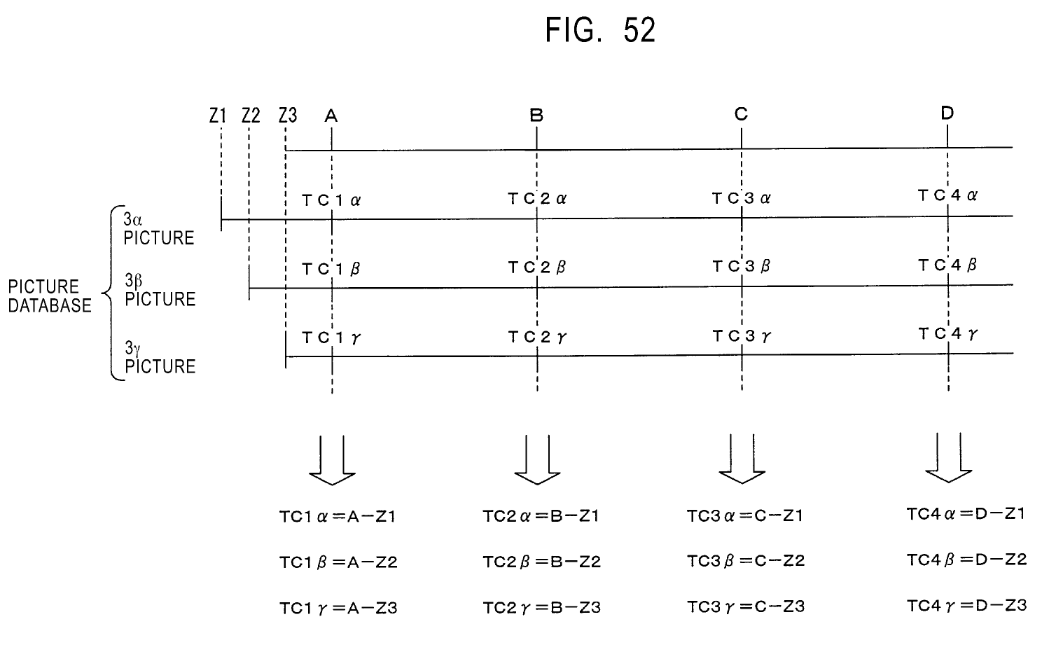

FIG. 52 illustrates an example in which the photographic device 3α starts taking pictures at time Z1, the photographic device 3β starts taking pictures at time Z2, and the photographic device 3γ starts taking picture at time Z3.

In this case, relative time codes, for example, at time A, are different among the photographic devices. More specifically, in this case, instead of simply performing subtractions using the start time Z, subtractions using the start times Z1, Z2, and Z3 should be performed. It is necessary that the device manager 29 store the photograph start time of each photographic device 3.

The time calibration manager 28 converts, for example, time A, into relative time codes as follows. For the photographic device 3α, the relative time code TC1α can be calculated by subtracting Z1 from A, i.e., A-Z1. For the photographic device 3β, the relative time code TC1β can be calculated by subtracting Z2 from A, i.e., A-Z2. For the photographic device 3γ, the relative time code TC1γ can be calculated by subtracting Z3 from A, i.e., A-Z3.

In the above-described time calibration processing, the time data of the client data is converted into the relative time code.

Conversely, the relative time code may be converted into actual time data. In this case, the relative time code may be converted into actual time data when extracting pictures. Alternatively, when storing pictures sent from the photographic devices 3 into the picture database 15, the relative time code may be converted into actual time data or the actual time data may be added to the relative time code. In the second case, since search can be conducted in the picture database 15 by using the actual time data, it is not necessary to perform time calibration when extracting pictures.

Although in the above-described example the time calibration processing is performed in the first example of the system, it may be performed in the second or third example of the system.

In all of the examples described above, picture packages featuring the users are produced by using the time data as one of the standards. Accordingly, if the time code (actual time or relative time code) of the photographic device 3 deviates from the time data written into the user medium 2 by the medium access device, pictures cannot be precisely extracted.

It is therefore preferable if, for example, the device controller 29 of the picture production apparatus 1 has a function of matching the time of the timers in the individual devices in the system.

### 10. Editing Using User Position Information and Photographic-Device Position Information

As discussed above, principally, picture packages are produced by extracting pictures of the individual users from the pictures taken by the photographic devices 3 fixed in the facility. However, the photographic devices 3 perform photographic operations only in the predetermined directions with the predetermined magnifications without aiming at specific users.

In this case, the pictures of each user are restricted to those in accordance with the user's actions and positions taken by the photographic devices 3. Accordingly, such pictures are not always desirable for the user. For example, the user may appear very small in a picture or may appear just at the corner of a picture.

Accordingly, if pictures are simply extracted, the resulting picture package does not satisfy the user or such a picture package is not interesting.

Thus, a description is now given of an example in which more preferable and interesting picture packages can be produced by performing secondary editing on extracted pictures rather than merely splicing extracted pictures.

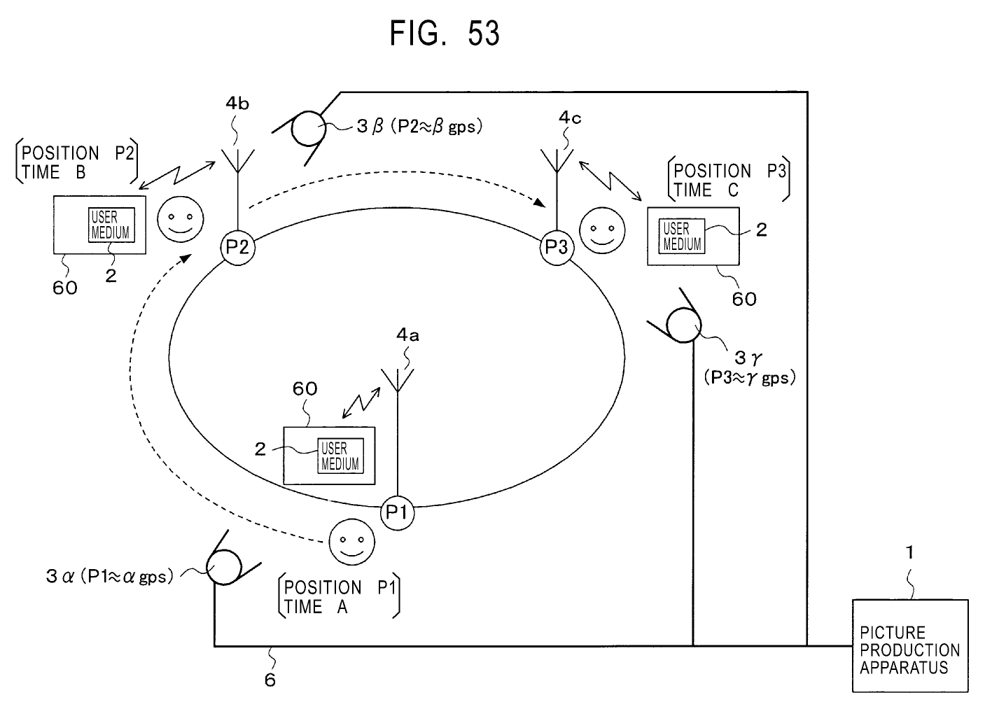

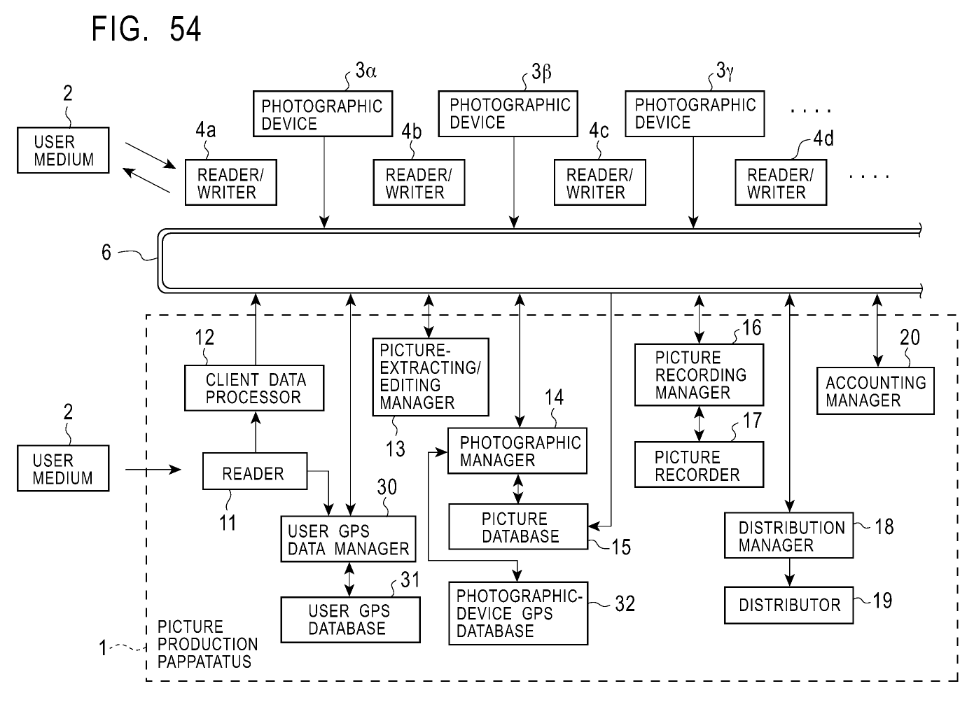

FIGS. 53 and 54 illustrate the configuration of the first example of the system in which secondary editing can be performed in producing picture packages.

In this case, as shown in FIG. 53, the user carries the information processing apparatus 60 integrating or loading the user medium 2 therein. The information processing apparatus 60 has a function of detecting the current position, i.e., the user position. Accordingly, the information processing apparatus 60 is provided with the GPS receiver 65, as in the user medium M5 or M6 shown in FIG. 21A or 21B, or the user medium M9 or M10 shown in FIG. 23A or 23B.

Basic points, such as the reading/writing of time data and position data from/into the user medium 2, the operation of the reader/writer 4, and the operation of the photographic device 3, are similar to those discussed in the above-described first example of the system.

In this information processing apparatus 60, GPS position data obtained by the GPS receiver 65 is recorded in the user medium 2. Since the GPS position data obtained by the GPS receiver 65 is associated with the user's actions, it is hereinafter referred to as “user GPS data”.

When access is made from the reader/writer 4, the information processing apparatus 60 records the user GPS data obtained by the GPS receiver 65.

Alternatively, the user GPS data may be regularly recorded in the information processing apparatus 60 rather than when access is made from the reader/writer 4. In this case, time data obtained by the timer 66 (see FIGS. 21A, 21B, 23A, and 23B) may be preferably recorded in accordance with the user GPS data.

Although in this example the user GPS data is recorded in the user medium 2, it may be recorded in another recording medium (solid memory, disk, or tape) within the information processing apparatus 60.

As shown in FIG. 53, the photographic devices 3 (3α, 3β, and 3γ) are installed near the reader/writers 4 (4a, 4b, and 4c) while aiming at specific places.

For example, the photographic device 3α photographs the area around position P1 at which the reader/writer 4a is installed. The place (the position of the subject) photographed by the photographic device 3α is the position indicated by the GPS position data (hereinafter referred to as “photographic-device GPS data α_{gps}”).

The place indicated by the photographic-device α_{gps} does not have to be the position P1 at which the reader/writer 4a is installed, and may be somewhere around the reader/writer 4a. Only in terms of the system, the photographic-device data corresponding to position P1 is managed as “α_{gps}”.

The same applies to the other photographic devices 3β and 3γ, i.e., the photographic devices 3β and 3γ photograph places, i.e., the positions of the subjects, (photographic-device GPS data β_{gps} and γ_{gps}) near position P2 and P3, respectively.

The picture production apparatus 1 includes, as shown in FIG. 54, a user GPS data manager 30, a user GPS database 31, and a photographic-device GPS database 32 in addition to the elements shown in FIG. 2.

The user GPS database 31 stores user GPS data U_{gps} recorded in the user medium 2. The user GPS data manager 30 manages the user GPS database 31 and information stored therein.

The photographic-device GPS database 32 stores the photographic-device GPS data α_{gps}, β_{gps}, and γ_{gps} as the position of the subjects in association with positions P1, P2, and P3, respectively.

When the user presents the user medium 2 at the service reception, the reader 11 reads the client data (client ID, time data, and position data) from the user medium 2, and also reads the user GPS data U_{gps}. The read user GPS data U_{gps} is delivered, together with the client ID, to the user GPS data manager 30, and is stored in the user GPS database 31.

If the user GPS data U_{gps} is recorded in a medium different from the user medium 2 by using the information processing apparatus 60, it is read from that medium at the service reception, and is stored in the user GPS database 31.

Picture package production processing by performing secondary editing using user GPS data U_{gps} and photographic-device GPS data is as follows.

It is now assumed that the user carrying the information processing apparatus 60 acts, as indicated by the broken lines in FIG. 53, as in positions P1→P2→P3, at time A, B, and C, respectively.

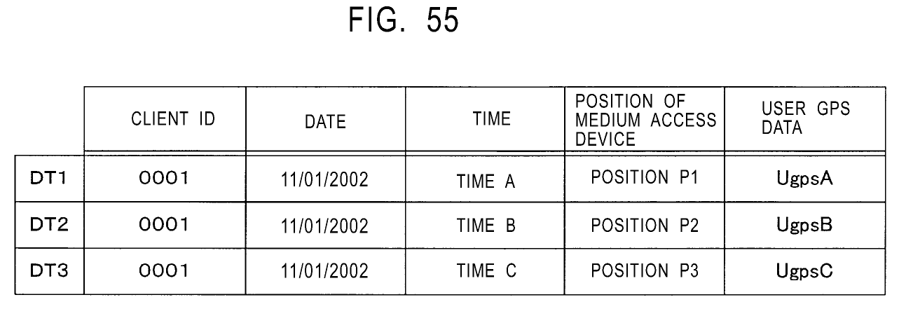

In the user medium 2 presented by the user, client data (client ID, time data, and position data), such as that shown in FIG. 55, is recorded. In the user medium 2 (or another medium), the user GPS data U_{gps} is recorded, as shown in FIG. 55.

In this case, the user GPS data U_{gps} is recorded when access is made to the user medium 2 by the reader/writer 4, and, as shown in FIG. 55, user GPS data U_{gpsA}, U_{gpsB}, U_{gpsC} are recorded in association with client data DT1, DT2, and DT3, respectively.

The picture production processing performed by the picture production apparatus 1 is similar to that shown in FIG. 3. The processing for generating a picture-extracting database by the client data processor 12 and the picture-extracting/editing manager 13 in steps F102 and F103 is similar to that of FIG. 43. The reason for generating a picture-extracting database according to the process of FIG. 43 rather than the process of FIG. 5 is that the photographic devices 3 take pictures of places near the readers/writers 4, and there is a one-to-one correspondence between the photographic devices 3 and the readers/writers 4.

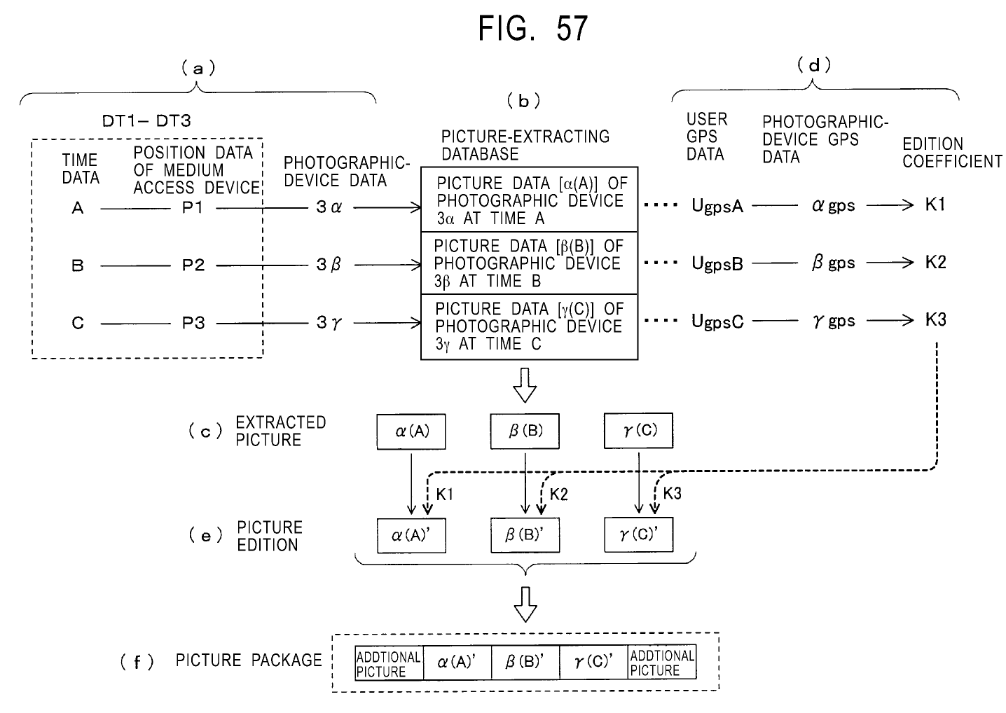

Accordingly, as indicated by (a) of FIG. 57, the photographic-device data 3α, 3β, and 3γ are assigned to the position data P1, P2, and P3, respectively, which are rearranged in chronological order, and a picture-extracting database indicating picture data α_{(A)}, β_{(B)}, and γ_{(C)} to be extracted in the individual periods is formed, as indicated by (b) of FIG. 57.

Then, in step F104 of FIG. 3, pictures are extracted based on the picture-extracting database. That is, α_{(A)}, β_{(B)}, and γ_{(C)} shown in (c) of FIG. 57 are read from the picture database 15.

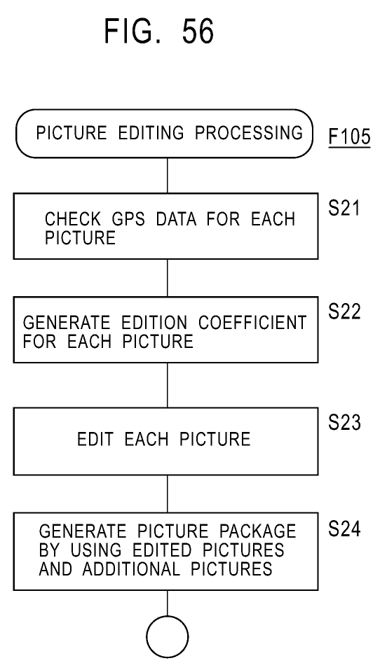

Then, in step F105 of FIG. 3, a picture package is produced by editing the extracted picture data. In this case, secondary editing is simultaneously performed in the process of FIG. 56.

In step S21 of FIG. 56, the picture-extracting/editing manager 13 checks each of the extracted picture data α_{(A)}, β_{(B)}, and γ_{(C)} against the user GPS data U_{gps} and the photographic-device GPS data.

More specifically, the picture-extracting/editing manager 13 requests the user GPS data manager 30 to send U_{gpsA}, U_{gpsB}, U_{gpsC} at times A, B, and C corresponding to the picture α_{(A)}, β_{(B)}, and γ_{(C)}, respectively. In response to this request, the user GPS data manager 30 reads the user GPS data U_{gpsA}, U_{gpsB}, U_{gpsC} at times A, B, and C from the user GPS database 31, and transfers the user GPS data to the picture-extracting/editing manager 13.

The picture-extracting/editing manager 13 also requests the photographic manager 14 to send the photographic-device GPS data α_{gps}, β_{gps}, and γ_{gps} for the photographic-device data 3α, 3β, and 3γ corresponding to the picture data α_{(A)}, β_{(B)}, and γ_{(C)}, respectively. In response to this request, the photographic manager 14 reads the photographic-device GPS data α_{gps}, β_{gps}, and γ_{gps} from the photographic-device GPS database 32, and transfers the data to the picture-extracting/editing manager 13.

The picture-extracting/editing manager 13 rearranges the user GPS data U_{gpsA}, U_{gpsB}, U_{gpsc} and the photographic-device GPS data α_{gps}, β_{gps}, and γ_{gps} in chronological order, and associates the user GPS data and the photographic-device GPS data with the extracted pictures α_{(A)}, β_{(B)}, and γ_{(C)}, as indicated in (d) of FIG. 57.

Then, in step S22 of FIG. 56, the picture-extracting/editing manager 13 generates edition coefficients K1, K2, and K3 for the extracted picture data α_{(A)}, β_{(B)}, and γ_{(C)}, respectively, as indicated by (d) of FIG. 57.

For generating the edition coefficients K1, K2, and K3, the user GPS data U_{gpsA}, U_{gpsB}, U_{gpsC} and the photographic-device GPS data α_{gps}, β_{gps}, and γ_{gps} are used.

More specifically, for generating the edition coefficient K1, the user GPS data U_{gpsA} and the photographic-device GPS data α_{gps} are used. From the two items of GPS data, the distance, the angle, the direction, the height, etc. between the user and the photographic device 3 can be calculated, thereby making it possible to detect the position or size of the user in the extracted picture data α_{(A)}. Thus, according to the calculation results, the edition coefficient K1 for performing edition, for example, positioning a picture of the user at the center of the picture or closing up a picture of the user, can be generated.

The edition coefficients include the type of edition (for example, enlarge, shrink, rotate, etc.), parameters for edition (for example, the range or magnification if a picture is enlarged), etc.

Subsequently, in step S23, the picture-extracting/editing manager 13 edits the extracted picture data α_{(A)}, β_{(B)}, and γ_{(C)} by using the edition coefficients K1, K2, and K3, respectively.

As indicated by (e) of FIG. 57, the picture data α_{(A)} is edited, for example, it is enlarged, by using the edition coefficient K1, resulting in picture data α_{(A)}′. Similarly, picture data β_{(B)} and γ_{(C)} are edited, i.e., they are enlarged, by using the edition coefficients K2 and K3 for the picture data, resulting in β_{(B)}′ and γ_{(C)}′, respectively.

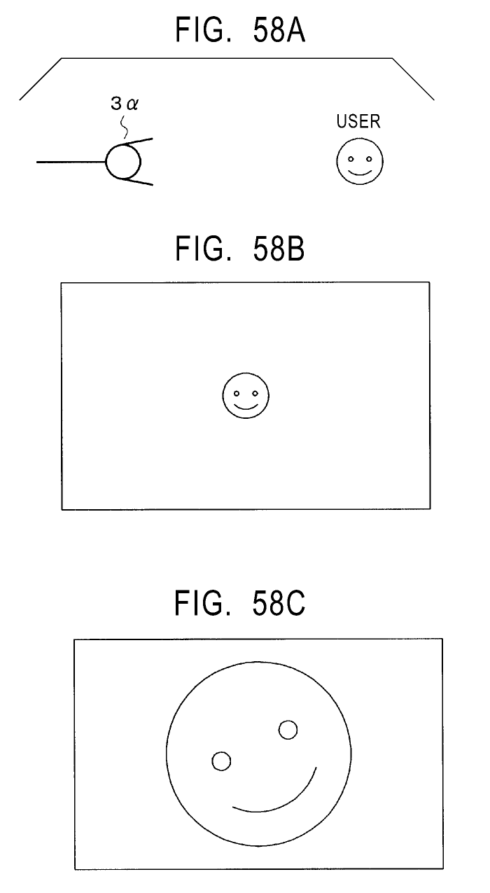

FIGS. 58A, 58B, and 58C illustrate edition examples. When the photographic device 3α takes a picture of the user, as shown in FIG. 58A, the user in the resulting picture appears very small, as shown in FIG. 58B. In this case, by calculating the distance or the angle between the user GPS data U_{gpsA} corresponding to the time data and the photographic-device GPS data α_{gps} at the subject position of the photographic device 3α, the image of the user in the extracted picture data α_{(A)}, i.e., the position or the size of the user in the picture, can be detected. Then, a parameter for enlarging the image of the user can be calculated as the edition coefficient K1. For making the picture more interesting, a parameter for rotating the image of the user may be added as the edition coefficient K1. Then, by performing editing processing using one or more parameters as the edition coefficient K1, picture data α_{(A)}′ including a close-up picture of the user is generated, as shown in FIG. 58C.

Subsequently, in step S24 of FIG. 56, the picture-extracting/editing manager 13 performs predetermined processing, for example, splicing of the secondarily edited picture data α_{(A)}′, β_{(B)}′, and γ_{(C)}′ in chronological order, or cutting of the time length, and also inserts additional pictures, thereby producing a picture package. An example of the picture package by using the picture data α_{(A)}′, β_{(B)}′, and γ_{(C)}′ and by inserting additional pictures before and after the picture data is shown in (f) of FIG. 57.

After completing the production of a picture package, the package is provided to the user in step F106 and accounting processing is performed in step F107, as discussed above.

As described above, in producing picture packages, secondary editing (enlarge, shrink, rotate, etc.) can be performed on extracted pictures, thereby making it possible to provide more interesting picture packages for the users.

The user GPS data U_{gps} can be obtained by the information processing apparatus 60 owned by the user, and thus, the facility cost is not incurred for the commercial entity. However, the commercial entity may prepare the information processing apparatus 60 that obtains the user GPS data U_{gps}, and rents it to the user.

Since the client data (position data and time data) and the user GPS data U_{gps}, which serve as a user's action history, are recorded in the user medium 2 integrated into the information processing apparatus 60, the leakage or unauthorized use of the information concerning the user's action history can be prevented.

In the picture processing apparatus 1, a picture package for each user can be produced from the client data (client ID, position data, and time data) and user GPS data U_{gps}. Accordingly, even an anonymous user is able to use the picture services, and the protection of the user's privacy can be enhanced.

Although the above-described secondary editing is performed in the first example of the system, it may be performed in the second or third example of the system.

Particularly in the second example of the system, since the medium access device (reader 5) has a communication function of performing communication via the network 6, it can read the user GPS data U_{gps} recorded in the user medium 2 (information processing apparatus 60) and sends it to the picture production apparatus 1 together with the client ID, time data, and position data. In this case, the picture production apparatus 1 should be provided with the user GPS data manager 30, the user GPS database 31, and the photographic-device GPS database 32 shown in FIG. 54 in addition to the elements shown in FIG. 9. It should be noted that the arrangement of the photographic devices 3 and the medium access devices (readers 5) is that shown in FIG. 53 rather than in FIG. 8.

In the third example of the system, since the information processing apparatus 60 has a communication function, it can send the user GPS data U_{gps} to the picture production apparatus 1. In this case, the user GPS data U_{gps} may be sent in response to a user's operation or access from the medium access device. Alternatively, the user GPS data U_{gps} may be automatically sent at regular intervals or when the capacity of the memory becomes small. Instead of recording the user GPS data U_{gps} in the information processing apparatus 60, the user GPS data U_{gps} obtained by the GPS receiver 65 may be directly sent to the picture production apparatus 1 by embedding the client ID into the user GPS data U_{gps}. In this case, the picture production apparatus 1 should be provided with the user GPS data manager 30, the user GPS database 31, and the photographic-device GPS database 32 shown in FIG. 54 in addition to the elements shown in FIG. 13. It should be noted that the arrangement of the photographic devices 3 and the medium access devices (writers or trigger devices 7) is that shown in FIG. 53 rather than in FIG. 12.

The obtaining, sending/transferring, and management of the user GPS data U_{gps} is performed by the information processing apparatus 60. To implement these operations, the commercial entity simply distributes application software for allowing the information processing apparatus 60 to perform such operations.

### 11. Additional Pictures/Sound According to the User

As stated above, the picture production apparatus 1 can use additional pictures (including additional sound) for producing picture packages. In this example, the picture production apparatus 1 produces picture packages by using pictures/sound that are more suitable for individual users.

This mode is described below in the context of the first example of the system.

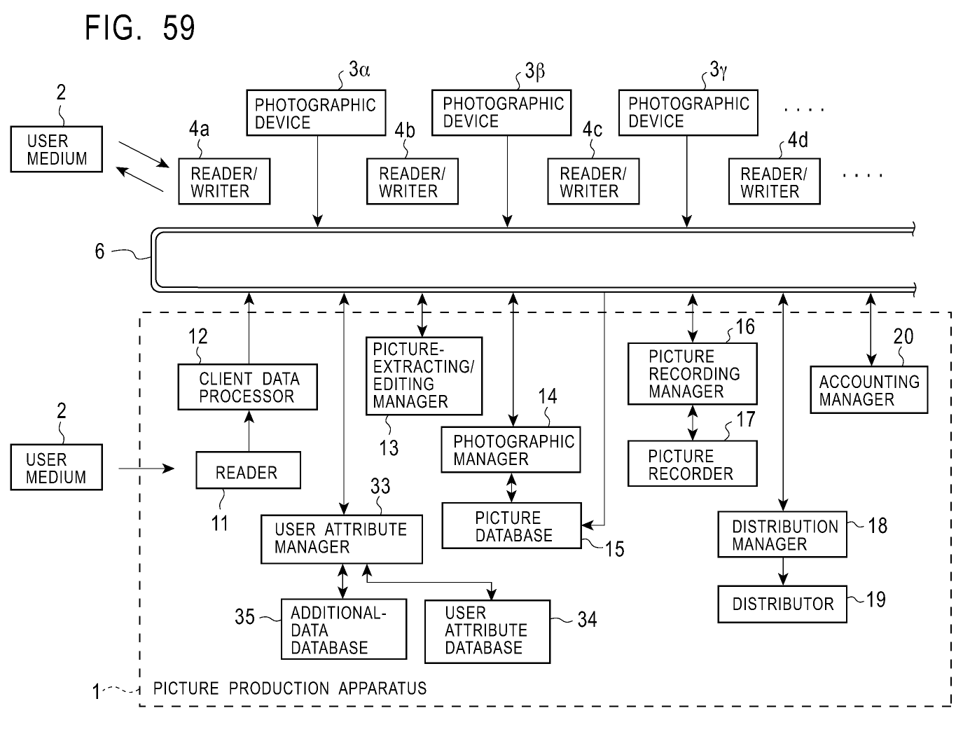

The picture production apparatus 1 includes, as shown in FIG. 59, a user attribute manager 33, a user attribute database 34, and an additional-data database 35 in addition to the elements shown in FIG. 2.

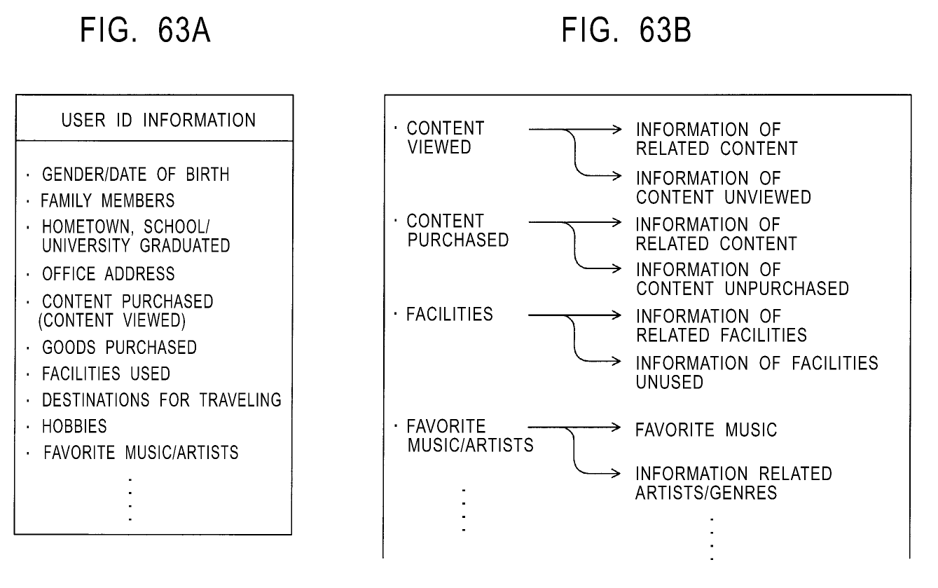

The user attribute database 34 stores personal information concerning user's attributes, for example, as shown in FIG. 63A, his/her name, date of birth, gender, address, family members, office address, names of goods purchased, names of content purchased, time and date of purchase, place of purchase, telephone No. email address, facilities used, the number of uses, traveling destinations, hobbies, favorite music genres/artists, hometown, school/university graduated, etc.

The additional-data database 35 stores various items of data as additional pictures/sound, for example, introduction pictures for various facilities, introductions/sales promotional pictures for goods and services, images, music data of various genres, etc.

The user attribute manager 33 manages the storage, search, reading of the data in the user attribute database 34 and the additional-data database 35.

Although in the above-described examples (FIGS. 2, 9, 13, 25, 32, 48, and 54) of the picture production apparatus 1, the storage location of additional pictures (additional sound) is not particularly shown, it is assumed that additional pictures (additional sound) are stored in, for example, the storage unit of the picture database 15 or the picture-extracting/editing manager 13. Of course, in these examples, an additional-data database, such as that in FIG. 59, may be separately provided.

Conversely, in the configuration shown in FIG. 59, instead of providing the additional-data database 35, additional data may be stored in the picture database 15, and the user attribute manager 33 manages the stored data.

Various items of data as personal information stored in the user attribute database 34 may be collected in advance from the user by means of a questionnaire or personal registration. Alternatively, the user (or the commercial entity requested by the user) may store user's personal information in the user medium 2. In this case, when the user presents the user medium 2 for receiving services, the personal information is read from the user medium 2 and is stored in the user attribute database 34.

In this example, when producing a picture package, the user attribute manager 33 selects an additional picture (additional sound) that can be assumed to be suitable for the user, and the picture-extracting/editing manager 13 edits/produces a picture package by using the selected additional picture (additional sound). The operation is as follows.

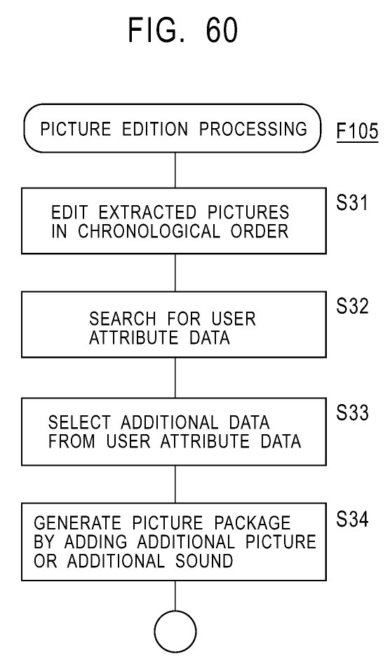

The picture production processing performed by the picture production apparatus 1 is similar to that of FIG. 3. However, after extracting pictures for the user in step F104, editing processing shown in FIG. 60 is performed by the picture-extracting/editing manager 13 in step F105.

In step S31 of FIG. 60, extracted pictures are edited in chronological order, for example, the extracted picture data α_{(A-B)}, β_{(B-C)}, and γ_{(C-D)} are rearranged in chronological order, as indicated by (a) and (b) of FIG. 7.

In step S32, the attributes of the user are checked. More specifically, the picture-extracting/editing manager 13 provides information for specifying the user (for example, client ID) to the user attribute manager 33, and allows the user attribute manager 33 to search the user attribute database 34 for the user's personal information based on the information received.

In step S33, the user attribute manager 33 extracts suitable additional data from the additional-data database 35 based on the user's personal information obtained from the user attribute database 34, and transfers the extracted additional data to the picture-extracting/editing manager 13.

Then, in step S34, the picture-extracting/editing manager 13 adds the additional data to the picture edited in step S31, thereby generating a picture package.

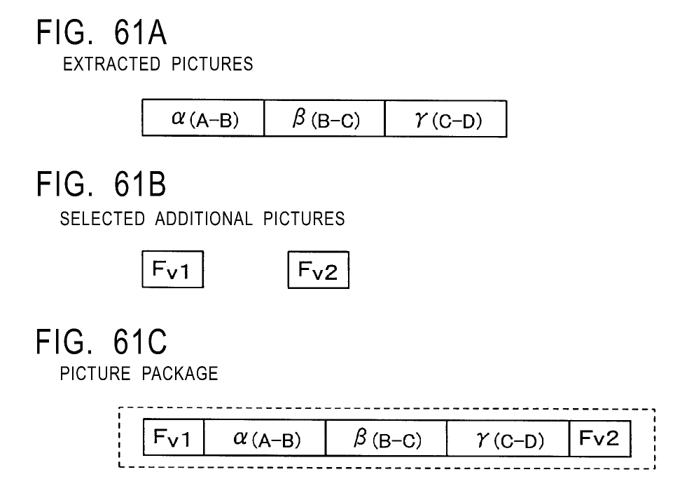

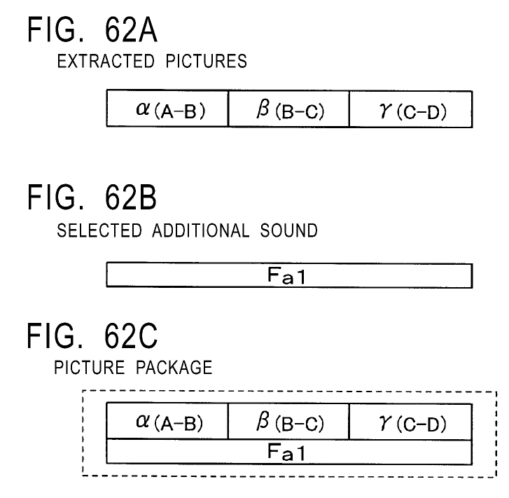

FIGS. 61A through 62C illustrate the production of picture packages having additional data.

It is now assumed, for example, that the picture data α_{(A-B)}, β_{(B-C)}, and γ_{(C-D)} are extracted, as indicated by (b) of FIG. 7, and the picture data α_{(A-B)}, β_{(B-C)}, and γ_{(C-D)} are shown in FIGS. 61A and 62A as the extracted pictures.

In steps S32 and S33 of FIG. 60, additional data suitable for the user is selected. In this case, additional pictures Fᵥ₁ and Fᵥ₂ are selected in FIG. 61B, and additional sound Fₐ₁ is selected in FIG. 62B. In step S34, a picture package is generated by adding the selected additional data. In this case, a picture package generated by adding the selected additional pictures Fᵥ₁ and Fᵥ₂ to the pictures α_{(A-B)}, β_{(B-C)}, and γ_{(C-D)} is shown in FIG. 61C. A picture package generated by adding the selected additional sound Fₐ₁ to the pictures α_{(A-B)}, β_{(B-C)}, and γ_{(C-D)} as, for example, BGM, is shown in FIG. 62C.

The selection of additional data in step S33 is conducted based on the user attribute data, for example, in the manner shown in FIG. 63B.

If information concerning the content that has been viewed by the user is available as the user attribute data, information (promotion, introduction, advertisement pictures, etc.) concerning the content related to the content viewed or the content that has not been viewed by the user may be selected as additional data.

If information concerning the goods purchased by the user is available as the user attribute data, information concerning goods related to the purchased goods or goods that have not been purchased by the user may be selected as additional data.

If information concerning the facilities used by the user is available as the user attribute data, information concerning facilities related to the facilities used or facilities that have not been used by the user may be selected as additional data.

If information concerning the user's favorite genres of music/artists is available as the user attribute data, the information concerning the music data, related music data, music data of the user's favorite genres, and related information (video clips, advertisement pictures, etc.) of the user's favorite artists may be selected as additional data.

Of course, other items of additional data can be considered.

As described above, when producing picture packages, the additional data selected based on the user's attribute data is added to the extracted pictures.

Then, the resulting picture packages become more valuable for the user. For example, the user registers his/her favorite goods or picture/music content, or goods or content that have been purchased in the user attribute database 34 of the commercial entity so that he/she can receive introductions of his/her favorite goods/content, information concerning the purchased goods or content, or content that has not been purchased.

The commercial entity is able to perform sales marketing more directly and efficiently in accordance with the user's hobbies, favorites, experiences, family members, etc, thereby expanding the information and developing close relationship between the sales stores and consumers.

It is now assumed that the user is a consumer of cars, homes, interior designs, cosmetics, etc. and sales stores for such products are facilities producing picture packages in this system.

It is also considered that the user visits a sales store a few times and tries a product before purchasing the product. Then, pictures or sound when the user has visited the sales store and tried the product are stored, and additional data (pictures of advertisement information and introduction of goods) in accordance with the user's attributes is added to the pictures or sound so as to produce a picture package, and the picture package is provided to the user. This is useful for the user and is also an effective sales method for the commercial entities.

Although the above-described mode has been described in the context of the first example of the system, it may be employed in the second or third example of the system.

In the second example of the system, the picture production apparatus 1 should include the user attribute manager 33, the user attribute database 34, and the additional-data database 35 shown in FIG. 59 in addition to the elements shown in FIG. 9.

In the second example of the system, since the medium access device (reader 5) has a communication function via the network 6, it can read the user attribute data recorded in the user medium 2 (information processing apparatus 60) and sends it to the picture production apparatus 1 together with the client ID, time data, and position data.

In the third example of the system, the picture production apparatus 1 should include the user attribute manager 33, the user attribute database 34, and the additional-data database 35 shown in FIG. 59 in addition to the elements shown in FIG. 13. In this case, since the information processing apparatus 60 has a communication function, it can send the user attribute data to the picture production apparatus 1.

### 12. Selection of Data by User

In the above-described examples, pictures are extracted for the user based on the time data and position data, which are recorded in the user medium 2 (or sent from the information processing apparatus 60), in accordance with the user's actions. In this case, the time data and position data to be used in the picture production apparatus 1 are not selected by the user. If the user selects time data and position data for extracting pictures, a picture package consists of pictures only desired by the user. In this example, a method for selecting position data and time data by the user is described below.

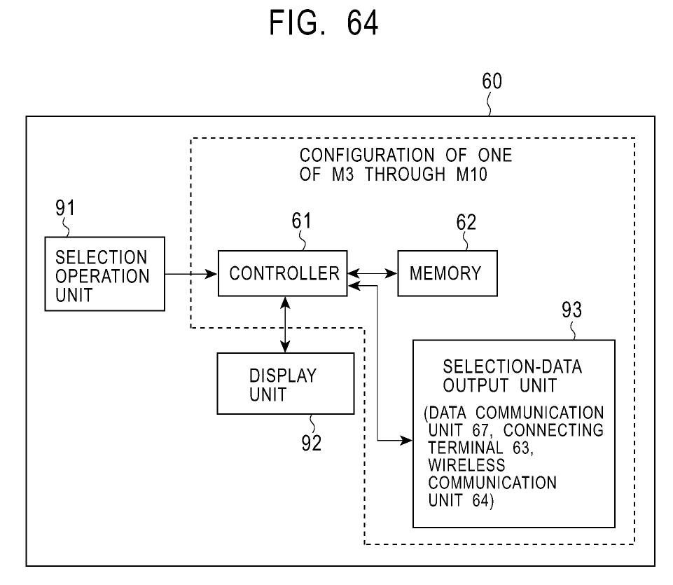

The user carries the information processing apparatus 60, such as that shown in FIG. 64, as the user medium 2.

The controller 61 and the memory 62 surrounded by the broken lines can be configured as one of the user media M3 through M10 shown in FIGS. 20A through 23B. A selection-data output unit 93 shown in FIG. 64 is equivalent to the data communication unit 67, the connecting terminal 63, or the wireless communication unit 64 shown in FIGS. 20A through 23B, and is able to output time data and position data as client data. The information processing apparatus 60 also includes a display unit 92 and a selection operation unit 91.

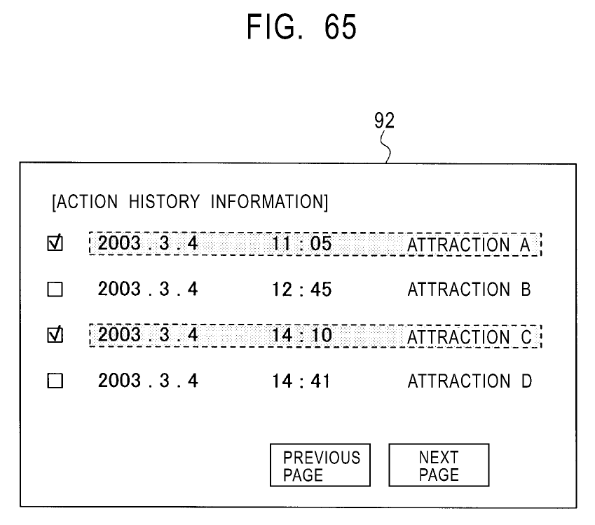

In this case, the controller 61 allows the display unit 92 to display the client data stored in the memory 62 as action history information, such as that shown in FIG. 65.

In FIG. 65, the time and date as the time data and the name of places as the position data (for example, the names of attractions corresponding to the position data P1, p2, and so on) are indicated.

The user selects desired attractions from this list by operating the selection operation unit 91, for example, by checking check boxes. Then, only the selected items of data are provided to the picture production apparatus 1, and can be used for extracting pictures for the user.

In the first example of the system, information indicating the user's selection status (selection flag) is stored in the user medium 2 in accordance with the time data and position data.

Then, in the picture production apparatus 1, among the client data (time data and position data) recorded in the user medium 2 presented by the user, data for which the selection flag is ON is read.

In the second example of the system, when access is made to the user medium 2, the reader 5 sends the client data (time data and position data) for which the selection flag is ON to the picture production apparatus 1.

In the third example of the system, the information processing apparatus 60 sends the client data (time data and position data) selected by the user (or stored with the selection flag ON) to the picture production apparatus 1.

In any of the first through third examples of the system, the client data selected by the user is provided to the picture production apparatus 1, and the picture production apparatus 1 extracts/edits the pictures based on the client information. Thus, the resulting picture package consists of pictures only desired by the user.

If there is a one-to-one correspondence between the position data P1, P2, and so on, and the photographic devices 3α, 3β, and so on, as shown in FIG. 41 or 53, pictures containing the user can be extracted reliably only by the client data selected by the user.

In contrast, when at least two items of position data are required for specifying the photographic device 3, as shown in FIG. 1, 8, or 12, there may be some cases in which the client data selected by the user cannot be identified.

In these cases, all the items of the client data are provided to the picture production apparatus 1 and are used for extracting pictures. Then, when editing pictures, pictures corresponding to the client data that are not selected by the user, that is, the client data with the selection flags OFF, are excluded.

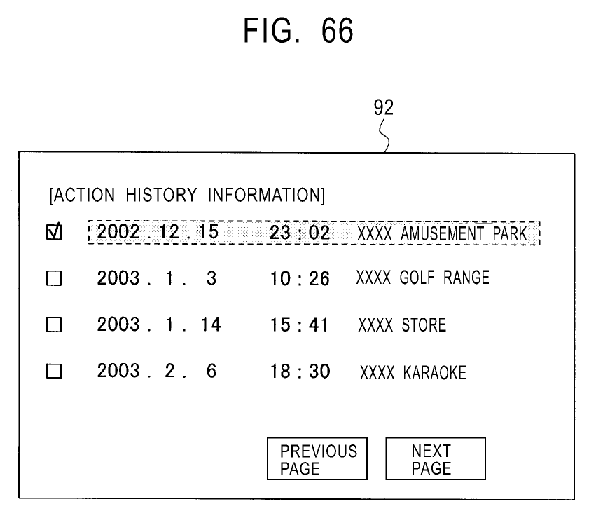

FIG. 65 illustrates a list of action history information in, for example, a theme park. Alternatively, user's action histories at different places which provide picture production services of this invention may be displayed, as shown in FIG. 66. Then, the user selects one of the histories, and sends it to the picture production apparatus 1 of the corresponding facility. The picture production apparatus 1 produces a picture package and distributes it to the user.

For example, as shown in FIG. 66, the user selects the history of XX amusement park that the user has visited, and sends the selection information to the picture production apparatus 1 via a telephone line. Then, the picture production apparatus 1 produces a picture package for the user, and provides it to the user by distribution or in the form of a medium.

The client data (time data and position data) in the facility used by the user is stored in the client-data database 22 of the picture production apparatus 1 in the second or third example of the system. Accordingly, the picture production apparatus 1 is able to produce a picture package in response to a request from the user.

If the client data is stored in the user medium 2 within the information processing apparatus 60, it is sent to the picture production apparatus 1 together with the selection information, and requests the picture production apparatus 1 to produce a picture package.

It can be considered that the user is able to check pictures to be extracted by selecting client data and by sending the corresponding selection information.

In the example of FIG. 65, the user selects, for example, attraction B and sends the selection information to the picture production apparatus 1. Then, the picture production apparatus 1 extracts pictures based on the time data and position data of attraction B, and sends the extracted pictures to the information processing apparatus 60. This enables the user to immediately check the pictures.

### 13. Various Modifications

Various modifications may be made to the system configurations, device configurations, and processes.

The service receiving areas in which the present invention is used may include theme parks, attraction parks, amusement parks, aquariums, zoos, vacation facilities, golf courses, golf driving ranges, ski resorts, diving spots, sports festivals, car races, driving schools, sport gyms, wedding reception halls, marathon races, karaoke places, concerts, event places, language conversation classes, tennis courts, dance halls, flower arrangement classes, childbirth, kindergartens, graduation ceremonies, expositions, exhibitions, car sales stores, house exhibitions, electric-appliance sales stores, interior-decoration sales stores, cosmetic sales stores, department stores, costume stores, boutiques, watch/clock stores, etc.

As the user medium 2, a recording medium for recording/storing at least client data, time data, and position data can be used, in which case, the type of recoding method is not restricted, for example, magnetic recording, electric recording, or punch recording may be employed. Particularly in the second example of the system in which only the client ID is stored in the user medium 2 and is read by the reader 5, paper or resin with holes or notches may be sufficiently used. If data is not written into the user medium 2 as in the second example of the system, paper indicating a client ID with bar code, or a key-shaped medium indicating a client ID recorded magnetically or by notches may be used.

If the information processing apparatus 60 is used as the user medium 2, unique IP addresses, such as IPv4 or IPv6 addresses, may be preferably assigned. In this case, if a picture package produced by the picture production apparatus 1 is provided to the user by distribution, the IP address, such as the IPv4 or IPv6 address, can be used for identifying the information processing apparatus 60 owned by the user. If the information processing apparatus 60 is a cellular telephone, accounting settlement can be conducted together with the telephone fee or the Internet connection fee.

To protect client data stored in the user medium 2 or in the picture production apparatus 1 from unauthorized access or use, the security can be enhanced. For example, client data may be encrypted or an encryption chip may be added to the client data.

If recorded user's voice or user picture data is used, as stated above, information may be encrypted or an encryption chip may be added to the information for protecting such recorded user's voice or user picture data from unauthorized access or use.

The client data stored in the user medium 2 or in the picture production apparatus 1 may include the user's name, date of birth, gender, address, family members, office address, names of goods purchased, names of content purchased, telephone No. email address, date, time, place (golf course, theme park, etc.), name of attraction, name of facility, name of sales store, number of uses, No. of card recording/playback device, delivery destination (television at a hotel, cellular telephone, home server, etc.), type of recording medium storing picture/audio data purchased (CD-R, DVD-R, semiconductor memory, photograph, etc.), type of encoding format (MPEG1, MPEG2, MPEG4, RealAudio, Microsoft, etc.) for picture/audio data purchased, payment settlement method (credit card, bank settlement, Internet money, etc.), and so on. It is preferable that the IP address assigned to the terminal is recorded as the client data.

Picture packages to be produced include not only moving pictures, but also photo albums consisting of still images. Of course, a single photograph may suffice. The photographic device may be any type provided with a microphone for recording sound with pictures.

What is claimed is:

1. A picture production system comprising:
a medium including storage means from or into which data is read or written;
at least one photographic device for taking pictures fixed at a predetermined place; and
a picture production apparatus for producing a picture by:
extracting a picture, in accordance with an action of a user using said medium, from pictures taken by said at least one photographic device based on the data recorded in said medium, and
editing the extracted picture related to the user.

2. A picture production system according to claim 1, further comprising at least one data writer fixed at a predetermined place, for writing data into said medium, wherein:
said at least one data writer writes time data and position data into said medium; and
said picture production apparatus extracts a picture in accordance with the action of the user by using the time data and the position data read from said medium.

3. A picture production system according to claim 1, further comprising at least one data reader fixed at a predetermined place, for reading data from said medium, wherein:
said data reader reads client identification information from said medium, and sends, together with the client identification information, time data and position data to said picture production apparatus; and
said picture production apparatus manages the client identification information, the time data, and the position data sent from said data reader, and also obtains the time data and position data based on the client identification information read from said medium, thereby extracting a picture in accordance with the action of the user by using the time data and the position data.

4. A picture production system according to claim 1, wherein said medium is a card medium.

5. A picture production system according to claim 1, wherein said medium is a medium loaded or integrated into an information processing apparatus.

6. A picture production system according to claim 5, wherein said information processing apparatus comprises position detecting means, and writes position data detected by the position detecting means into said medium.

7. A picture production system according to claim 5, wherein said information processing apparatus comprises timing means, and writes time data obtained by the timing means into said medium.

8. A picture production system according to claim 1, further comprising at least one medium access device fixed at a predetermined place, wherein:
said medium is a medium loaded or integrated into an information processing apparatus provided with a communication function;
said medium access device instructs said information processing apparatus to obtain time data and position data;
said information processing apparatus sends, together with client identification information stored in said medium, the time data and the position data transferred from said medium access device or obtained in response to an instruction from said medium access device to said picture production apparatus; and
said picture production apparatus manages the client identification information, the time data, and the position data sent from said information processing apparatus, and obtains the time data and the position data based on the client identification information read from said medium, thereby extracting a picture in accordance with the action of the user based on the time data and the position data.

9. A picture production system according to claim 8, wherein said information processing apparatus stores the time data and the position data transferred from said medium access device into said medium, and sends the client identification information, the time data, and the position data read from said medium to said picture production apparatus.

10. A picture production system according to claim 8, wherein said information processing apparatus comprises position detecting means, and sends position data detected by the position detecting means to said picture production apparatus.

11. A picture production system according to claim 8, wherein said information processing apparatus comprises timing means, and sends time data obtained by the timing means to said picture production apparatus.

12. A picture production system according to claim 8, wherein said medium access device accesses said medium according to a contact or wired-connection method.

13. A picture production system according to claim 1, wherein:
said medium is a medium loaded or integrated into a information processing apparatus provided with a recording function; and
said picture production apparatus produces a picture with sound based on the picture extracted from the pictures taken by said at least one photographic device and sound recorded by said information processing apparatus.

14. A picture production system according to claim 13, wherein said information processing apparatus stores audio data corresponding to time information in said medium or another storage means provided in said information processing apparatus by using the recording function.

15. A picture production system according to claim 14, wherein said information processing apparatus is provided with a communication function, and outputs the audio data recorded by the recording function in association with the time information by using the communication function.

16. A picture production system according to claim 1, wherein:
said medium is a medium loaded or integrated into an information processing apparatus provided with a photographic function; and
said picture production apparatus produces an edited picture for the user by using the picture extracted from the pictures taken by said at least one photographic device and a picture taken by said information processing apparatus.

17. A picture production system according to claim 16, wherein said information processing apparatus stores picture data corresponding to time information in said medium or another storage means provided in said information processing apparatus by using the photographic function.

18. A picture production system according to claim 16, wherein said information processing apparatus is provided with a communication function, and outputs picture data taken by the photographic function in association with time information by using the communication function.

19. A picture production system according to claim 2, wherein said picture production apparatus associates the time data with a time code added to a picture taken by said at least one photographic device so as to extract a picture in accordance with the action of the user by using the time data and the position data.

20. A picture production system according to claim 1, wherein:
said medium is a medium loaded or integrated into an information processing apparatus provided with a position detecting function for detecting a position of the user when taking a picture with said at least one photographic device; and
said picture production apparatus edits the picture extracted from the pictures taken by said at least one photographic device by using user position information detected by the position detecting function and position information of said at least one photographic device.

21. A picture production system according to claim 20, wherein said picture production apparatus enlarges, shrinks, or rotates an image for editing a picture by using position information indicating a position of said information processing apparatus detected by the position detecting function and the position information of said at least one photographic device.

22. A picture production system according to claim 20, wherein said information processing apparatus stores the user position information detected by the position detecting function in said medium or another storage means provided in said information processing apparatus.

23. A picture production system according to claim 20, wherein said information processing apparatus is provided with a communication function, and outputs the user position information detected by the position detecting function by using the communication function.

24. A picture production system according to claim 1, wherein said picture production apparatus produces an edited picture for the user by using a picture extracted from the pictures taken by said at least one photographic device and additional picture or additional sound.

25. A picture production system according to claim 24, wherein said picture production apparatus selects the additional picture or the additional sound used for producing an edited picture based on user information.

26. A picture production system according to claim 1, wherein:
said medium is a medium loaded or integrated into an information processing apparatus provided with a data selection function; and
said picture production apparatus extracts a picture, in accordance with the action of the user, from the pictures taken by said at least one photographic device based on at least data selected by the data selection function among the data stored in said medium.

27. A picture production system according to claim 1, wherein:
said at least one photographic device is disposed at a predetermined place within a photographic-service receiving area; and
said picture production apparatus produces an edited picture when said medium leaves the photographic-service receiving area.

28. A picture production apparatus comprising:
picture storage means for storing pictures from at least one photographic device which is disposed at a predetermined place to take pictures;
reading means for reading data from a medium which is capable of reading or writing data; and
picture production means for producing a picture by:
extracting a picture, in accordance with an action of a user using the medium, from pictures stored in said picture storage means based on the data read from the medium by said reading means, and
editing the picture related to the user.

29. A picture production apparatus according to claim 28, wherein:
the medium stores time data and position data written into the medium by at least one medium access device fixed at a predetermined place; and
said picture production means extracts a picture in accordance with the action of the user by using the time data and the position data read from the medium by said reading means.

30. A picture production apparatus according to claim 28, wherein user identification information is stored in the medium, said picture production apparatus further comprising client-data management means for managing the user identification information, time data, and position data sent from at least one medium access device fixed at a predetermined place, wherein:
said client-data management means obtains the time data and the position data based on the user identification information read from the medium by said reading means; and
said picture production means extracts a picture in accordance with the action of the user by using the time data and the position data.

31. A picture production apparatus according to claim 28, wherein user identification information is stored in the medium, said picture production apparatus further comprising client-data management means for managing the user identification information, time data, and position data sent from a communication device owned by the user, wherein:
said client-data management means obtains the time data and the position data based on the client identification information read from the medium by said reading means; and
said picture production means extracts a picture in accordance with the action of the user based on the time data and the position data.

32. A picture production apparatus according to claim 28, wherein said picture production means produces an edited picture by adding an additional picture or additional sound to the extracted picture.

33. A picture production apparatus according to claim 32, further comprising:
user-information management means for storing and managing user information; and
additional-information storage means for storing additional pictures or additional sound,
wherein said picture production means produces an edited picture by using the additional picture or additional sound selected from said additional-information storage means by said user-information management means based on the user information.

34. A picture production apparatus according to claim 32, further comprising recording means for recording the edited picture produced by said picture production means into a portable recording medium.

35. A picture production apparatus according to claim 32, further comprising distribution means for distributing the edited picture produced by said picture production means.

36. A picture production apparatus according to claim 32, further comprising accounting means for performing accounting processing for the edited picture produced by said picture production means for the user.

37. A picture production apparatus according to claim 28, further comprising sound storage means for storing audio data,
wherein said picture production means produces an edited picture with sound for the user by using a picture extracted from said picture storage means and sound extracted from said sound storage means.

38. A picture production apparatus according to claim 29, wherein said picture production means performs calibration processing for associating the time data with a time code added to a picture taken by said at least one photographic device so as to extract a picture in accordance with the action of the user by using the time data and the position data.

39. A picture production apparatus according to claim 28, further comprising:
user-position-information storage means for storing user position information detected by an information processing apparatus owned by the user; and
photographic-device-position storage means for storing position information of said at least one photographic device,
wherein said picture production means edits a picture extracted from said picture storage means by using the user position information searched from said user-position-information storage means and the photographic-device position information searched from said photographic-device-position information storage means.

40. A picture production apparatus according to claim 39, wherein said picture production means enlarges, shrinks, or rotates an image for editing a picture extracted from said picture storage means by using the user position information and the photographic-device position information.

41. A picture production apparatus according to claim 28, further comprising user-picture storage means for storing picture data taken by a photographic machine used by the user,
wherein said picture production means produces an edited picture for the user by using a picture extracted from said picture storage means and a picture extracted from said user-picture storage means.

42. A picture production apparatus according to claim 28, wherein said picture production apparatus is disposed at a predetermined place within a photographic-service receiving area, and produces an edited picture when the medium leaves the photographic-service receiving area.

43. A picture production method comprising:
a picture storage step of storing pictures from at least one photographic device which is disposed at a predetermined place to take pictures;
a reading step of reading data from a medium which is capable of reading or writing data; and
a picture production step of producing a picture by:
extracting a picture, in accordance with an action of a user using the medium, from pictures stored in said picture storage step based on the data read from the medium in said reading step, and
by editing the picture related to the user.

44. A picture production method according to claim 43, wherein:
the medium stores time data and position data written into the medium by at least one medium access device fixed at a predetermined place; and
said picture production step extracts a picture in accordance with the action of the user by using the time data and the position data read from the medium in said reading step.

45. A picture production method according to claim 43, wherein user identification information is stored in the medium, said picture production method further comprising:
a client-data management step of managing the user identification information, time data, and position data sent from at least one medium access device fixed at a predetermined place; and
an obtaining step of obtaining the time data and the position data based on the user identification information read from the medium in said reading step,
wherein, in said picture production step, a picture in accordance with the action of the user is extracted by using the time data and the position data obtained in said obtaining step.

46. A picture production method according to claim 43, wherein user identification information is stored in the medium, said picture production method further comprising:
a client-data management step of managing the user identification information, time data, and position data sent from a communication device owned by the user; and
an obtaining step of obtaining the time data and the position data based on the client identification information read from the medium in said reading step,
wherein, in said picture production step, a picture in accordance with the action of the user is extracted based on the time data and the position data.

47. A picture production method according to claim 43, further comprising a sound storage step of storing sound,
wherein, in said picture production step, an edited picture with sound is produced by using a picture extracted from the pictures stored in said picture storage step and sound extracted from the sound stored in said sound storage step.

48. A picture production method according to claim 43, further comprising a user-picture storage step of storing picture data taken by a photographic machine used by the user,
wherein, in said picture production step, an edited picture for the user is produced by using a picture extracted from the pictures stored in said picture storage step and a picture extracted from the pictures stored in said user-picture storage step.

49. A picture production method according to claim 44, wherein, in said picture production step, the time data is associated with a time code added to a picture stored in said picture storage step so as to extract a picture in accordance with the action of the user by using the time data and the position data.

50. A picture production method according to claim 43, wherein, in said picture production step, an edited picture is produced by adding an additional picture or additional sound to the extracted picture.

51. A picture production method according to claim 50, wherein the additional picture or the additional sound is selected based on user information.

52. A picture production method according to claim 43, wherein, in said picture production step, an extracted picture is edited by using user position information detected by an information processing apparatus used by the user and position information of said at least one photographic device.

53. A picture production method according to claim 52, wherein, in said picture production step, an image is enlarged, shrunk, or rotated for editing a picture by using the user position information and the position information of said at least one photographic device.

54. A picture production method according to claim 43, wherein said picture production step is performed when the medium leaves a photographic-service receiving area.
